(19) United States
(12) Patent Application Publication
(10) Pub. No.: US 2004/0021554 A1
(43) Pub. Date: Feb. 5, 2004

(54) Radio pager that can flexibly select an output mode

(76) Inventors: Toshihiro Hishida, Hyogo (JP); Hidetaka Ohto, Hyogo (JP); Hitoshi Uno, Gifu (JP); Kazunori Watanabe, Kanagawa (JP); Masakazu Kawano, Osaka (JP); Hiromi Wada, Osaka (JP); Yasunori Tanaka, Osaka (JP); Yoshifumi Yonemoto, Osaka (JP)

Correspondence Address: SNELL & WILMER LLP, Suite 1200, 1920 Main Street, Irvine, CA, 92614, US

(21) Appl. No.: 10/425,530

(22) Filed: Apr. 29, 2003

Related U.S. Application Data
(62) Division of application No. 09/125,402, filed on Jun. 28, 1999, now Pat. No. 6,633,224.

(30) Foreign Application Priority Data
Feb. 29, 1996 (JP) 08-42749
Jun. 28, 1996 (JP) 08-169194
Jul. 3, 1996 (JP) 08-173261
Nov. 29, 1996 (JP) 08-335085
Nov. 29, 1996 (JP) 08-320424

(51) Int. Cl. H04Q 7/00

(52) U.S. Cl. 340/7.21; 340/7.55

(57) ABSTRACT

A radio pager system includes a radio pager that can receive messages and can specify a specific output mode, including a display, a sound output, a vibration, and a light emission appropriate to a particular type of message. The radio pager can further reduce difficulties in retransmitting and/or replying to messages and save time in the transmission period. The radio pager can receive and implement a radio message that includes control information which can be utilized for generating the specific output mode of the display.

### FIELD OF THE INVENTION

The present invention relates to a radio pager that receives message information and outputs the information by output operations such as displays, sounds, and vibrations, and relates to a method of controlling the output operations.

### DESCRIPTION OF THE PRIOR ART

FIG. 1 shows the general construction of a system that uses a conventional radio pager. As shown in the figure, a message inputted using a telephone 2601 is transmitted to a radio pager 2604 via a public network 2602, a radio station 2603, and an antenna 2605 by radio waves.

The radio pager 2604 includes a reception unit 2606 for receiving the message transmitted by radio via the antenna 2605, a conversion unit 2607 for converting the received message as necessary, a display unit 2608 for displaying the received message, a message storage unit 2609 for storing the received message, a setting unit 2610, and a fixed message storage unit 2611.

A message is usually inputted using 12 keys that are made up of “*”, “#”, and 10 numeric keys of “1” to “0”. A letter of Japanese katakana or alphabet can be inputted using a two-digit number.

For example, “23239912” is inputted in order to generate a message “ [symbol] ” (SUZUKI). Here, “ [symbol] ” (SU) is expressed by “23”, a voiced consonant mark “ [symbol] ” is expressed by “99”, and “ [symbol] ” (KI) is expressed by “12”. On receiving the radio message “23239912”, the radio pager outputs the message “ [symbol] ” on a display screen along with bell or melody sounds which are set in advance.

If a fixed message “TEL [symbol] ” (PLEASE CALL) is registered in a code “*0510” in advance, on receiving a radio message “23239912*0510”, the radio pager outputs the message “z,8 TEL [symbol] ” (SUZUKI, PLEASE CALL) along with the bell or melody sounds set in advance.

With a radio selection call receiver disclosed in Japanese Laid-Open Patent Application No. 3-24827, a transmitter can specify a sound to be outputted at the time of message reception by including information specifying a call notification sound pattern and a sound level in a radio message.

Also, a radio pager 32 in FIG. 2, disclosed in Japanese Laid-Open Patent Application No. 3-18137, includes a clock unit 32d, a timer time setting unit 32e, and a comparison unit 32f which compares a set timer time of the timer time setting unit 32e and a clock time of the clock unit 32d and outputs a matching signal when they match. A control unit 32c drives and controls a call display unit 32b according to the matching signal. The timer time (time of day) is set according to a timer time setting signal which is included in a calling signal.

However, in these conventional radio pagers, the display unit can only be driven and controlled in accordance with a fixed factor such as a scheduled time. Also, the contents of the control are limited to the bell sound output. Furthermore, it is difficult to cancel or change the contents which have already been set.

The transmitter can only specify the call notification sound pattern and the sound level to be outputted at the time of the message reception but cannot specify a message display pattern and a sound, such as the call notification sound, to be outputted in association with the message display. Thus, there is a problem of restricted flexibility in making a transmission message.

To transmit messages which have the same meaning but subtly different styles for various receivers, it is necessary to create and transmit each message with a different style to a corresponding receiver. This incurs a great cost and time to the transmitter.

In the conventional radio pagers, a message is processed as an indivisible unit, so that a transmission message and a received message have the same contents. Accordingly, to partially change the contents of a message that has already been transmitted, it is necessary to create a whole message again by inputting both the changed part and the unchanged part of the original message. The partial change cannot be made just by transmitting the changed part. Thus, the conventional radio pagers have a drawback that it is troublesome to input messages and to retransmit and reply to the messages.

Also, with the conventional radio pagers, not only the changed part but the unchanged part of the original message needs to be transmitted. This causes the wastes in retransmitting the same part of the message.

The use of a self-made message setting function cannot sufficiently reduce the difficulties in retransmitting/replying messages and the wastes in retransmitting the same part of the messages.

### DISCLOSURE OF THE INVENTION

The present invention aims to provide a radio pager that can specify output control including a display, a sound output, a vibration, a light emission, and the like in greater variety and flexibility, and a control method of the radio pager.

The present invention also aims to provide a radio pager whose output control can be determined and changed by the transmitter and a control method of the radio pager.

The present invention also aims to provide a radio pager that can reduce the transmitter's difficulties in making messages which have the same meaning but different styles improve the flexibility in making messages, and a control method of the radio pager.

The present invention further aims to provide a radio pager that can reduce the difficulties in retransmitting/replying messages and the wastes in transmission, and a control method of the radio pager.

The above objects can be fulfilled by a radio pager, comprising: output means for performing an output operation using at least one of a display, a sound output, a vibration, and a light emission; storage means for storing control information for controlling an output mode that includes at least one of the display, the sound output, the vibration, and the light emission; reception means for receiving a radio message that includes at least one parameter relating to the control information; generation means for generating output control data according to the received parameter and the control information; and control means for controlling the output means according to the output control data generated by the generation means.

Here, the storage means may store any of: at least one program for processing data in the radio message and determining the output mode; at least one set of event information that are each a combination of an event condition relating to the radio message and operation data which is dependent on an occurrence of an event; and at least one template showing a form for a display message where contents of at least one column in the radio message are included. With the above construction, the generated output control data differs according to the parameter in the radio message. Accordingly, the transmitter can flexibly specify the output control including the display, the bell sound output, and the like, by setting the parameter corresponding to the desired output mode.

Here, the reception means may receive the radio message that includes a program identifier as the parameter, and the generation means may process the data in the radio message and determines the output mode according to a program specified by the program identifier in order to generate the output control data which instructs to execute the output mode.

Here, the storage means may store the combination of the event condition for the occurrence of the event and the operation data to be used when the event occurs, wherein the reception means receives the radio message that includes an element relating to the event condition as the parameter, and wherein the generation means generates the output control data according to the operation data stored in the storage means when the event caused by the parameter occurs.

Here, the storage means may store, as the event condition, any of: a reception of a radio message which includes specified data; a coming of a time, and a lapse of a time period since a reception of a radio message.

Here, the storage means may store the template which includes a plurality of columns, wherein the reception means receives the radio message that includes the contents of at least one column as the parameter, and wherein the generation means generates the output control data according to the contents of the columns and the template.

With the above construction, the transmitter can specify the desired output mode by specifying, as the parameter, one of the program identifier, the event condition for the event occurrence, and the template identifier. Since a simple identifier is used as the parameter and the radio message does not need to include a whole display message but only includes data or column contents to be processed by the program, the amount of transmission data can be reduced.

Here, the radio message may include one of a new program, a new set of event information, and a new template, and the radio pager may further include setting means for setting one of the new program, the new set of event information, and the new template included in the radio message into the storage means.

With the above construction, the transmitter can flexibly set the new program, the new event information, and the new template into the radio pager.

Here, the generation means may include: analysis means for analyzing the radio message received by the reception means and detecting the program identifier; read means for reading a program specified by the detected program identifier from the storage means; and creation means for creating the output control data by executing the read program.

Here, the generation means may include: analysis means for analyzing the radio message received by the reception means and detecting the element relating to the event condition; monitor means for monitoring whether the detected element meets the event condition; and creation means for creating the output control data according to the operation data when the event condition is met.

Here, the generation means may include: analysis means for analyzing the radio message received by the reception means and detecting the template identifier and the contents of each column; read means for reading a template specified by the detected template identifier from the storage means; and creation means for creating the output control data according to the read template and the contents of each column.

Also, the above objects can be fulfilled by a control method of a radio pager that includes an output unit for performing an output operation using at least one of a display, a sound output, a vibration, and a light emission and a storage unit for storing control information, the control method comprising: a storage step of storing at least one program that each determine an output mode into the storage unit, the program being stored as the control information for controlling the output mode which includes at least one of the display, the sound output, the vibration, and the light emission; a reception step of receiving a radio message that includes a program identifier as a parameter relating to the control information; a generation step of generating output control data according to the received parameter and the control information; and an output step of controlling the output unit according to the output control data generated in the generation step.

Here, the generation step may include: an analysis substep of analyzing the radio message and detecting the program identifier; a read substep of reading a program specified by the detected program identifier from the storage unit; and a creation substep of creating the output control data by executing the read program.

Here, the generation step may include: an analysis substep of analyzing the radio message and detecting the element relating to the event condition; a monitor substep of monitoring whether the detected element meets the event condition; and a creation substep of creating the output control data according to the operation data when the event condition is met.

Here, the generation step may include: an analysis substep of analyzing the radio message and detecting the template identifier; a read substep of reading a template specified by the detected template identifier from the storage unit; and a creation substep of creating the output control data using the read template and the contents of each column.

With the above construction, the generated output control data differs according to the parameter in the radio message. Accordingly, the transmitter can flexibly specify the output control including the display, the bell sound output, and the like, by setting the parameter corresponding to the desired output mode.

### BRIEF DESCRIPTION OF THE DRAWINGS

FIG. 1 is a block diagram showing the general construction of the system that uses a conventional radio pager.

FIG. 2 is a block diagram showing another conventional radio pager.

FIG. 3 is a block diagram showing an example of the general construction of the system that uses the radio pagers of the first embodiment of the present invention.

FIG. 4 shows a specific example of the appearance of the radio pagers shown in FIG. 3.

FIG. 5 is a block diagram showing a specific example of the internal construction of the radio pagers shown in FIG. 3.

FIG. 6 shows the construction of the meeting template.

FIGS. 7A and 7B show examples of the construction of the column definition data in the meeting template.

FIGS. 8A and 8B show examples of the transmission message input program shown in FIG. 3.

FIG. 9 is a flowchart showing the execution of the transmission message input program by the program execution unit.

FIGS. 10A-10I show display examples of the display unit.

FIG. 11 shows an example of a message when a new column message is inputted in each column.

FIG. 12 shows a difference message for changing the time set in the message shown in FIG. 11.

FIGS. 13A and 13B show examples of the column program shown in FIG. 3.

FIG. 14 is a flowchart when the program execution unit executes the column program shown in FIG. 13.

FIGS. 15A and 15B show examples of the received message display program shown in FIG. 3.

FIG. 16 is a flowchart when the program execution unit executes the received message display program shown in FIG. 15.

FIG. 17 shows an example of a message displayed by the display unit when the message shown in FIG. 11 is received.

FIG. 18 shows an example of a message displayed by the display unit when the difference message shown in FIG. 12 is received.

FIG. 19 shows an example of a guidance display when inputting a difference reply message.

FIG. 20 shows the difference reply message to be transmitted and received.

FIG. 21 shows a message displayed when receiving the reply message.

FIG. 22 is a flowchart showing the operation of creating another display message in the first embodiment.

FIG. 23 is a block diagram showing the general construction of the system that uses the radio pager of the second embodiment of the present invention.

FIG. 24 is a block diagram showing an example of the general construction of the system that uses the radio pager of the third embodiment of the present invention.

FIG. 25 shows the construction of the message information included in a received radio message in the third embodiment.

FIGS. 26A-26C are schematic diagrams showing information stored in the program information storage unit of the third embodiment.

FIG. 27 shows a specific example of the message information in the third embodiment.

FIGS. 28A and 28B show the appearance of the radio pager of the third embodiment when receiving the message information.

FIG. 29 is a block diagram showing an example of the general construction of the system that uses the radio pager of the fourth embodiment of the present invention.

FIG. 30 shows the construction of the message information included in a received radio message in the fourth embodiment.

FIGS. 31A and 31B are schematic diagrams showing information stored in the program information storage unit of the fourth embodiment.

FIGS. 32A and 32B are flowcharts of the program in the fourth embodiment.

FIGS. 33A and 33B are schematic diagrams showing information stored in the sound output control unit and the vibration control unit of the fourth embodiment.

FIGS. 34A-34C show specific examples of the message information in the fourth embodiment.

FIGS. 35A-35C show the appearance of the radio pager when receiving the message information in the fourth embodiment.

FIG. 36 is a block diagram showing an example of the general construction of the system that uses the radio pager of the fifth embodiment of the present invention.

FIGS. 37A-37C show the construction of the message information included in a received radio message in the fifth embodiment.

FIG. 38 is a schematic diagram showing data stored in the address information storage unit of the fifth embodiment.

FIG. 39 shows a specific example of the message information in the fifth embodiment.

FIG. 40 shows the appearance of the radio pager when receiving the message information in the fifth embodiment.

FIG. 41 is a block diagram showing an example of the general construction of the system that uses the radio pager of the sixth embodiment of the present invention.

FIG. 42 is a schematic diagram showing information stored in the program information storage unit of the sixth embodiment.

FIG. 43 shows the construction of the program information received by the second reception unit of the sixth embodiment.

FIG. 44 shows a specific example of the program information in the sixth embodiment.

FIG. 45 is a block diagram showing an example of the general construction of the system that uses the radio pager of the seventh embodiment of the present invention.

FIGS. 46A-46C each show the construction of the divided message information in the seventh embodiment.

FIG. 47 shows a specific example of the divided message information in the seventh embodiment.

FIG. 48 shows the message information obtained by combining the divided message information in the seventh embodiment.

FIG. 49 is a block diagram showing the radio pager of the eighth embodiment of the present invention.

FIG. 50 shows the structure of the event information stored in the event information storage unit of the eighth embodiment.

FIG. 51 shows the structure of the event identification information in the eighth embodiment.

FIGS. 52A-52C show the structure of the event condition information in the eighth embodiment.

FIG. 53 shows the structure of the event execution contents information in the eighth embodiment.

FIG. 54 shows the construction of information in the output setting information storage unit of the eighth embodiment.

FIG. 55 shows an example of the melody patterns of the sound output control information in the eighth embodiment.

FIGS. 56A and 56B show examples of giving meanings to the key information and the internal processing information included in the message in the eighth embodiment.

FIG. 57 illustrates the command information in the eighth embodiment.

FIG. 58 shows a specific example of the event information stored in the event information storage unit in the first operation example of the eighth embodiment.

FIGS. 59A and 59B each show a specific example of a received message in the first operation example.

FIG. 60 is a flowchart showing the operation of the radio pager in the first operation example.

FIG. 61 shows a specific example of the output setting information stored in the output setting information storage unit in the first operation example.

FIG. 62 shows a specific example of the output, such as the display, in the first operation example.

FIGS. 63A-63C each show a specific example of a received message in the second operation example.

FIGS. 64A and 64B show specific examples of the event information stored in the event information storage unit in the second operation example.

FIG. 65 shows a specific example of the output, such as the display, in the second operation example.

FIG. 66 shows a specific example of the event information stored in the event information storage unit in the third operation example.

FIGS. 67A and 67B each show a specific example of a received message in the third operation example.

FIG. 68 shows a specific example of the output, such as the display, in the third operation example.

FIG. 69 shows a specific example of a received message in the third operation example.

FIG. 70 shows a specific example of the event information stored in the event information storage unit in the third operation example.

FIG. 71 shows a specific example of the output setting information stored in the output setting information storage unit in the fourth operation example.

FIGS. 72A and 72B each show a specific example of the output, such as the display, in the fourth operation example.

FIG. 73 shows a specific example of a message for program information registration in the fifth operation example.

FIG. 74 shows a specific example of the program information stored in the event information storage unit in the fifth operation example.

FIG. 75 shows the structure of a received message that is processed by the program in the fifth operation example.

FIG. 76 shows a description example of the program in the fifth operation example.

FIG. 77 is a flowchart showing the operation of the program in the fifth operation example.

FIGS. 78A and 78B each show a specific example of a received message that is processed by the program in the fifth operation example.

FIGS. 79A and 79B each show a specific example of the output, such as the display, in the fifth operation example.

FIG. 80 shows a specific example of the program information stored in the event information storage unit in the sixth operation example.

FIG. 81 shows the structure of a received message that is processed by the program in the sixth operation example.

FIG. 82 shows a description example of the program in the sixth operation example.

FIG. 83 is a flowchart showing the operation of the program in the sixth operation example.

FIGS. 84A-84C each show a specific example of a received message that is processed by the program in the sixth operation example.

FIG. 85 shows a specific example of the output, such as the display, in the sixth operation example.

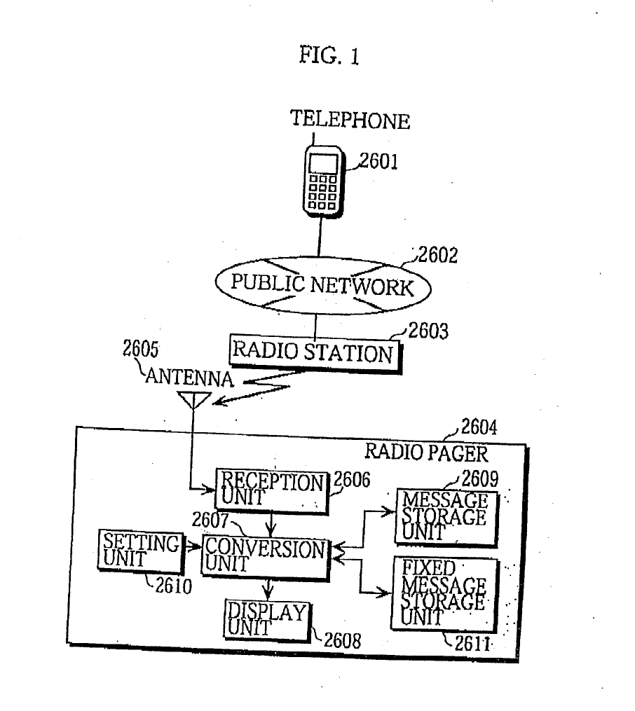

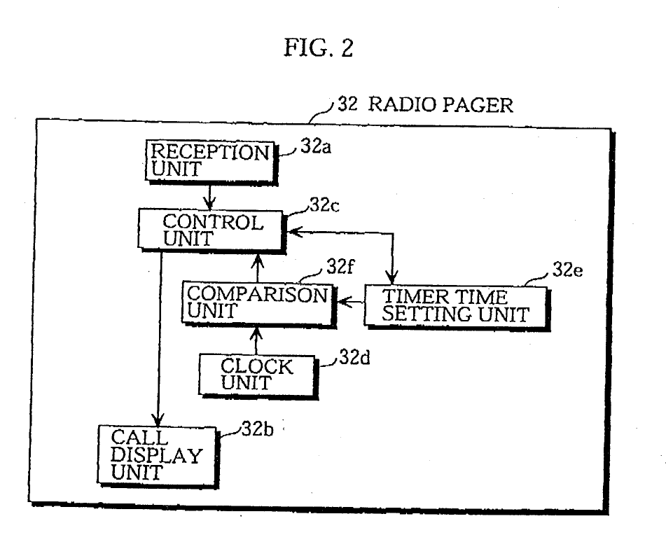

### DESCRIPTION OF THE PREFERRED EMBODIMENTS

The following is an explanation of the first and second embodiments where control information stored in the storage means relates to templates, the third to seventh embodiments where the control information relates to programs, and the eighth embodiment where the control information relates to event information.

### First Embodiment

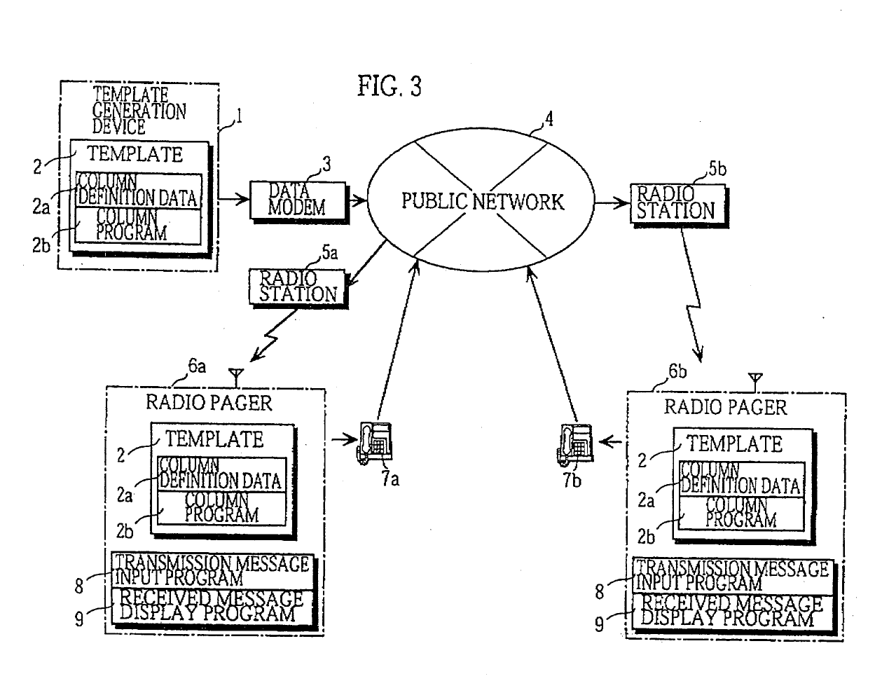

FIG. 3 is a block diagram showing an example of the general construction of a system that uses a radio pager of the first embodiment of the present invention. A template 2 generated in a template generation device 1 is transmitted to radio pagers 6a and 6b via a data modem 3, a public network 4, and radio stations 5a and 5b, respectively. Note that column definition information that includes column definition data (described later) and a column program (described later) which operates when displaying the column definition data is referred to as the template in the present embodiment.

The template generation device 1 is made up of a personal computer, a work station, and the like, and generates templates for various purposes (for example, a meeting template, a call template, and a stock price template).

The radio pagers 6a and 6b both store the template 2 which they commonly use for message transmission/reception. The template 2 includes column definition data 2a which defines a plurality of main elements (such as “person”, “time”, and “place”) that compose a message, each element being a column, and a column program 2b which relates to the column definition data 2a. The column definition data 2a and the column program 2b for all columns defined by the column definition data 2a is included in the template 2 as a set. When a message is received, the column program 2b is used for adding accessory elements determined by the contents of each column to the contents of each column and detecting a preceding message which relates to the received message.

Thus, the template 2 is distributed to and commonly used by the radio pagers 6a and 6b, so that it is no longer necessary for each user to input each self-made message commonly in a predetermined number and memorize a list which associates each self-made message with the predetermined number as being conventionally done. Also, the template 2 can be obtained easily.

When transmitting the template 2 to the users by radio, a single transmission from the template generation device 1 is sufficient to send the template 2 to the plurality of radio pagers 6a and 6b by a multi-destination delivery service of the public network 4. Accordingly, transmission time and cost can be reduced, when compared with transmitting the template 2 to the radio pagers 6a and 6b separately.

The radio pagers 6a and 6b each store a transmission message input program 8 and a received message display program 9 in advance that are commonly used for various templates. The transmission message input program 8 is used for displaying a guidance with which the user inputs the contents of each column and for receiving the inputted contents of each column according to the column definition data 2a in the template 2. The received message display program 9 is used for combining execution results of the column program 2b and displaying the combination.

Here, a message is not an indivisible unit as in the prior art but can be seen as a combination of a plurality of elements. The message is a combination of a plurality of main elements (such as “person”, “time”, and “place”) that compose the message and accessory elements (such as particles) of the main elements. The main elements tend to change according to factors such as different situations where the message is used, while the accessory elements are completely determined by the main elements. The main elements that compose the message also change according to the purpose of the message. Thus, it is necessary to determine each column of the column definition data 2a according to the purpose of the message and then make the column program 2b that is highly dependent on the column definition data 2a. Thus, the column definition data 2a and the column program 2b need to be handled as one unit.

On the other hand, the transmission message input program 8 and the received message display program 9 can be made as general-purpose programs that have low dependence on the column definition data 2a, since the input and the display of each column are possible once the contents of the column definition data 2a are set. Accordingly, the column definition data 2a and the column program 2b are treated as one unit in the template 2, and the template 2, the transmission message input program 8, and the received message display program 9 are treated as separate units.

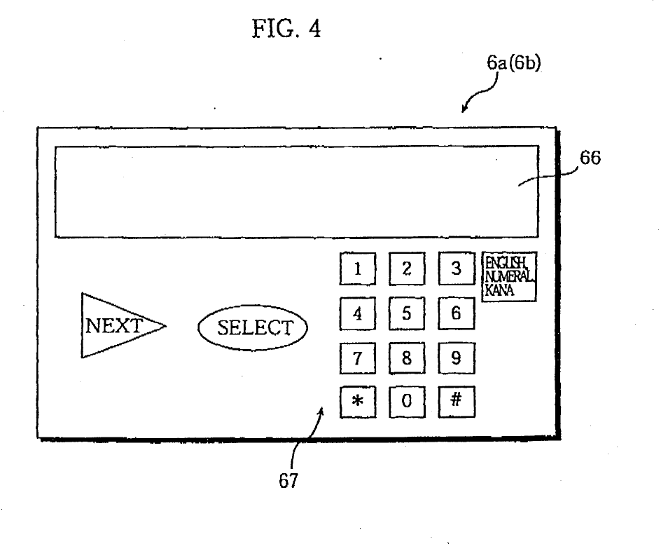

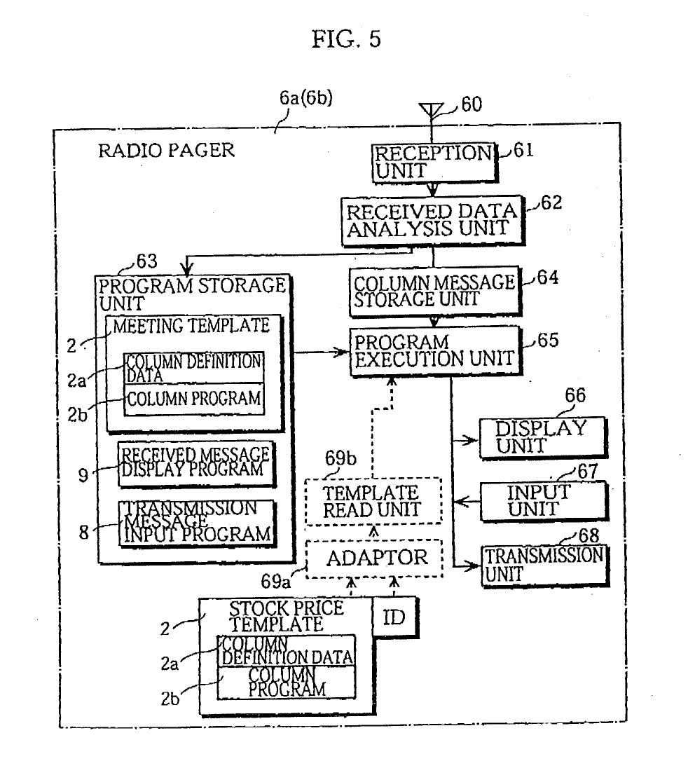

FIG. 4 shows a specific example of the appearance of the radio pager 6a (6b) shown in FIG. 3. FIG. 5 shows a specific example of the internal construction of the radio pager 6a (6b) shown in FIG. 3. The following is an explanation of the construction of the radio pager 6a (6b) with reference to FIGS. 4 and 5.

As shown in FIGS. 4 and 5, the radio pagers 6a and 6b each include an antenna 60, a reception unit 61, a received data analysis unit 62, a program storage unit 63, a column message storage unit 64, a program execution unit 65, a display unit 66, an input unit 67, and a transmission unit 68.

The received data analysis unit 62 analyzes data which is received by the reception unit 61 via the antenna 60, classifies the received data either as the template 2 composed of the column definition data 2a and the column program 2b, or as other messages, and extracts them. The program storage unit 63 stores the column definition data 2a and the column program 2b of the template 2 extracted by the received data analysis unit 62. Note that the program storage unit 63 stores the transmission message input program 8 and the received message display program 9 in advance.

The column message storage unit 64 stores the other messages which are extracted by the received data analysis unit 62. The column message storage unit 64 can also store messages inputted via the input unit 67, as well as transmission information and confirmation information that are described later. When transmitting a message, the program execution unit 65 executes the transmission message input program 8 stored in the program storage unit 63. When receiving a message, the program execution unit 65 successibly executes the column program 2b and the received message display program 9.

As shown in FIG. 4, the input unit 67 has numeral keys “1”-“0”, keys “*” and “#”, an input mode switch key, a NEXT key, and a SELECT key, with which a transmission message can be inputted. It should be noted here that the radio pager 6a (6b) cannot have a large operation unit due to its portability. Accordingly, the input mode switch key is used to switch the input mode so as to accommodate the numeral keys to not only the input of numbers but also the input of the alphabet and Japanese kana.

For instance, when the Japanese kana input mode is set by the input mode switch key, “z,10 ”, “ [symbol] ”, “ [symbol] ”, “ [symbol] ”, and “ [symbol] ” can be inputted respectively by pressing the numeral key “1” once, twice, three, four, and five times. Equally, other kana letters “ [symbol] ”-“Z,17 ” can be inputted by pressing the other numeral keys as the key “1” by appropriate times. The input of large and small letters can be switched by pressing “#” in the Japanese kana input mode.

When the alphabet input mode is set by the input mode switch key, “A”, “B”, and “C” can be inputted respectively by pressing the numeral key “1” once, twice, and three times. Equally, other alphabet letters “D”-“Z” can be inputted by pressing the other numeral keys as the key “1” by appropriate times. The input of the capital and small letters can be switched by pressing “#” in the alphabet input mode.

The display unit 66 displays a guidance for each column, an input message, a received message, and the like. The transmission unit 68 transmits the input message and other data by tone signals.

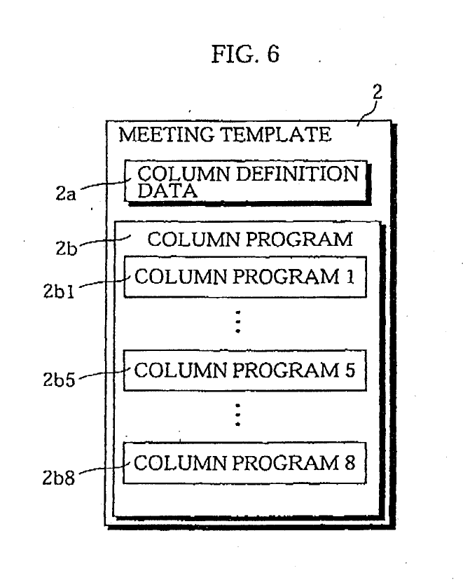

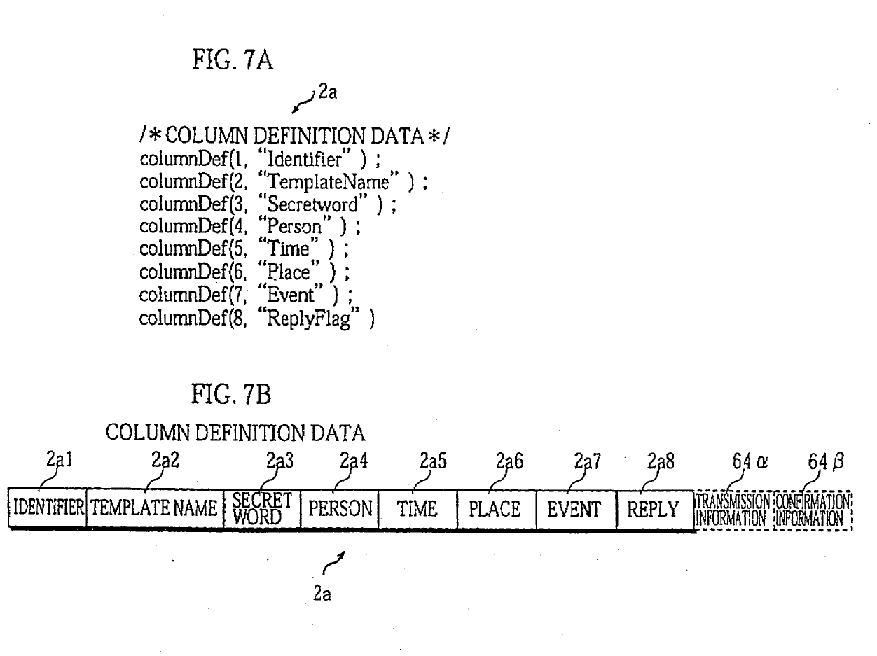

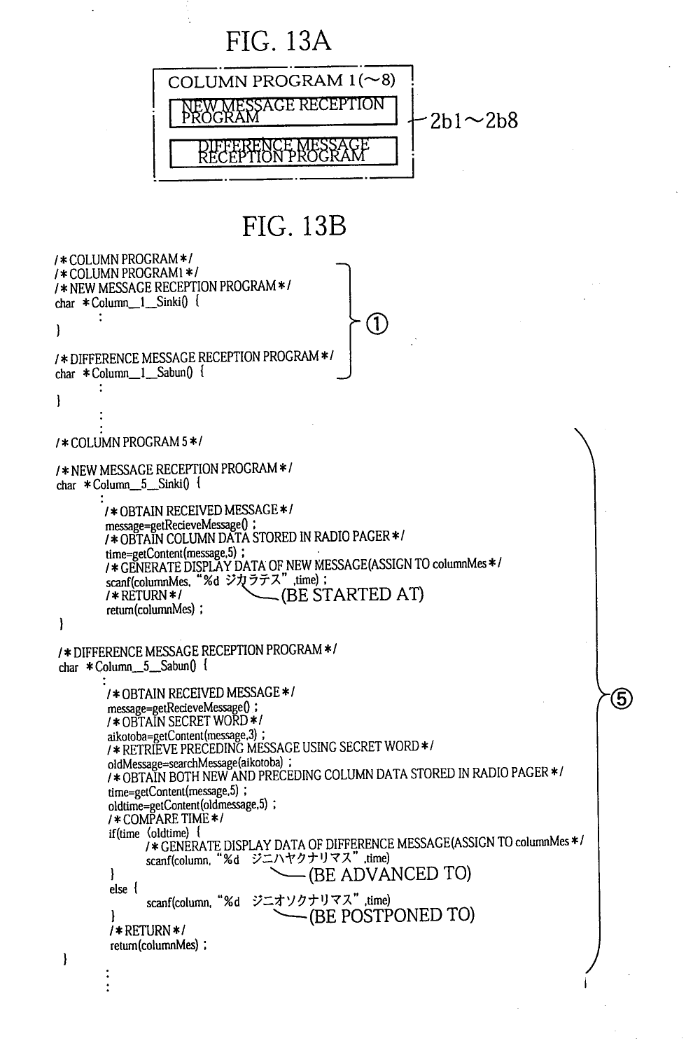

The following is an explanation of the template 2 using a meeting arrangement example. FIG. 6 shows the construction of a meeting template 2. The meeting template 2 includes the column definition data 2a (see FIG. 7) determined by the purpose, the purpose here being the meeting arrangement, and the column program 2b. The column program 2b includes a plurality of column programs 2b1-2b8 (see FIG. 13) that each correspond to a column defined in the column definition data 2a.

FIG. 7 shows an example of the construction of the column definition data 2a in the meeting template 2. FIG. 7A shows the definition of the column definition data 2a in the C program, while FIG. 7B shows the format construction of the column definition data 2a. A message generally concerns “when”, “who”, “where”, “why”, “what”, and “how” (that is, 5W1H) . Accordingly, main elements of a meeting arrangement message are “person”, “time”, “place”, “event”, and “need of reply”.

Hence the column definition data 2a in the meeting template 2 includes a person column 2a4, a time column 2a5, a place column 2a6, an event column 2a7, and a reply column 2a8, as shown in FIG. 7.

The contents of the person column 2a4 show a subject or a person, such as a transmitter of a message. The contents of the time column 2a5 show time, such as a meeting time. The contents of the place column 2a6 show a place, such as a meeting place. The contents of the event column 2a7 show an event, such as a new year party, a year-end party, and an ending party. The contents of the reply column 2a8 show the need or no need of replying to the message.

In meeting arrangement, a transmitter of the first message needs to determine all elements that are “person”, “time”, “place”, “event”, and “need of reply”. However, transmission can be made more easily when retransmitting the message that has been partially changed or when replying to the first message, since the part other than the changed part of the first message can be reused if it is clear how the message to be sent relates to the first message. Accordingly, the column definition data 2a includes an identifier column 2a1, a template name column 2a2, and a secret word column 2a3 in order to clearly show the relation to preceding messages.

The contents of the identifier column 2a1 show whether the message is a new or difference message. The contents of the template name column 2a2 show a type of the template 2 that is used for transmission/reception of the message. The contents of the secret word column 2a3 show a name of a group or the like that transmits/receives the message using the template 2. When there are a plurality of messages that are made using the same template, the secret word column 2a3 shows an identifier for distinguishing each message.

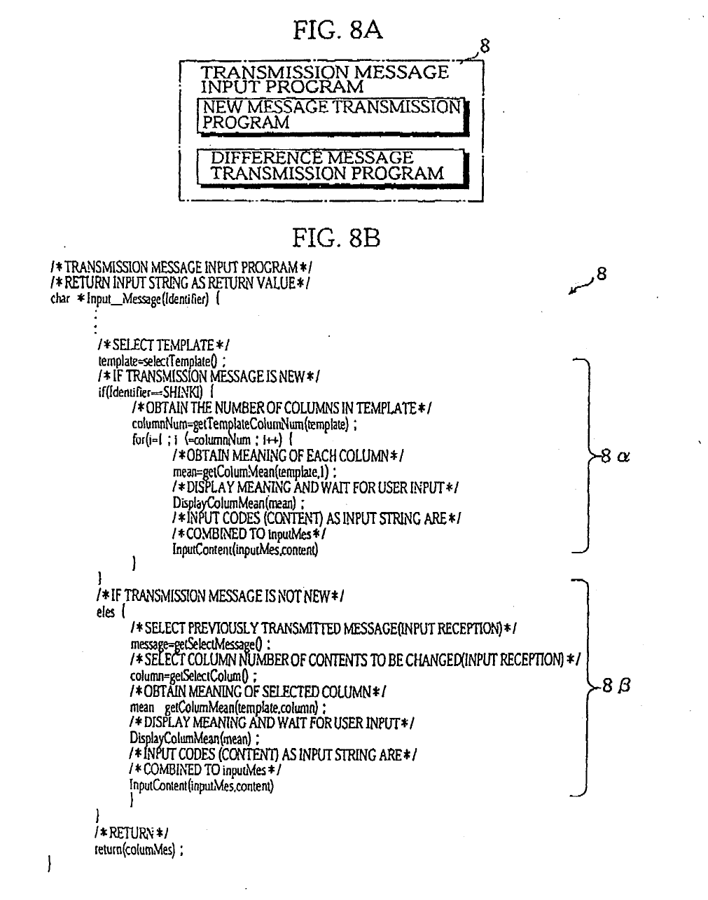

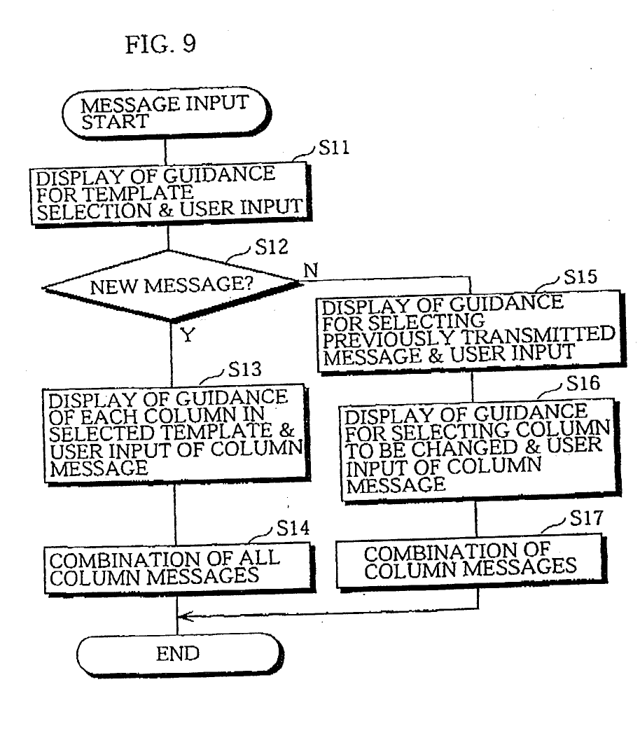

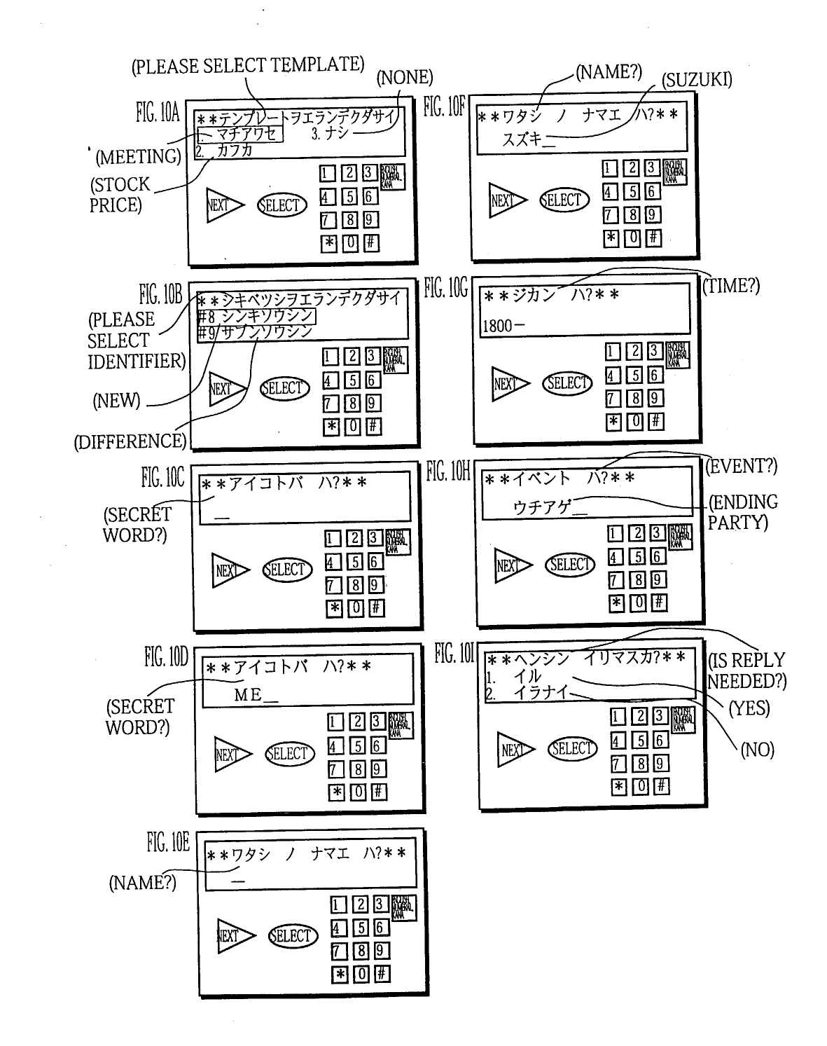

The transmission message input processing is explained next. FIGS. 8A and 8B show examples of the transmission message input program 8 shown in FIG. 3. FIG. 8A shows the general construction of the program, while FIG. 8B shows the specific program. FIG. 9 is a flowchart when the program execution unit 65 executes the transmission message input program 8. FIG. 10 shows display examples of the display unit 66.

The transmission message input program 8 generally includes a new message transmission program 8α and a difference message transmission program 8β. When an input trigger is made by the user, the transmission message input program 8 is activated by the program execution unit 65 and returns an input string as return values.

On activating the transmission message input program 8, the program execution unit 65 has the display unit 66 display a guidance for selecting a template to be used (see FIG. 10A), selects the template to be used according to the number inputted in the input unit 67 by the user (Step S11), and returns the selected template name. The program execution unit 65 then has the display unit 66 display a guidance for selecting whether a message to be transmitted is new or not (see FIG. 10B), judges whether it is the new message transmission according to the number inputted in the input unit 67 by the user (Step S12), and returns the selected identifier.

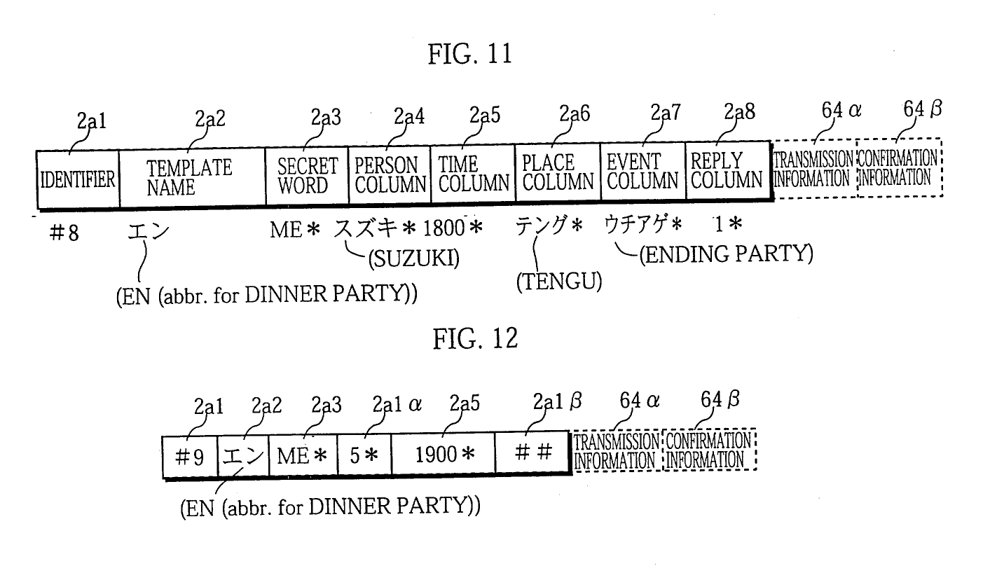

When the user selects to transmit a new message, the program execution unit 65 activates the new message transmission program 8α to execute Steps S13 and S14 and completes the program. More specifically, the program execution unit 65 obtains the number of columns of the column definition data 2a in the template 2 according to the new message transmission program 8α, obtains the meaning of each column, displays the meaning (see FIGS. 10C-10I), and waits for the user input. Here, the program execution unit 65 has the display unit 66 display a guidance of each column and waits until the user inputs the contents of each column. When the contents of all columns are inputted by the user, the contents that are input codes are combined to form an input string according to the new message transmission program 8α. By repeating this operation, a new message to be transmitted “#8 [symbol] ME* [symbol] *1800* [symbol] * [symbol] *1*” is generated as shown in FIG. 11. Thus, the user can input/make the new message to be transmitted while understanding what to input without difficulty.

FIG. 11 shows an example when a new column message is inputted in the columns of the meeting template. The contents “#8” of the identifier column 2a1 indicate that the message is new. The contents “ [symbol] ” of the template name column 2a2 indicate a meeting at a dinner party. The contents “ME*” of the secret word column 2a3 indicate a company name or the like. The contents “ [symbol] *” of the person column 2a4 indicate that the transmitter's name is Suzuki. The contents “1800*” of the time column 2a5 indicate that the dinner party starts at 18:00. The contents “ [symbol] *” of the place column 2a6 indicate that the dinner party is held at Tengu. The contents “ [symbol] *” of the event column 2a7 indicate that the dinner party is for an ending party. The contents “1*” of the reply column 2a8 indicate the need of reply.

Note that the numeral keys are used to input the above numbers, Japanese katakanas, and alphabets, the NEXT key is used to move the pointer on the template selection display in the display unit 66, and the SELECT key is used to determine the selected template and other items.

Since the person column 2a4 to the reply column 2a8 and the secret word column 2a3 have a variable data length, the terminal symbol “*” is added to data of each column, while the terminal symbol is not added to data of the identifier column 2a1 and the template name column 2a2 that have a fixed data length.

When a column message is transmitted, the column message storage unit 64 stores the column message and transmission information 64α which is added to the column message for indicating that the column message has been transmitted. In the radio pager 6a (6b), a transmission message may be created and stored in advance in the column message storage unit 64 for later transmission. Hence the transmission information 64α is used as a flag for specifying whether the message has been transmitted. When the transmission information flag shows “1”, for instance, the column message has been transmitted to a receiver. When the transmission information flag shows “0”, on the other hand, the column message has not been transmitted yet. That is to say, the receiver has already received the column message when the flag shows “1”, so that it is possible to transmit/receive a difference message that includes only the changed part of the transmitted original column message while reusing the unchanged part of the original message.

Concerning a storage form of column messages, each column of a column message may be stored separately or successively as long as the column message can be extracted as a unit.

When the user selects to transmit a difference message in Step S12 in FIG. 9, the program execution unit 65 activates the difference message transmission program 8β to execute Steps S15-S17 and then completes the program. More specifically, on activating the difference message transmission program 8β, the program execution unit 65 waits until the user selects one of messages which have been transmitted between the user and the receiver of the difference message (Step S15). When the user selects one message (such as the message shown in FIG. 11), the program execution unit 65 waits until the user inputs a column number of the contents to be changed according to the difference message transmission program 8β. When the user selects the column number, the program execution unit 65 obtains the meaning of the column of the selected number, displays the meaning, and waits for the user input. Here, the program execution unit 65 has the display unit 66 display a guidance of the column whose contents are to be changed and waits until the user inputs the new contents of the column (Step S16). When the user inputs the contents, the program execution unit 65 combines the contents that are input codes to form an input string according to the difference message transmission program 8β (Step S17). As a result, the difference message is made that includes the contents of the columns 2a1-2a3 as parameters for selecting the preceding message that is the basis of the difference message, the contents of a column 2a1α that show the changed part, and the changed contents of the column 2a5 as shown in FIG. 12. Thus, the user can input/make the difference message to be transmitted while understanding what to input without difficulty.

FIG. 12 shows the difference message for changing the time in the message shown in FIG. 11. The contents “#9” of the identifier column 2a1 indicate that the message is a difference message. The contents “ [symbol] ” of the template name column 2a2 indicate that the template for meeting at a dinner party is used. The contents “ME*” of the secret word column 2a3 indicate the company name. The contents “*5” of the column 2a1α indicate that the column to be changed by the key input is the fifth column that is the time column 2a5. The contents “1900” of the time column 2a5 indicate that the time is changed to 19:00. The contents “##” of a column 2a1β is a terminal signal 93 that shows the end of the difference message. Note that the columns 2a1α and 2a1β are generated when the contents “#9” which indicates the difference message are inputted in the column 2a1.

The radio pagers described above can also be used in the same way as the prior art, since messages can be inputted using free words as in the conventional way if the template 2 is not specified.

With the present embodiment, a change message is created by specifying a part and its contents to be changed in a preceding message stored in the column message storage unit 64 according to the user operation. Accordingly, it is sufficient to input the changed contents, that is, the difference, so that the message input and transmission can be performed easily. It is unnecessary to transmit data other than the difference with the preceding message, so that a needless repetition of message transmission can be avoided.

Also, by storing the column definition data that defines the columns which compose the main part of a message and storing the contents of each column of preceding messages, the part to be changed can easily be specified.

Also, when the user specifies the part and its contents to be changed, a guidance for the user operation is displayed for each column. Accordingly, the difference with the preceding message can easily be inputted.

Also, the transmission information 64α is added to each preceding message stored in the column message storage unit 64 so as to indicate whether the receiver of a difference message has a corresponding preceding message. Accordingly, it is possible to create messages beforehand and to confirm that the receiver certainly has the preceding message from which the difference message is originated.

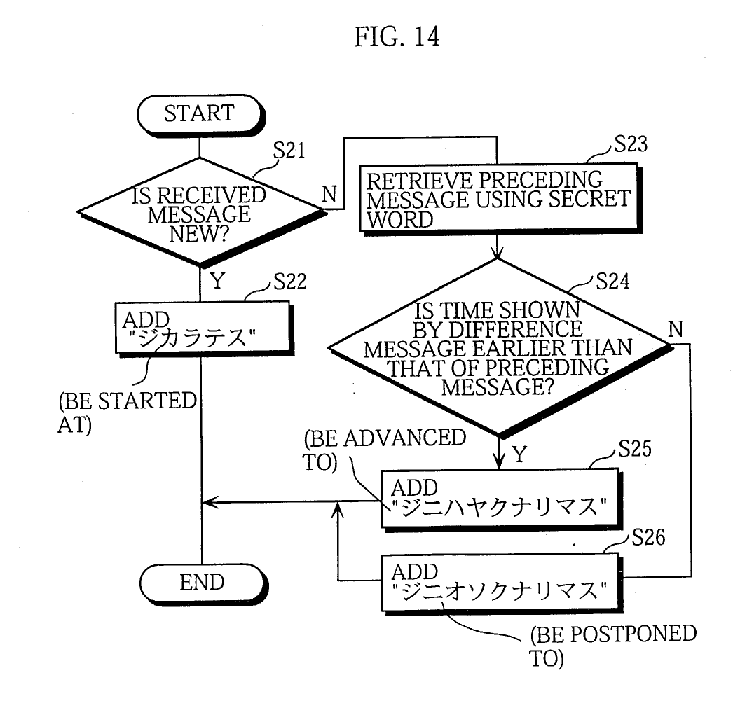

The following is an explanation of the message reception. FIG. 13 shows an example of the column program 2b shown in FIG. 3. FIG. 13A shows the general construction of the program, while FIG. 13B partially shows the definition in the C program. The code \mathring{1} in FIG. 13B partially shows a column program 2b1 that corresponds to the identifier column 2a1 of a received message, while the code \mathring{5} partially shows a column program 2b5 that corresponds to the time column 2a5 of the received message. FIG. 14 is a flowchart when the program execution unit 65 executes the column program 2b shown in FIG. 13.

The column program 2b includes a plurality of column programs 2b1-2b8 that respectively correspond to the identifier column 2a1 to the reply column 2a8 in the column definition data 2a. The column programs 2b1-2b8 each has new and difference message versions. When a message is received, the column program 2b is activated by the program execution unit 65.

First, the program execution unit 65 executes the column program 2b1 in the column program 2b to check the contents of the identifier column 2a1 of the received message and to judge whether the message is a new or difference message according to whether the identifier is “#8” or “#9” (Step S21; see FIGS. 11 and 12). When the message is new, the program execution unit 65 proceeds to Step S22 and successively executes the column programs 2b4-2b8. For example, when executing the column program 2b5, “ [symbol] ” (BE STARTED AT) is added to the contents “1900” of the time column of the received message to make a display message. The program execution unit 65 then completes the program. As a result, the display message “ [symbol] [symbol] 1800 [symbol] [symbol] [symbol] ” (THE ENDING PARTY AT TENGU IS STARTED AT 18:00. SENDER: SUZUKI. REPLY NEEDED) is generated from the received message “#8I [symbol] ME* [symbol] *1800* [symbol] * [symbol] *1*”. Note that the particles “ [symbol] ”, “ [symbol] ”, “ [symbol] ”, and “ [symbol] ” in the display message are accessory message elements which are added according to the column program 2b.

When the received message is a difference message, the program execution unit 65 proceeds to Step S23 and retrieves a corresponding preceding message by referring to the contents of the template name column 2a2 and the secret word column 2a3 of the received difference message as parameters. The program execution unit 65 then successively executes the column programs 2b4-2b8. For example, when executing the column program 2b5, the contents of the time columns 2a5 of the preceding message and the difference message are compared to judge whether the time in the time column 2a5 of the difference message is earlier than the time in the time column 2a5 of the preceding message (Step S24).

When the time of the difference message is earlier than that of the preceding message as a result of the comparison in Step S24, the program execution unit 65 adds [symbol] (BE ADVANCED TO) to the contents of the time column of the difference message to make a display message and completes the program (Step S25). On the other hand, when the time of the difference message is later than that of the preceding message, the program execution unit 65 adds [symbol] (BE POSTPONED TO) to the contents of the time column of the difference message to make a display message and completes the program (Step S26).

Accordingly, when receiving the difference message “#9I [symbol] ME*5*1900*##” after the message “#8( [symbol] ME* [symbol] *1800* [symbol] * [symbol] [symbol] *1*” was received, the display message [symbol] 1900 [symbol] (THE ENDING PARTY AT TENGU IS POSTPONED TO 19:00. SENDER: SUZUKI. DIFFERENCE) is generated from the above difference message. Note that the particles [symbol] in the display message are accessory message elements which are added according to the column program 2b.

When storing a new or difference column message received from a transmitter into the column message storage unit 64, a flag “1” is set in the transmission information 64α in the received column message. By doing so, it shows that the transmitter has the column message, so that the user can reuse an unchanged part of the column message.

The column program 2b5 which corresponds to the time column 2a5 may often be used in other templates. Such a column program that is likely to be used in the other templates can be shared by each column program 2b by adding information such as a template name to that column program and storing it in the received message display program 9, rather than each template separately having the column program.

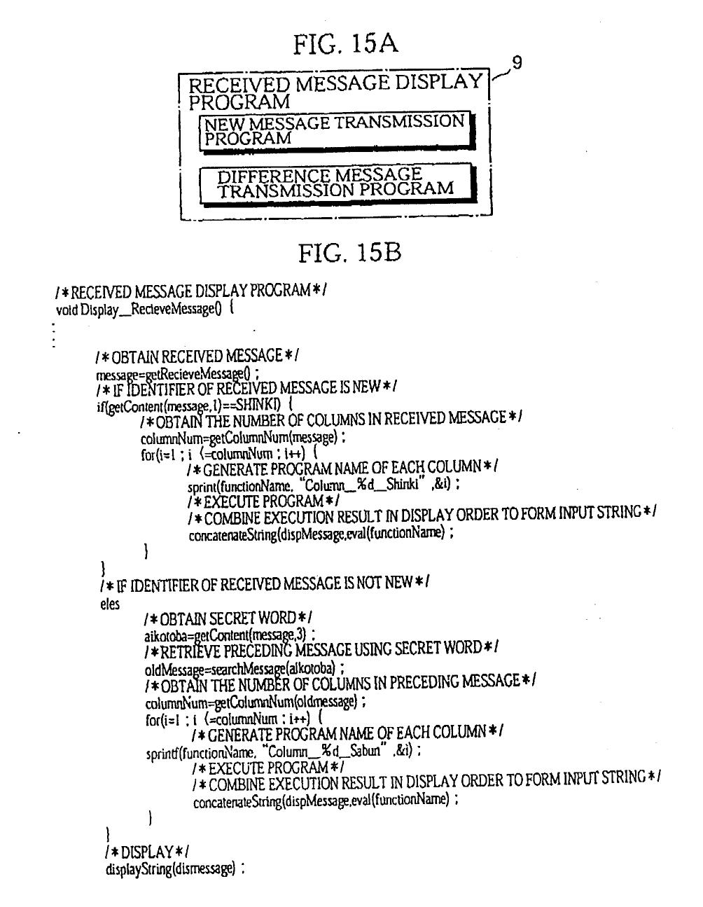

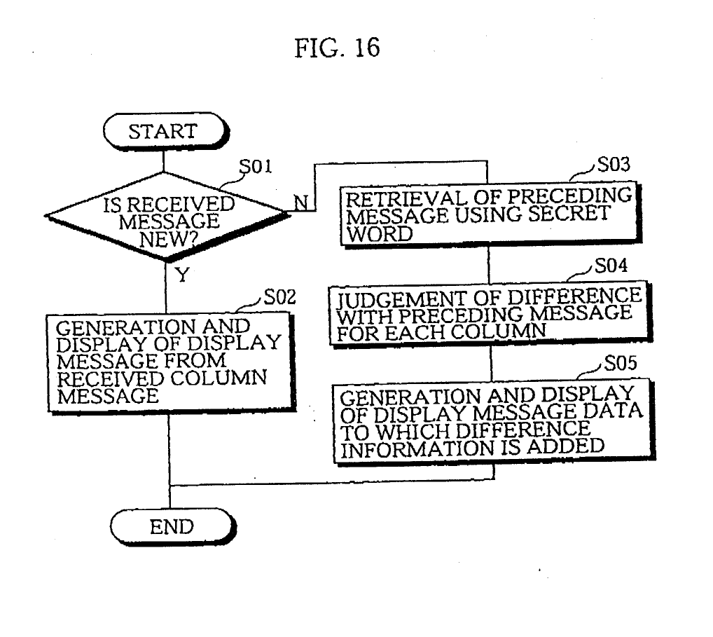

The message display is explained next. FIG. 15 shows an example of the received message display program 9 shown in FIG. 3. FIG. 15A shows the general construction of the program, while FIG. 15B partially shows the definition in the C program. FIG. 16 is a flowchart showing the execution of the received message display program 9 in FIG. 15 by the program execution unit 65.

The received message display program 9 has new and difference message versions. When a message is received, the received message display program 9 is activated by the program execution unit 65. On receiving the message, the program execution unit 65 first activates the received message display program 9 and refers to the contents of the identifier column 2a in the received message to judge whether the received message is new (Step S01).

When the received message is judged to be new in Step S01, the program execution unit 65 generates a display message using the received new message, displays the display message, and completes the program (Step S02). Here, the program execution unit 65 obtains the number of columns included in the received new message, arranges each display message element obtained as a result of the execution of the column program 2b in a display order, and combines each display message element to display the display message.

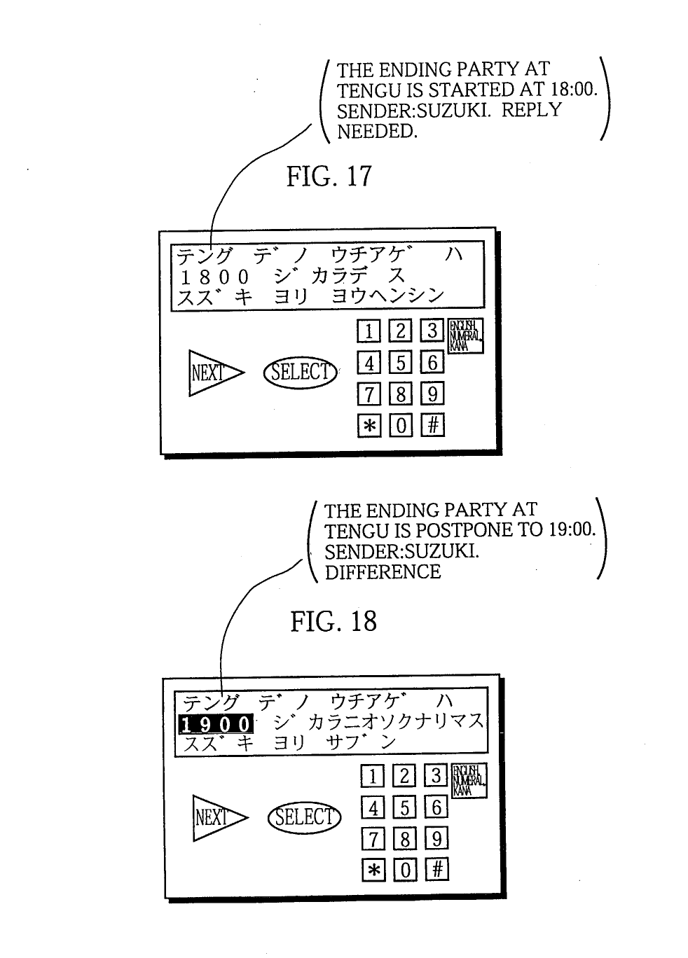

Consequently, when receiving the message shown in FIG. 11, the display unit 66 displays the display message “ [symbol] [symbol] 1800 [symbol] [symbol] [symbol] ” that is easier to understand than the received message “#8I [symbol] ME* [symbol] *1800* [symbol] * [symbol] *1*”, as shown in FIG. 17. “ [symbol] ” is displayed in order to clearly show that the transmitter of the message requires the user's reply.

When the received message is judged to be a difference message in Step S01, the program execution unit 65 retrieves a corresponding preceding message using a secret word included in the received difference message (Step S03). The program execution unit 65 then performs comparisons, substitutions, and computations on each column of the preceding message and the difference message to judge what is different from the preceding message (Step S04), creates a display message that includes difference information, and completes the received message display program 9 (Step S05). Thus, when receiving a difference message, the program execution unit 65 obtains a secret word of the difference message and retrieves a corresponding preceding message using the secret word. The program execution unit 65 then obtains the number of columns in the preceding message, arranges display message elements obtained by executing the column program 2b in a display order, and combines the display message elements to display a display message.

Consequently, when receiving the message shown in FIG. 12, the display unit 66 displays “ [symbol] ” so that the user can easily understand that the meeting time shown in the preceding message has been postponed by the difference message, as shown in FIG. 18. “ [symbol] ” is displayed to show that the message is the difference message, while the changed time “1900” is highlighted to make it easy to understand that the meeting time has been changed.

When the radio pager does not have a template that corresponds to a received message, the received message is directly displayed in the display unit 66 with the display informing that the pager does not have the corresponding template.

With the present embodiment, when receiving a change message which shows a changed part and its contents in respect to a preceding message stored in the column message storage unit 64, a display message is created from the preceding message and the changed part of the received message. Accordingly, a whole message in which the unchanged part of the preceding message is combined with the changed part of the received message is displayed, so that the user can easily understand the message.

Also, by storing the column definition data 2a that defines the columns which compose the main part of a message and storing the contents of each column of preceding messages, a display message can be created according to the definition of each column, thus making the message easier to understand. Also, by displaying the message as sentences by combining the contents of the columns and respective accessory message elements in the display unit 66, the message can be easily understood.

Also, when the program execution unit 65 executes the column program 2b and makes a display message, the difference from the preceding message to the difference message in the column to be changed are taken into consideration. Accordingly, the display message is created in accordance with the difference so as to be easily understood.

The following is an explanation of the case when transmitting a reply message in response to the display message in FIG. 17 which is displayed on receiving the message shown in FIG. 11. A radio pager of the transmitter of the reply message has a preceding message that is the basis of the reply message. Thus, it is easier to make a difference message by partially changing the preceding message rather than making a whole message again. Hence the case when the reply message is inputted as the difference message is explained below.

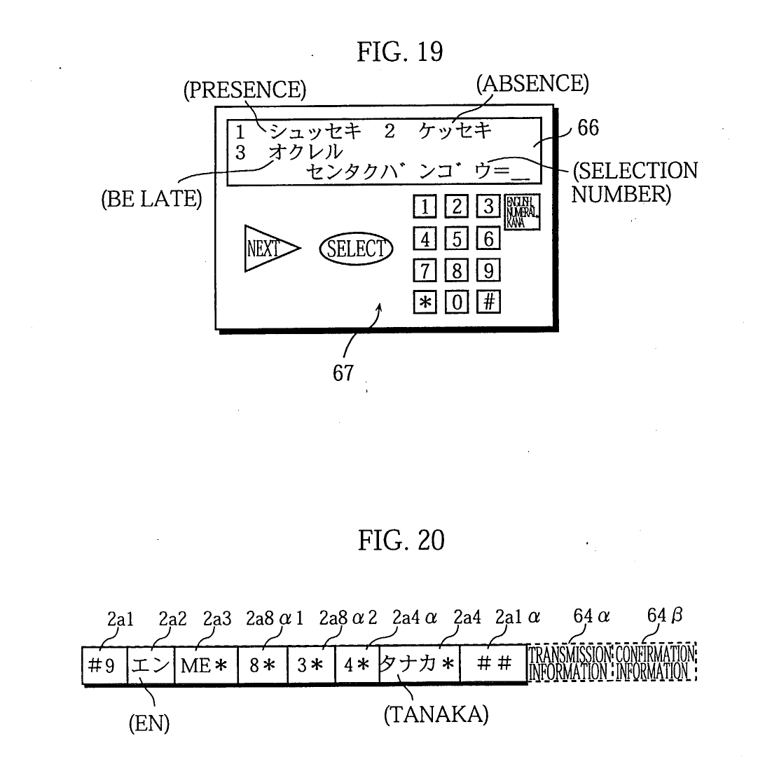

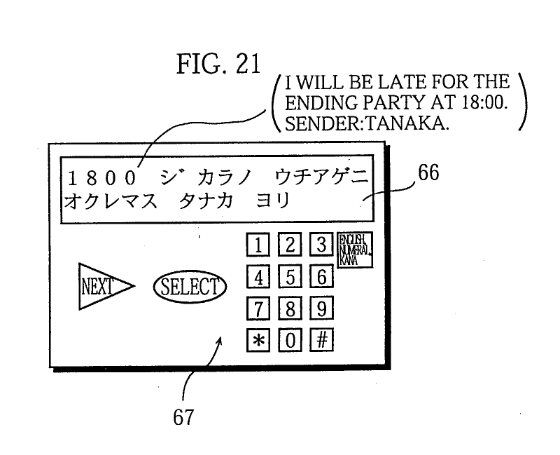

FIG. 19 shows an example of a guidance display for inputting the reply message as the difference. FIG. 20 shows the difference reply message to be transmitted/received. FIG. 21 shows a message displayed when receiving the reply message.

On receiving the message shown in FIG. 11, the program execution unit 65 activates the transmission message input program 8 and obtains the contents of the columns 2a1-2a8 of the received message. Since the reply column 2a8 of the received message has the contents. “1*” indicating the need of reply, a guidance such as “ [symbol] ” is displayed in the display unit 66. The transmitter of the reply message selects “ [symbol] ” by operating the input unit 67. As a result, the program execution unit 65 obtains the contents of the columns 2a1-2a3 and 2a8α1 “#9”, “ [symbol] ”, “ME*”, and “8*” as return values and has the display unit 66 display guidances for inputting information such as attendance at or absence from the dinner party. When the transmitter selects the selection number “3” indicating “ [symbol] ” (BE LATE), the program execution unit 65 obtains “3*” as return values. Also, since the transmitter of the reply message is different from the transmitter “ [symbol] ” of the message shown in FIG. 11, the program execution unit 65 displays the guidance shown in FIG. 10E. The transmitter of the reply message inputs his or her name “ [symbol] ” (TANAKA) in the input unit 67. The program execution unit thus obtains “3*”, “4*”, “ [symbol] *”, and “##” as return values of the columns 2a8α2, 2a4α, 2a4, and 2a1α. As a result, the reply message shown in FIG. 20 is generated.

In FIG. 20, the contents “#9” of the identifier column 2a1 indicate that the reply message is a difference message. The contents “ [symbol] ” of the template name column 2a2 indicate a meeting at a dinner party. The contents “ME*” of the secret word column 2a3 indicate a company name. The contents “8*” of the column 2a8α1 indicate that the reply is in response to the contents “1*” of the reply column 2a8 that require the reply. The contents “3*” of the column 2a8α2 indicate the selection number “3” for “ [symbol] ” shown in FIG. 19. The contents “4*” of the column 2a4α indicate that the part to be changed is the fourth column, that is, the person column 2a4. The contents “ [symbol] *” of the person column 2a4 indicate the changed contents. The contents “##” of the column 2a1α is a terminal signal of the difference message.

Note that the column 2a8α1 is automatically set when replying to a reply requirement. The column 2a8α2 is automatically set when the part to be changed is specified. The column 2a1α is automatically set when creating a difference message.

When another radio pager receives the reply message shown in FIG. 20, the program execution unit 65 in the radio pager executes the column program 2b to obtain the contents of the column 2a1-2a4, 2a8α1, 2a8α2, and 2a1α of the message shown in FIG. 20. Since the contents “#9” of the column 2a1 indicates the difference and the contents “1*” of the reply column 2a8 indicates the need of reply, the program execution unit 65 retrieves the preceding message shown in FIG. 11 by referring to the contents of the columns 2a2 and 2a3. The program execution unit 65 uses the preceding message and the reply message to make a display message that contains the contents of columns, such as the time and event columns, which are not included in the reply message. The program execution unit 65 then activates the received message display program 9 and has the display unit 66 display the display message “1800 [symbol] [symbol] [symbol] ” (I WILL BE LATE FOR THE ENDING PARTY AT 18:00. SENDER: TANAKA) as shown in FIG. 21.

With the present embodiment, in response to a reply requirement, the user specifies a part and its contents to be changed in the preceding message stored in the column message storage unit 64 in order to make a change message. Accordingly, it is sufficient to input the changed contents, that is, the difference with the preceding message, so that the message input and transmission can be performed easily. Also, since it is unnecessary to transmit data other than the difference with the preceding message, a needless repetition of message transmission can be avoided.

Also, by storing the column definition data that defines the columns which compose the main part of a message and storing the contents of each column of preceding messages, the part to be changed can easily be specified.

Also, when the user specifies the part and its contents to be changed, a guidance for the user operation is displayed for each column. Accordingly, the difference with the preceding message can easily be inputted.

Also, the transmission information 64α is added to each preceding message stored in the column message storage unit 64 so as to indicate whether the receiver of a difference message has a corresponding preceding message. Accordingly, it is possible to create messages beforehand and to confirm that the receiver certainly has the preceding message from which the difference message is originated.

Also, when receiving a reply message as a difference message, a display message is created from the preceding message and the changed part and its contents shown in the received reply message. Accordingly, a whole message in which the unchanged part of the preceding message is combined with the changed part of the received message is displayed, so that the user can easily understand the message.

Also, by storing the column definition data 2a that defines the columns which compose the main part of a message and storing the contents of each column of preceding messages, a display message can be created according to the definition of each column, thus making it further easier to understand the message. Also, by displaying the message as sentences by combining the contents of the columns and respective addition message elements in the display unit 66, the message can easily be understood.

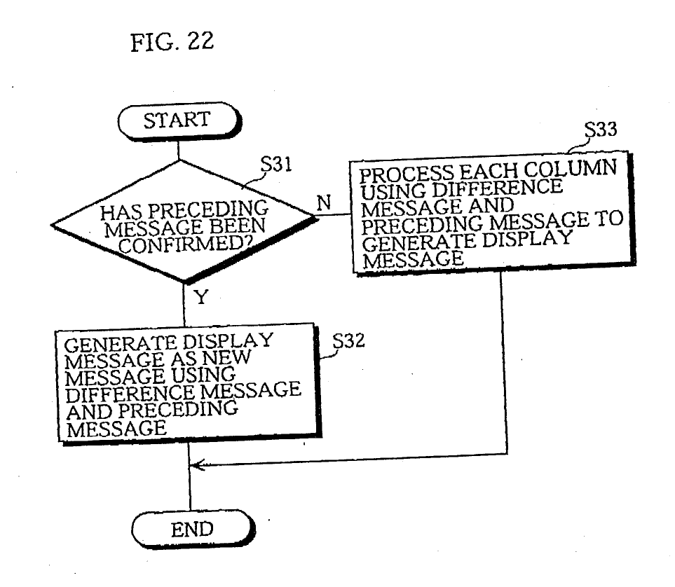

FIG. 22 is a flowchart showing the operation of creating other display messages in the first embodiment. When receiving a plurality of messages, the receiver may not be able to confirm each message immediately after the receipt. For instance, if meeting time is changed from 3:00 to 5:00 and then further changed from 5:00 to 4:00 and if the receiver confirms each received message, he or she can understand these changes. However, for the receiver who has confirmed a message specifying the meeting time at 3:00 but not a message indicating the change of the meeting time from 3:00 to 5:00, a display that informs of the change from 5:00 to 4:00 with the accessory message element “ [symbol] ” would be confusing, since the receiver assumes that the meeting time has changed from 3:00 to 4:00.

In order to solve this problem, when a received message is confirmed by the receiver, confirmation information 64β showing that the message has been confirmed is added to the received message which is stored in the column message storage unit 64. For example, a flag “1” in the confirmation information 64β shows that the message has been confirmed, while a flag “0” in the confirmation information 64β shows that the message has not yet been confirmed.

On receiving and displaying a difference message, the program execution unit 65 activates the received message display program 9 and retrieves a flag of the confirmation information 64β of an immediately preceding message to judge whether the immediately preceding message has been confirmed (Step S31). When the immediately preceding message has been confirmed, the program execution unit 65 proceeds to Step S32 to create a display message using the changed contents of the column in the difference message in respect to the immediately preceding message as a new message and completes the program. Which is to say, when the receiver has confirmed both the message specifying 3:00 and the message indicating the change from 3:00 to 5:00 or when the receiver has confirmed only the message indicating the change from 3:00 to 5:00, the change to 4:00 is displayed with the display message element “ [symbol] ”.

When, on the other hand, the immediately preceding message has not been confirmed in Step S31, the program execution unit 65 proceeds to Step S33 to create a display message by processing the difference message and received preceding messages for each column and completes the program. Which is to say, when the receiver has confirmed neither the message specifying 3:00 nor the message indicating the change from 3:00 to 5:00, the change to 4:00 is displayed with the display message element “ [symbol] [symbol] ”.

With the present embodiment, the confirmation information 64β showing whether a message has been confirmed by the receiver is added to each preceding message stored in the column message storage unit 64. Accordingly, when the program execution unit 65 executes the column program 2b and the received message display program 9 to create a display message, the program execution unit 65 checks whether a corresponding preceding message has been confirmed. Thus, the display message is created in accordance with a confirmation/non-confirmation of the corresponding preceding message, so that the user can understand the display message more easily.

Note that while the programs are written in the C language in the above embodiment, the programs may be written in any programming languages, such as the assembler, C++, Tcl, PostScript, and Java.

Also, while each radio pager is described as an independent device in the above embodiment, the radio pager may be installed in a radio device, such as a PHS (Personal Handyphone System), a portable phone, or a PDA (Personal Digital Assistant).

The programs in the radio pager may also be written in other programming languages, such as the assembler and PASCAL.

### Second Embodiment

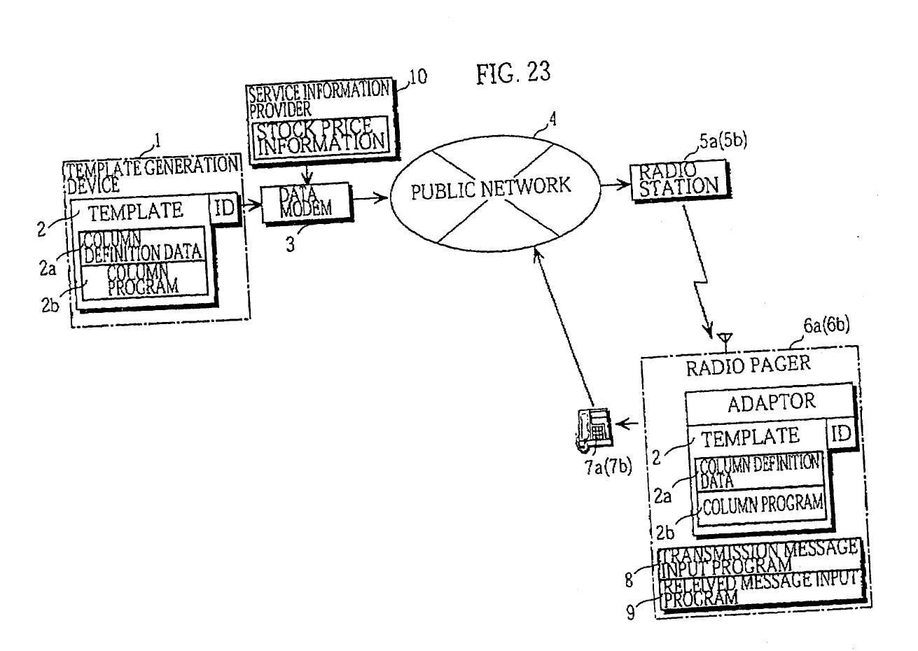

FIG. 23 is a block diagram showing the general construction of the system that uses the radio pager of the second embodiment of the present invention. In this system, the template generation device 1 issues a card that stores the template 2 and an ID unique to a user and sends the card to each user by mail or other means. The radio pagers 6a and 6b each place the card in an adaptor 69a and as a result the template 2 is stored into the program storage unit 63 by a template read unit 69b (see FIG. 5). Alternatively, the card itself may be used as the program storage unit 63. Also, the template 2 may be sent by radio, while a card which stores the ID is sent by mail and placed in the adaptor 69a.

The program execution unit 65 of the radio pager 6a (6b) in this system can use the column definition data 2a and execute the column program 2b in the template 2 if the radio pager possesses the ID. The column program 2b included in a stock price template 2 is designed so that a price of each stock periodically sent from a service information provider 10 as a difference message is compared with a previous price shown in a preceding message and accordingly the difference message is displayed with comments such as “ [symbol] ” (INCREASE) and “ [symbol] ” (DECREASE). The column program 2b may also be designed so that the message is displayed only when a price exceeds a threshold value which has been set for each specified stock. Also, the transmission message input program 8 may be designed so that the user can trade stocks according to a rise and fall in the prices.

As described above, the template 2 is used by placing the card which includes the template 2 into the adaptor 69a in the present embodiment. The column definition data is sent to and commonly used by users, so that it is unnecessary for each user to commonly input each self-made message in a predetermined number and memorize a list which associates each self-made message with the corresponding predetermined number as being conventionally done. Also, the column definition data can be obtained easily.

The third to seventh embodiments are explained next where the control information stored in the storage means relates to programs.

### Third Embodiment

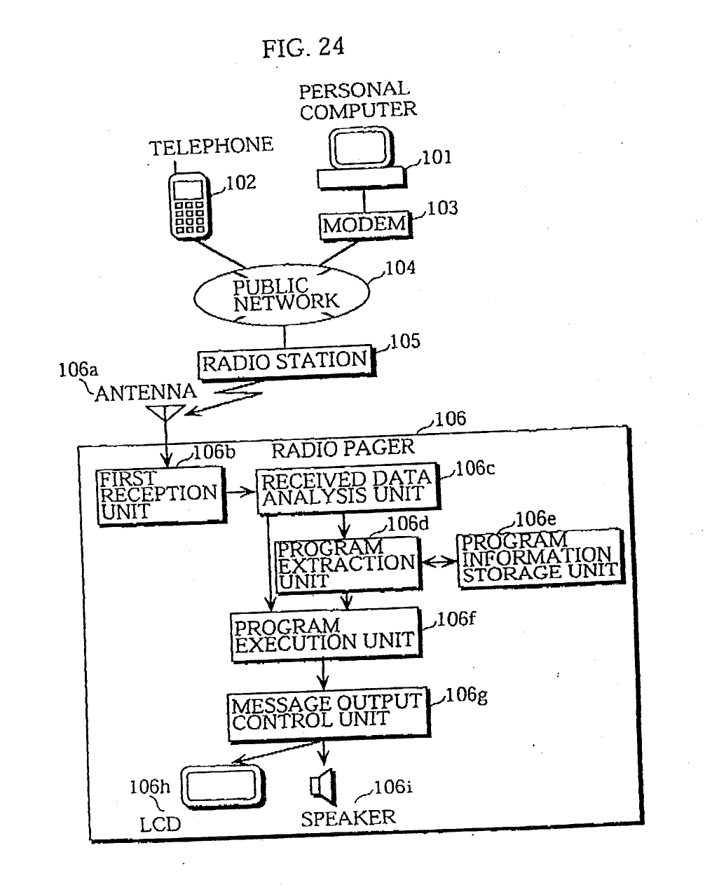

FIG. 24 is a block diagram showing an example of the general construction of the system that uses the radio pager of the third embodiment of the present invention.

In the figure, a message inputted using a personal computer 101 is transmitted to a radio pager 106 as a radio message via a modem 103, a public network 104, and a radio station 105. A message inputted using a telephone 102 is transmitted to the radio pager 106 as a radio message via the public network 104 and the radio station 105.

The public network 104 provides a number/kana service, an alphanumeric service, a free sentence service, and a transparent data service. The number/kana service is to transmit the numbers 0-9 and the Japanese kana, as well as symbols such as a hyphen. The alphanumeric service is to transmit the numbers 0-9 and the alphabet. The free sentence service is to transmit free sentences by using a combination of two-digit numbers to express letters. The transparent data service is to transmit radio messages sent from a transmitter in the binary form.

The radio pager 106 includes an antenna 106a, a first reception unit 106b, a received data analysis unit 106c, a program extraction unit 106d, a program information storage unit 106e, a program execution unit 106f, a message output control unit 106g, an LCD (liquid crystal display) 106h, and a speaker 106i.

The first reception unit 106b judges whether a radio message received via the antenna 106a is for the radio pager 106. When the message is for the radio pager 106, the first reception unit 106b sends the message to the received data analysis unit 106c.

The received data analysis unit 106c analyzes the radio message sent from the first reception unit 106b and extracts message header information and message contents information (described later) from the analyzed message information. The received data analysis unit 106c then extracts program information (described later) and each message contents group respectively from the message header information and the message contents information.

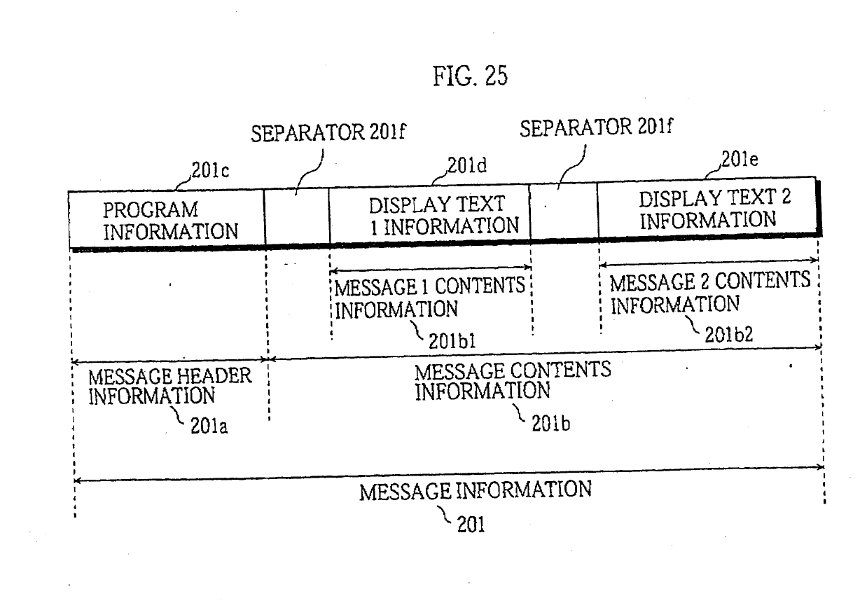

The construction of the message information is explained below with reference to FIG. 25.

In the figure, message information 201 is composed of message header information 201a and message contents information 201b. The message header information 201a is composed of program information 201c for identifying a program stored in the radio pager 106. The message contents information 201b is composed of message contents 1 information 201b1, message contents 2 information 201b2, and separators 201f. The message contents 1 information 201b1 is composed of display text 1 information 201d, while the message contents 2 information 201b2 is composed of display text 2 information 201e.

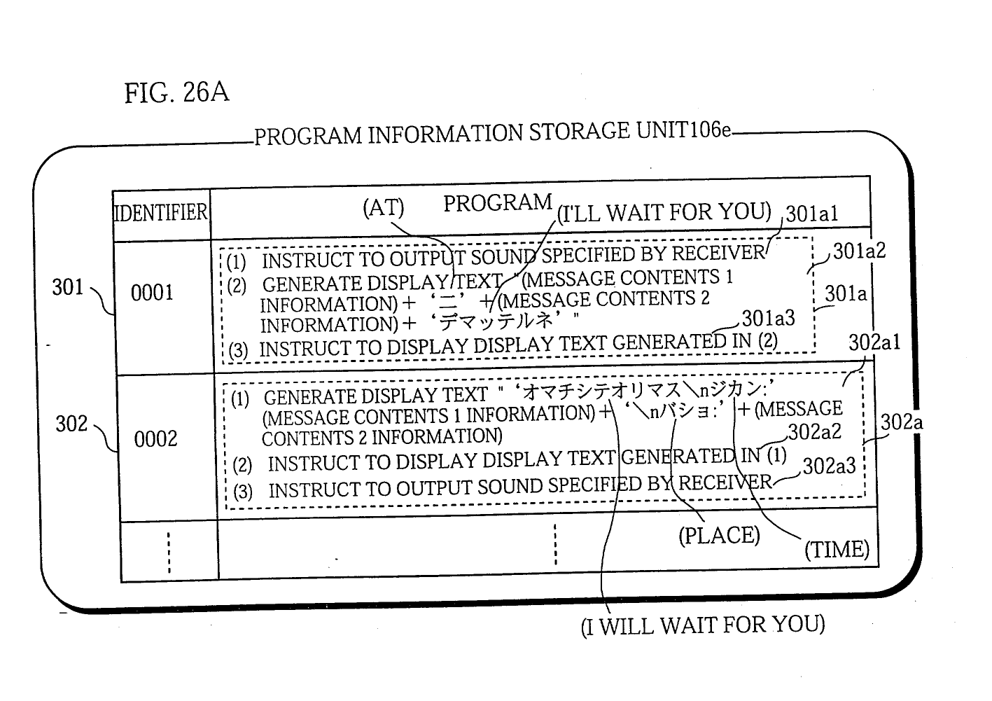

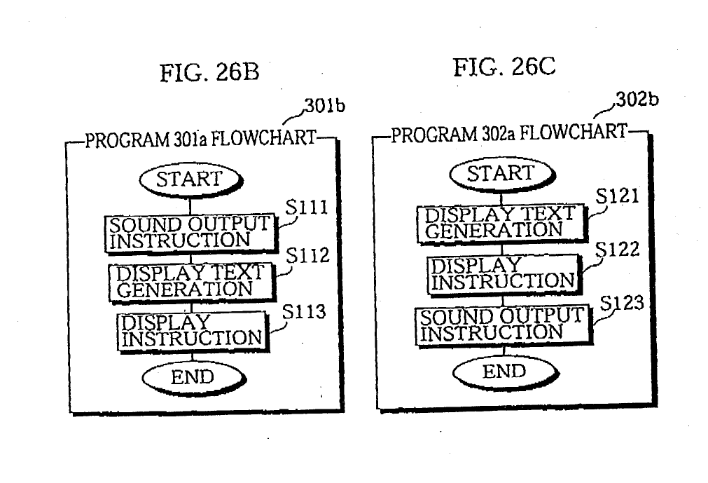

The program information storage unit 106e stores each combination of an identifier and a program in a conceptual form as shown in FIG. 26.

In the figure, a combination 301 shows that program 301ahas an identifier 0001. Program 301a includes sub programs 301a1, 301a2, and 301a3. Sub program 301a1 is a program for instructing to output a sound that is specified by a receiver in advance in the radio pager 106. Sub program 301a2 is a program for generating a display text “(the message contents 1 information 201b1)+‘ [symbol] ’+(the message contents 2 information 201b2)+‘ [symbol] [symbol] ’” using the display text information included in the message contents 1 information 201bl and the message contents 2 information 201b2 in the message information 201. For instance, when the display text information of the message contents 1 information 201b1 is “12 [symbol] ” (12:00) and the display text information of the message contents 2 information 201b2 is “ [symbol] ” (UMEDA), sub program 301a2 generates a display text “12 [symbol] [symbol] ” (I'LL WAIT FOR YOU AT 12:00 IN UMEDA). Sub program 301a3 is a program for instructing to display the display text generated by sub program 301a2. The processing of program 301a is shown below with reference to the flowchart 301b. The processing proceeds in numerical order.

(1) Instruct to output the sound specified by the receiver (Step S111).

(2) Generate the display text “(message contents 1 information 201b1)+‘ [symbol] ’+(message contents 2 information 201b2)+‘ [symbol] ’” (Step S112).

(3) Instruct to display the display text generated in Step S112 (Step S113).

An example program written in the programming language Tcl is shown below as a specific example of program 301a. Each comment is given the code #.

# Instruct to output the sound specified by the receiver.

# Note that sound specification information of the receiver is stored in a variable userdefsound.

execsound $userdefsound

# Generate a display text.

# Note that the generated display text is stored in a variable disptxt.

# Note that display texts of the message contents 1 information and the message contents 2 information are respectively stored in variables msg1info and msg2info.

set disptxt [join[list $msg1info“ [symbol] ”$msg2info“ [symbol] ”]””]

# Instruct to display.

execdisp $disptxt (End)

In FIG. 26, a combination 302 shows that program 302a has an identifier 0002. Program 302a includes sub programs 302a1, 302a2, and 302a3. Sub program 302a1 generates a display text “‘ [symbol] \n [symbol] :’+(message contents 1 information 201b1)+‘\n [symbol] :’+(message contents 2 information 201b2)” using the display text information included in the message contents 1 information 201b1 and the message contents 2 information 201b2 in the message information 201. For instance, when the display text information of the message contents 1 information 201b1 is “12 [symbol] ” and the display text information of the message contents 2 information 201b2 is “ [symbol] ”, sub program 302a1 generates a display message “ [symbol] [symbol] \n [symbol] : 12 [symbol] \n [symbol] ” (I WILL WAIT FOR YOU\TIME: 12:00\PLACE: UMEDA). The code “\n” indicates a line break. Sub program 302a2 instructs to display the display text generated by sub program 302a1. Sub program 302a3 instructs to output the sound specified by the receiver in advance in the radio pager 106. The processing of program 302a is shown below with reference to the flowchart 302b. The processing proceeds in numerical order.

(1) Generate the display text “‘ [symbol] [symbol] \ [symbol] :’+(message contents 1 information 201b1)+‘\n [symbol] :’+(message contents 2 information 201b2)” (Step S121).

(2) Instruct to display the display text generated in Step S121 (Step S122).

(3) Instruct to output the sound specified by the receiver (Step S123).

An example program written in the programming language Tcl is shown below as a specific example of program 302a.

# Generate a display text.

# Note that the generated display text is stored in a variable disptxt.

Note that display texts of the message contents 1 information and the message contents 2 information are respectively stored in variables msg1info and msg2info.

set disptxt[join[list“ [symbol] [symbol] ”\n [symbol] : “$msg1info\”\n [symbol] : “$msg2info]””]

# Instruct to display.

execdisp $disptxt

# Instruct to output the sound specified by the receiver.

# Note that sound specification information of the receiver is stored in a variable userdefsound.

execsound $userdefsound (End)

The program extraction unit 106d extracts a program stored in the program information storage unit 106e in accordance with the program information extracted as a result of the analysis by the received data analysis unit 106c.

The program execution unit 106f executes the program extracted by the program extraction unit 106d using the information included in the message contents information 201b analyzed by the received data analysis unit 106c.

The message output control unit 106g controls the message output of the LCD 106h and/or the speaker 106i when an output instruction is generated towards the LCD 106h and/or the speaker 106i during the execution of the program by the program execution unit 106f.

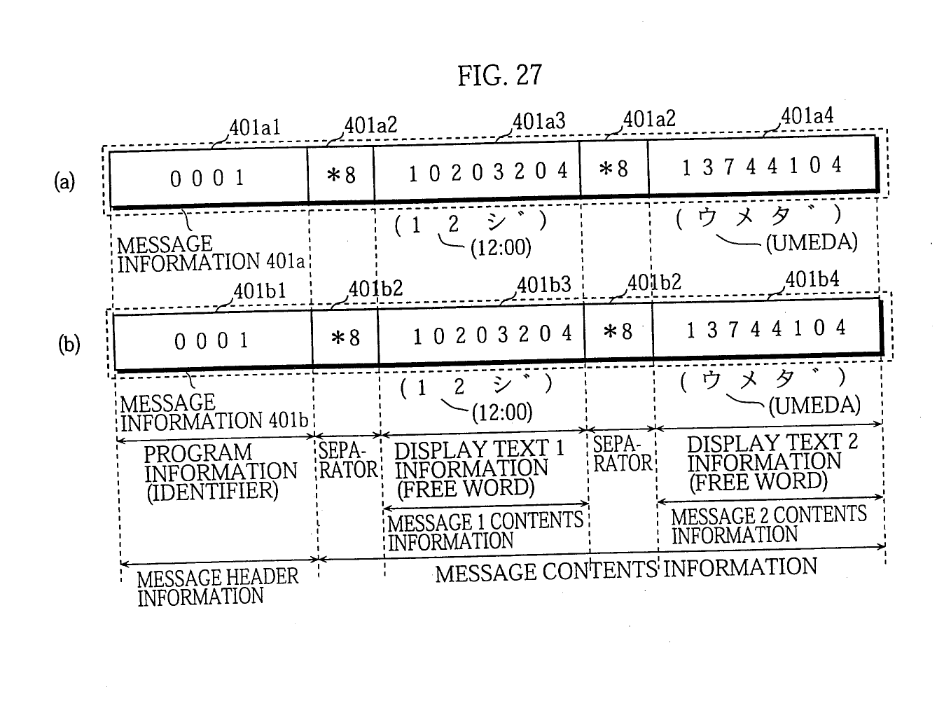

The following is an explanation of the specific operation of the radio pager of the first embodiment of the present invention with the above construction. Here, the case is explained when the radio pager receives a radio message sent from the radio station 105, the radio message including the message information shown in FIGS. 27(a) and 27(b) which is sent from the telephone 102.

First, the message information shown in FIGS. 27(a) and 27(b) is briefly explained.

In FIG. 27(a), a four-digit identifier 401a1 “0001” showso program information. A separator 401a2 has the value “*8”. Display text 1 information 401a3 has the value “10203204” as free words. In the free words, “10” indicates “1”, “20” indicates “2”, “32” indicates “z,115 ”, and “04” indicates “ [symbol] ”. Accordingly, “10203204” indicates “12 [symbol] ” (12:00). Display text 2 information 401a4 has the value “13744104” as free words. In the free words, “13” indicates “ [symbol] ”, “74” indicates “ [symbol] ”, “41” indicates “ [symbol] ”, and “04” indicates “ [symbol] ”. Accordingly, “13744104” indicates “ [symbol] ” (UMEDA).

In FIG. 27(b), a four-digit identifier 401b1 “0002” shows program information. A separator 401a2, display text 1 information 401a3, and display text 2 information 401a4 are the same as described above.

The following is an explanation of the operation when a radio message that includes the message information 401a shown in FIG. 27(a) is received. The operation proceeds in numerical order. The information shown in FIG. 26 explained above is stored in the program information storage unit 106e in advance.

(1) The radio pager 106 maintains a reception waiting state.

(2) The first reception unit 106b receives the radio message via the antenna 106a. (3) The first reception unit 106b judges whether the received radio message is for the radio pager 106. If the message is not for the radio pager 106, the operation returns to (1). If the message is for the radio pager 106, the operation proceeds to (4).

(4) The received data analysis unit 106c analyzes the received radio message and extracts the message information 401a. The received data analysis unit 106c then extracts the message header information and the message contents information from the message information 401a. Next, the program information is extracted from the message header information, while the message contents 1 information and the message contents 2 information are extracted from the message contents information. As a result, the program information “0001”, the message contents 1 information “10203204 (12 [symbol] )”, and the message contents 2 information “13744104 ( [symbol] )” are extracted.

(5) The program extraction unit 106d extracts a program stored in the program information storage unit 106e with reference to the program information “0001” extracted in (4). As a result, sub programs 301a1-301a3 are extracted.

(6) The program execution unit 106f obtains the message contents 1 information and the message contents 2 information extracted in (4) and starts the execution of the program extracted in (5).

(7) The program execution unit 106f executes sub program 301a1 and instructs the message output control unit 106g to output the sound specified by the receiver.

(8) The message output control unit 106g has the speaker 106i output the sound specified by the receiver.

(9) The program execution unit 106f executes sub program 301a2 and generates a display text “12 [symbol] [symbol] ” using the message contents 1 information “10203204 (12 [symbol] )” and the message contents 2 information “13744104 ( [symbol] )”.

(10) The program execution unit 106f executes sub program 301a3 and instructs the message output control unit 106g to display the display text generated in (9).

(11) The message output control unit 106g has the LCD 106h display the display text received in (10).

(12) The operation returns to (1).

Next, the operation is explained when a radio message that includes the message information 401b shown in FIG. 27(b) is received. The operation proceeds in numerical order. The information shown in FIG. 26 explained above is stored in the program information storage unit 106e in advance.

(1) The radio pager 106 maintains a reception waiting state.

(2) The first reception unit 106b receives the radio message via the antenna 106a.

(3) The first reception unit 106b judges whether the radio message received in (2) is for the radio pager 106. If the message is not for the radio pager 106, the operation returns to (1). If the message is for the radio pager 106, the operation proceeds to (4).

(4) The received data analysis unit 106c analyzes the radio message and extracts the message information 401b. The received data analysis unit 106c then extracts the message header information and the message contents information from the message information 401b. Next, the program information is extracted from the message header information, while the message contents 1 information and the message contents 2 information are extracted from the message contents information. As a result, the program information “0002”, the message contents 1 information “10203204 (12 [symbol] ”, and the message contents 2 information “13744104 ( [symbol] )” are extracted.

(5) The program extraction unit 106d extracts a program stored in the program information storage unit 106e with reference to the program information “0002” extracted in (4). As a result, sub programs 302a1-302a3 are extracted.

(6) The program execution unit 106f obtains the message contents 1 information and the message contents 2 information extracted in (4) and starts the execution of the program extracted in (5).

(7) The program execution unit 106f executes sub program 302a1 and generates a display text “ [symbol] \n [symbol] :12 [symbol] \n [symbol] : [symbol] ” using the message contents 1 information “10203204 (12 [symbol] )” and the message contents 2 information “13744104 ( [symbol] [symbol] )”.

(8) The program execution unit 106f executes sub program 302a2 and instructs the message output control unit 106g to display the display text generated in (7).

(9) The message output control unit 106g has the LCD 106h display the display text received in (8).

(10) The program execution unit 106f executes sub program 302a3 and instructs the message output control unit 106g to output the sound specified by the receiver.

(11) The message output control unit 106g has the speaker 106i output the sound specified by the receiver.

(12) The operation returns to (1).

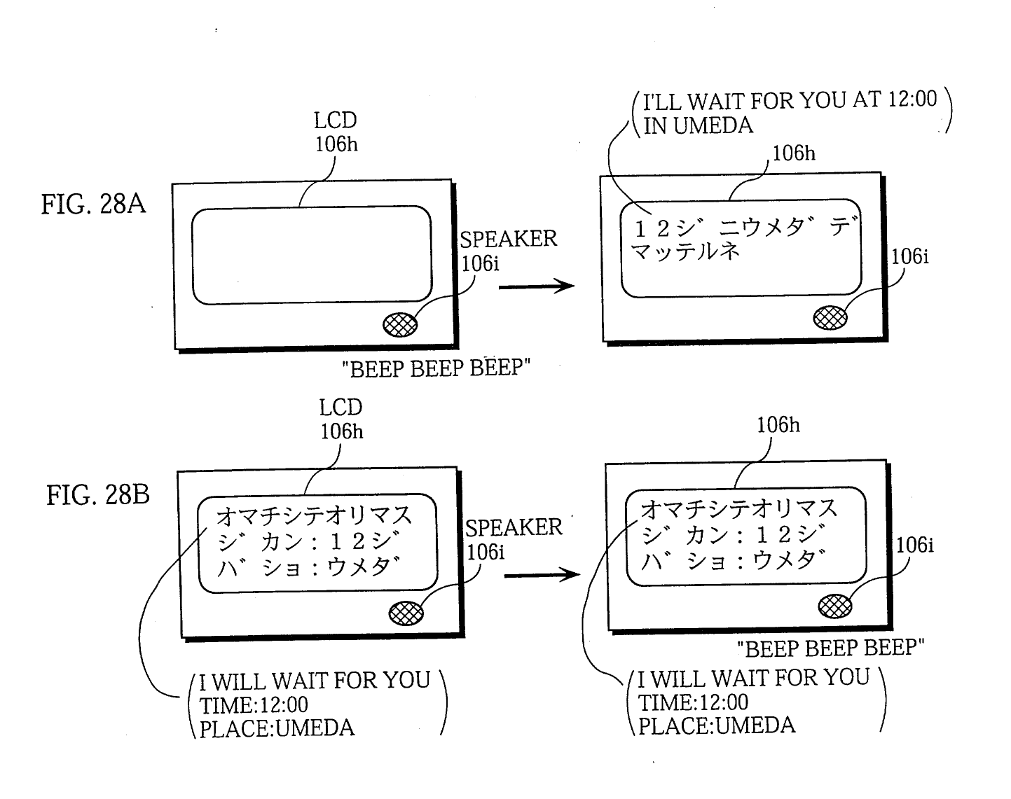

The appearance of the radio pager 106 when receiving the message information 401a and the message information 401b are shown in FIG. 28.

In the present embodiment, when the transmitter intends to inform the receiver of the meeting at 12:00 in Umeda, the transmitter does not have to make a whole message such as “12 [symbol] [symbol] ”. The transmitter can instead send the contents of the message (“12 [symbol] ” and “ [symbol] ”) and the program information that is used to process the message contents, the program information thus making up for the parts other than the message contents. Accordingly, the transmitter can make a message easily.

Also, when the transmitter intends to send messages which subtly differ, such as “ [symbol] [symbol] ” and “ [symbol] ”, to different receivers, the transmitter can do so just by sending different types of program information that realize different displays, such as ““ [symbol] [symbol] ”. Accordingly, the transmitter does not have to make subtly different messages one by one.

Note that while the program information included in the message header information is a four-digit identifier of a fixed length in the present embodiment, the program information may be an identifier of a variable length. Also, the identifier may be expressed as a string or a code. The program information may instead be a list of a plurality of identifiers. Alternatively, the program information may include a program itself, so that the program execution unit can execute the program analyzed by the received data analysis unit.

While “*8” is used as the separator in the message information in the present embodiment, any other separators may be used or, if possible, the separator may be omitted.

While the free word form is used to express the display text 1 information and the display text 2 Information in the message contents information in the present embodiment, any other data forms for expressing text information may be used.

While the message header information is placed at the head of the message information in the present embodiment, the message header information may instead be placed at the end of the message information.

While the programs stored in the program information storage unit are written in the programming language Tcl in the present embodiment, the programs may be written in any other programming languages such as the assembler, C, C++, PostScript, and Java. Alternatively, model templates of output messages may be used as the programs.

While the message header information is composed of the program information in the present embodiment, the message header information may also include transmitter information, transmission device type information, and other information.

While the radio pager is described as an independent device in the present embodiment, the radio pager may be installed in a radio device, such as a PHS (Personal Handyphone System), a portable phone, or a PDA (Personal Digital Assistant).

When a radio message includes the transmitter information, only radio messages from specified transmitters may be permitted (or prohibited) to be displayed. In such a case, transmitter information of each specified transmitter who is permitted by the receiver is stored in the program information storage unit 106e in advance. The program execution unit 106f judges whether transmitter information of a received radio message is stored in the program information storage unit 106e and permits (or prohibits) the message output control unit 106g to display/output the received radio message in accordance with the judgement.

### Fourth Embodiment

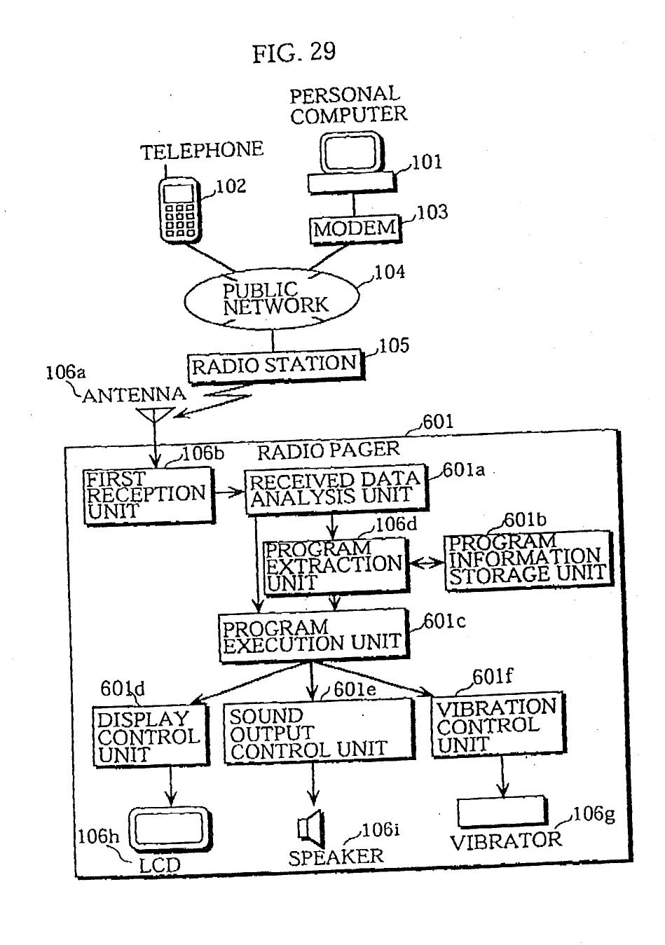

FIG. 29 is a block diagram showing an example of the general construction of the system that uses the radio pager of the fourth embodiment of the present invention.

In the figure, a message inputted using the personal computer 101 is transmitted to a radio pager 601 as a radio message via the modem 103, the public network 104, and the radio station 105. A message inputted using the telephone 102 is transmitted to the radio pager 601 as a radio message via the public network 104 and the radio station 105. The personal computer 101, the telephone 102, the modem 103, the public network 104, and the radio station 105 are as described above and thus are not explained here.

The radio pager 601 includes the antenna 106a, the first reception unit 106b, a received data analysis unit 601a, the program extraction unit 106d, a program information storage unit 601b, a program execution unit 601c, a display control unit 601d, a sound output control unit 601e, a vibration control unit 601f, the LCD 106h, the speaker 106i, and a vibrator 601g. The antenna 106a, the first reception unit 106b, the program extraction unit 106d, the LCD 106h, and the speaker 106i are as described above and thus are not explained here.

The received data analysis unit 601 analyzes a radio message sent from the first reception unit 106b and extracts message header information and message contents information (described later) from the analyzed message information. The received data analysis unit 601a then extracts program information (described later) and a group of arguments respectively from the message header information and the message contents information.

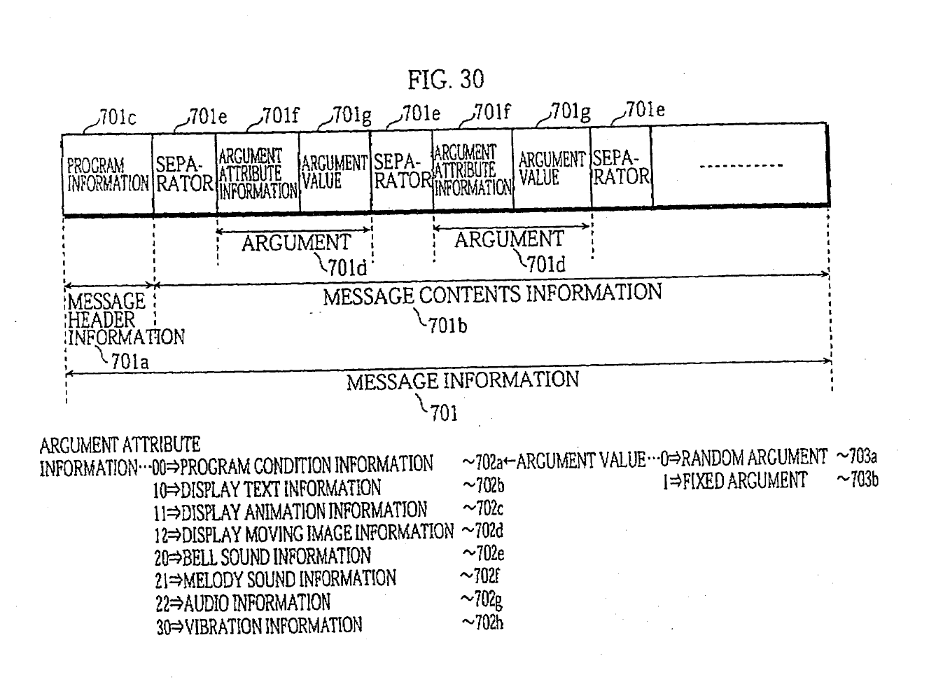

The construction of the message information is explained below with reference to FIG. 30.

In the figure, message information 701 is composed of message header information 701a and message contents information 701b. The message header information 701a is composed of program information 701c for identifying a program stored in the radio pager. The message contents information 701b includes a group of arguments 701d, wherein a separator 701e is placed between each two arguments. Arguments 701d are each composed of argument attribute information 701f and an argument value 701g. Specific examples of the argument attribute information 701f are shown in Lines 702a-702h. In Line 702a, when the argument attribute information 701f is “00”, the argument value shows program condition information. The same can be applied to Lines 702b-702h. Specific examples of the argument value 701g are shown in Lines 703a and 703b. In Line 703a, when the argument value 701g is “0”, the argument is a “random argument”. In Line 703b, when the argument value 701g is “1”, the argument is a “fixed argument”. Here, the random argument means that each combination of argument attribute information and an argument value is included at random in a message, so that the radio pager performs the output operation on all combinations included in the message. The fixed argument means that each combination of argument attribute information and an argument value is included in a message in a predetermined order, so that the radio pager performs the output operation only on combinations which conform to the predetermined order among all combinations included in the message.

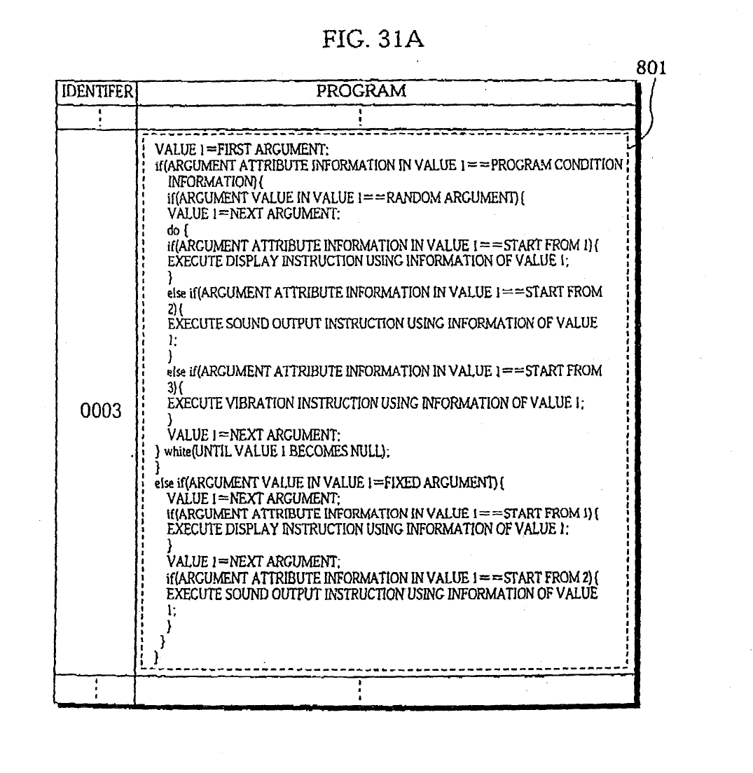

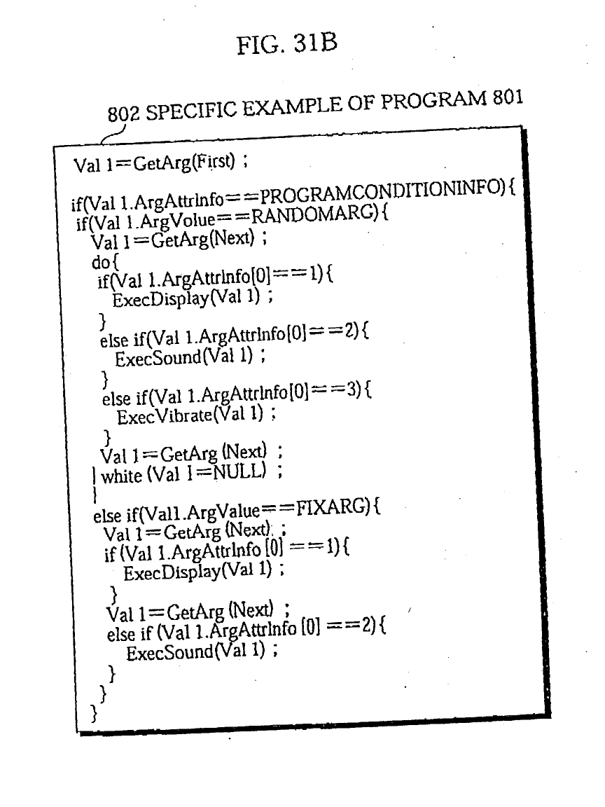

The program information storage unit 601b stores each combination of an identifier and a program in a conceptual form as shown in FIG. 31.

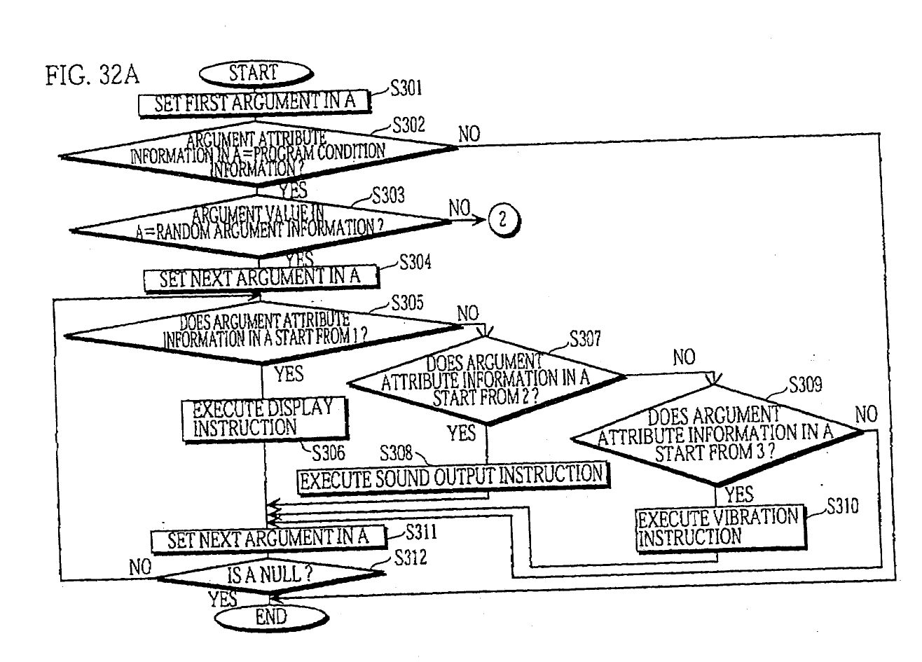

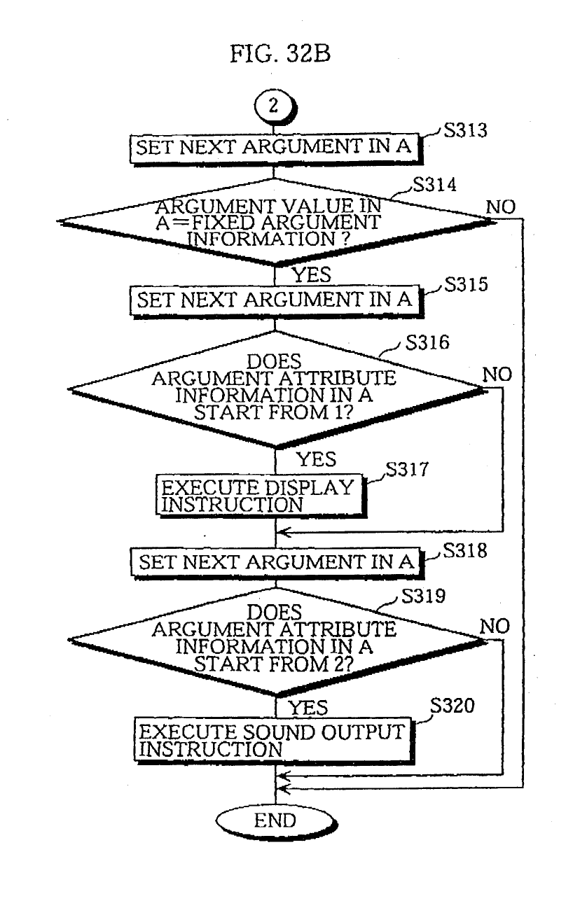

FIG. 31 shows an example of program 801 whose identifier is “0003”. In the figure, program 801 is written in a form similar to the C language. Program 802 is shown as a specific example of program 801 written in C. The following is an explanation of the operation of program 801 with reference to FIG. 32. The operation proceeds in numerical order.

(1) A first argument including an argument attribute value and an argument value is set in a variable A (Step S301).

(2) If the argument attribute information in the variable A shows program condition information, the operation proceeds to (3) Otherwise, the operation proceeds to (21) (Step S302).

(3) If the argument value in the variable A shows the “random argument”, the operation proceeds to (4). Otherwise, the operation proceeds to (13) (Step S303).

(4) A next argument is set in the variable A (Step S304).

(5) If argument attribute information in the variable A has a value starting from “1”, the operation proceeds to (6). Otherwise, the operation proceeds to (7) (Step S305).

(6) A display instruction is executed for the information in the variable A, and the operation proceeds to (11) (Step S306).

(7) If the argument attribute information in the variable A has a value starting from “2”, the operation proceeds to (8). Otherwise, the operation proceeds to (9) (Step S307).

(8) A sound output instruction is executed for the information in the variable A, and the operation proceeds to (11) (Step S308).

(9) If the argument attribute information in the variable A has a value starting from “3”, the operation proceeds to (10). Otherwise, the operation proceeds to (11) (Step S309).

(10) A vibration instruction is executed for the information in the variable A, and the operation proceeds to (11) (Step S310).

(11) A next argument is set in the variable A (Step S311).

(12) If the variable A is null, the operation proceeds to (21). Otherwise, the operation proceeds to (5) (Step S312).

(13) A next argument is set in the variable A (Step S313).

(14) If an attribute value in the variable A shows the “fixed argument”, the operation proceeds to (15). Otherwise, the operation proceeds to (21) (Step S314).

(15) A next argument is set in the variable A (Step S315).

(16) If argument attribute information in the variable A has a value starting from “1”, the operation proceeds to (17). Otherwise, the operation proceeds to (18) (Step S316).

(17) A display instruction is executed for the information in the variable A (Step S317).

(18) A next argument is set in the variable A (Step S318).

(19) If argument attribute information in the variable A has a value starting from “2”, the operation proceeds to (20). Otherwise, the operation proceeds to (21) (Step S319).

(20) A sound output instruction is executed for the information in the variable A (Step S320).

(21) The program ends.

The program execution unit 601c executes a program, which was extracted by the program extraction unit 106d, using the information included in the message contents information analyzed by the received data analysis unit 601a.

On receiving display information from the program execution unit 601c, the display control unit 601d controls the LCD 106h to display letters, animation, moving images, and the like. The animation and moving images can be easily displayed by flashing each dot of the LCD 106h on and off or by combining sideways scrolling and up-and-down scrolling in units of dots.

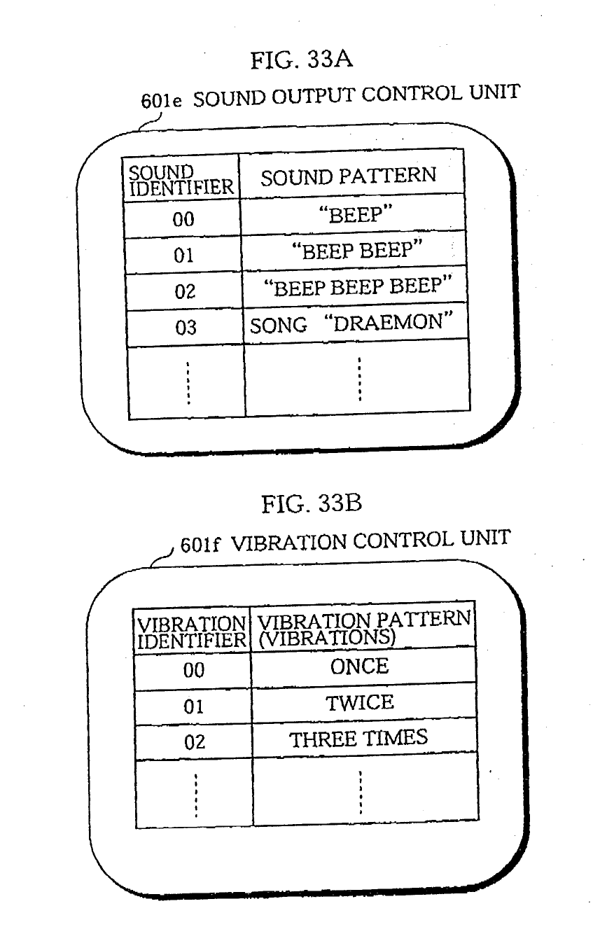

On receiving sound output information from the program execution unit 601c, the sound output control unit 601e controls the speaker 106i to output bells, melodies, and other sounds. In the present embodiment, the sound output control unit 601e stores in advance each combination of a sound identifier and a sound pattern in a conceptual form as shown in FIG. 33A, and controls the speaker 106i to output sounds in accordance with a sound identifier included in the sound output information.

On receiving vibration information from the program execution unit 601c, the vibration control unit 601f controls the vibrator 601g to generate vibrations. In the present embodiment, the vibration control unit 601f stores in advance each combination of a vibration identifier and a vibration pattern in a conceptual form as shown in FIG. 33B, and controls the vibrator 601g to generate vibrations in accordance with a vibration identifier included in the vibration information.

The following is an explanation of the specific operation of the radio pager of the fourth embodiment with the above construction.

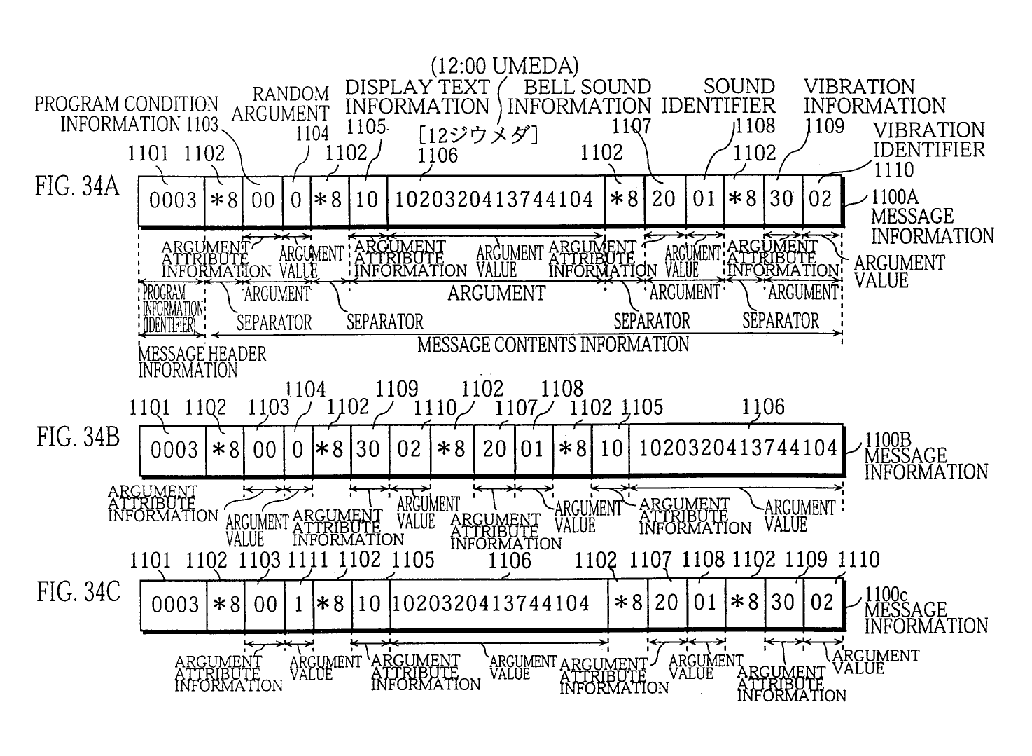

Here, the case is explained when the radio pager receives a radio message from the radio station 105, the radio message including message information shown in FIG. 34 sent from the telephone 102.

Here, FIG. 34 is briefly explained.

The figure shows the contents of message information 1100a, 1100b, and 1100c.

In the figure, field 1101 shows a four-digit identifier with the value “0003” as program information. Field 1102 shows a separator with the value “*8”. Field 1103 shows argument attribute information with the value “00” that indicates program condition information. Field 1104 shows an argument value of “0” that indicates the random argument. Field 1105 shows argument attribute information with the value “10” that indicates display text information. Field 1106 shows an argument value of “1020320413744104” in the free word form. In the free words, “10” indicates “1”, “20” indicates “2”, “32” indicates “ [symbol] ”, “04” indicates “ [symbol] ”, “13 indicates “ [symbol] ”, “74” indicates “ [symbol] ”, “41” indicates “ [symbol] ”, so that “1020320413744104” indicates “12 [symbol] ”. Field 1107 shows argument attribute information with the value “20” that indicates sound output information. Field 1108 shows an argument value with a sound identifier “01”. Field 1109 shows argument attribute information with the value “30” that indicates vibration information. Field 1110 shows an argument value with a vibration identifier “02”.

The following is an explanation of the operation when receiving a radio message which includes the message information 1100a shown in FIG. 34. The operation proceeds in numerical order. The information shown in FIG. 31 is stored in the program information storage unit 601b in advance. Also, the data shown in FIGS. 33A and 33B is stored respectively in the sound output control unit 601e and the vibration control unit 601f in advance. FIGS. 31 and 33 have already been explained.

(1) The radio pager maintains a reception waiting state.

(2) The first reception unit 106b receives the radio message via the antenna 106a.

(3) The first reception unit 106b judges whether the radio message received in (2) is for the radio pager 601. If the message is not for the radio pager 601, the operation returns to (1). Otherwise, the operation proceeds to (4).

(4) The received data analysis unit 601a analyzes the radio message and extracts the message information 1100a, from which message header information and message contents information are extracted. The received data analysis unit 601a further extracts program information and an argument group respectively from the message header information and the message contents information. As a result, the program information “0003” and four arguments that are “argument attribute information=00, argument value=0”, “argument attribute information=10, argument value=1020320413744104”, “argument attribute information=20, argument value=01”, and “argument attribute information=30, argument value=02” are extracted in this order.

(5) The program extraction unit 106d extracts a program stored in the program information storage unit 601b in accordance with the program information “0003” extracted in (4). As a result, program 801 is extracted.

(6) The program execution unit 601c obtains the argument group extracted in (4) and starts the execution of the program extracted in (5).

(7) The first argument is set in a variable A.

(8) Since the argument attribute information “00” in the variable A indicates the program condition information and the argument value “0” in the variable A indicates the random argument, the second argument is set in the variable A.

(9) Since the argument attribute information in the variable A has the value “10” that starts from 1 and that indicates display text information, the program execution unit 601c instructs the display control unit 601d to display using the second argument.

(10) Since the argument attribute information of the second argument indicates the display text information, the display control unit 601d displays a text expressed by the argument value “1020320413744104”. As a result, “12 [symbol] ” is displayed on the LCD 106h.

(11) The third argument is set in the variable A.

(12) Since the variable A is valid, the program execution unit 601c checks the argument attribute information in the variable A. Since the argument attribute information in the variable A has the value “20” that starts from 2 and that indicates sound output information, the program execution unit 601c instructs the sound output control unit 601e to output sounds using the third argument.

(13) Since the argument attribute information of the third argument indicates bell sound information, the sound output control unit 601e retrieves a sound pattern corresponding to the argument value “01” and outputs the sound pattern to the speaker 106i. As a result, the sound “beep beep” is outputted from the speaker 106i.

(14) The fourth argument is set in the variable A.

(15) Since the variable A is valid, the program execution unit 601c examines the argument attribute information in the variable A. Since the argument attribute information in the variable A has the value “30” that starts from 3 and that indicates vibration information, the program execution unit 601c instructs the vibration control unit 601f to generate vibrations using the fourth argument.

(16) Since the argument attribute information of the fourth argument indicates the vibration information, the vibration control unit 601f retrieves a vibration pattern corresponding to the argument value “02” and outputs the vibration pattern to the vibrator 601g. As a result, the vibrator 601g generates vibrations three times.

(17) A next argument is set in the variable A.

(18) Since the variable A is null, the program ends.

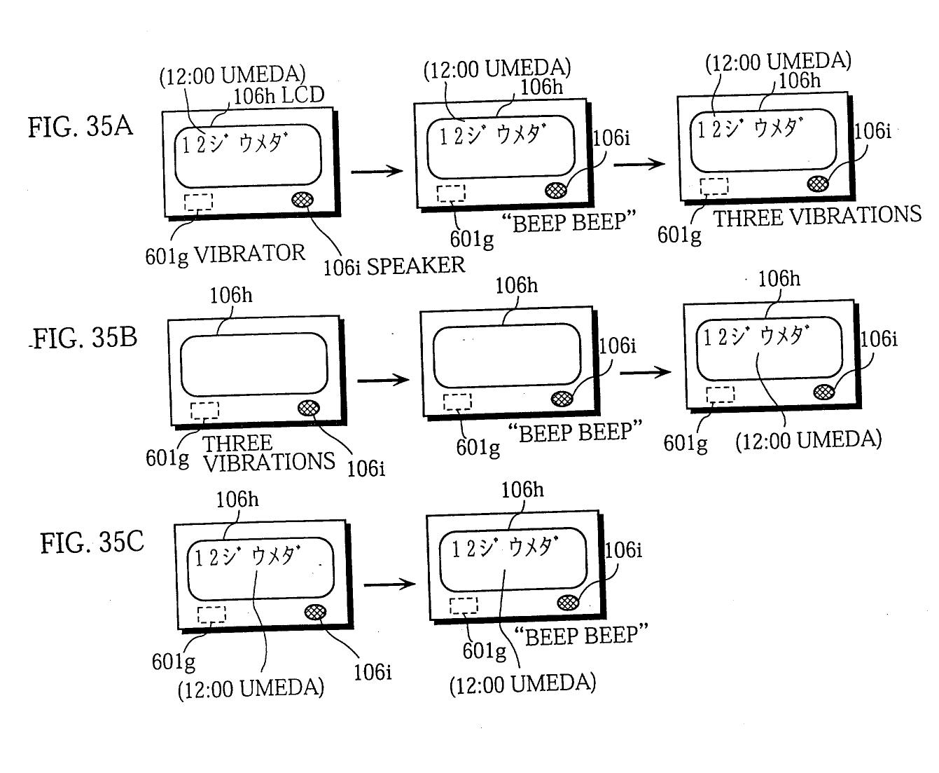

The appearance of the radio pager when receiving the message information 1100a is shown in FIG. 35A.

Next, the operation when receiving a radio message which includes the message information 1100b shown in FIG. 34 is explained. The operation proceeds in numerical order. The information shown in FIG. 31 is stored in the program information storage unit 601b in advance. Also, the data shown in FIGS. 33A and 33B is stored respectively in the sound output control unit 601e and the vibration control unit 601f in advance. FIGS. 31 and 33 have already been explained.

(1) The radio pager maintains a reception waiting state.

(2) The first reception unit 106b receives the radio message via the antenna 106a.

(3) The first reception unit 106b judges whether the radio message received in (2) is for the radio pager 601. If the message is not for the radio pager 601, the operation returns to (1). Otherwise, the operation proceeds to (4).

(4) The received data analysis unit 601a analyzes the radio message and extracts the message information 1100b, from which message header information and message contents information are extracted. The received data analysis unit 601a further extracts program information and an argument group respectively from the message header information and the message contents information. As a result, the program information “0003” and four arguments that are “argument attribute information=00, argument value=0”, “argument attribute information=30, argument value=02”, “argument attribute information=20, argument value=01”, and “argument attribute information=10, argument value=1020320413744104” are extracted in this order.

(5) The program extraction unit 106d extracts a program stored in the program information storage unit 601b in accordance with the program information “0003” extracted in (4). As a result, program 801 is extracted.

(6) The program execution unit 601c obtains the argument group extracted in (4) and starts the execution of the program extracted in (5).

(7) The first argument is set in a variable A.

(8) Since the argument attribute information “00” in the variable A indicates the program condition information and the argument value “0” in the variable A indicates the random argument, the second argument is set in the variable A.

(9) Since the argument attribute information in the variable A has the value “30” that starts from 3 and that indicates vibration information, the program execution unit 601c instructs the vibration control unit 601f to generate vibrations using the second argument.

(10) Since the argument attribute information of the second argument indicates the vibration information, the vibration control unit 601f retrieves a vibration pattern corresponding to the argument value “02” and outputs the vibration pattern to the vibrator 601g. As a result, the vibrator 601g generates vibrations three times.

(11) The third argument is set in the variable A.

(12) Since the variable A is valid, the program execution unit 601c checks the argument attribute information in the variable A. Since the argument attribute information in the variable A has the value “20” that starts from 2 and that indicates sound output information, the program execution unit 601c instructs the sound output control unit 601e to output sounds using the third argument.

(13) Since the argument attribute information of the third argument indicates bell sound information, the sound output control unit 601e retrieves a sound pattern corresponding to the argument value “01” and outputs the sound pattern to the speaker 106i. As a result, the sound “beep beep” is outputted from the speaker 106i.

(14) The fourth argument is set in the variable A.

(15) Since the variable A is valid, the program execution unit 601c checks the argument attribute information in the variable A. Since the argument attribute information in the variable A has the value “10” that starts from 1 and that indicates display text information, the program execution unit 601c instructs the display control unit 601d to display using the fourth argument.

(16) Since the argument attribute information of the fourth argument indicates the display text information, the display control unit 601d displays a text expressed by the argument value “1020320413744104”. As a result, “12 [symbol] ”, is displayed on the LCD 106h.

(17) A next argument is set in the variable A.

(18) Since the variable A is null, the program ends.

The appearance of the radio pager when receiving the message information 1100b is shown in FIG. 35B.

Next, the operation when receiving a radio message which includes the message information 1100c shown in FIG. 34 is explained. The operation proceeds in numerical order. The information shown in FIG. 31 is stored in the program information storage unit 601b in advance. Also, the data shown in FIGS. 33A and 33B is stored respectively in the sound output control unit 601e and the vibration control unit 601f in advance. FIGS. 31 and 33 have already been explained.

(1) The radio pager maintains a reception waiting state.

(2) The first reception unit 106b receives the radio message via the antenna 106a.

(3) The first reception unit 106b judges whether the radio message received in (2) is for the radio pager 601. If the message is not for the radio pager 601, the operation returns to (1). Otherwise, the operation proceeds to (4).

(4) The received data analysis unit 601a analyzes the radio message and extracts the message information 1100c, from which message header information and message contents information are extracted. The received data analysis unit 601a further extracts program information and an argument group respectively from the message header information and the message contents information. As a result, the program information “0003” and four arguments that are “argument attribute information=00, argument value=1”, “argument attribute information=10, argument value=1020320413744104”, “argument attribute information=20, argument value=01”, and “argument attribute information=30, argument value=02” are extracted in this order.

(5) The program extraction unit 106d extracts a program stored in the program information storage unit 601b in accordance with the program information “0003” extracted in (4). As a result, program 801 is extracted.

(6) The program execution unit 601c obtains the argument group extracted in (4) and starts the execution of the program extracted in (5).

(7) The first argument is set in a variable A.

(8) Since the argument attribute information “00” in the variable A indicates the program condition information and the argument value “1” in the variable A indicates the fixed argument, the second argument is set in the variable A.

(9) Since the argument attribute information in the variable A has the value “10” that starts from 1 and that indicates display text information, the program execution unit 601c instructs the display control unit 601d to display using the second argument.

(10) Since the argument attribute information of the second argument indicates the display text information, the display control unit 601d displays a text expressed by the argument value “1020320413744104”. As a result, “12 [symbol] ” is displayed on the LCD 106h.

(11) The third argument is set in the variable A.

(12) Since the argument attribute information in the variable A has the value “20” that starts from 2 and that indicates sound output information, the program execution unit 601c instructs the sound output control unit 601e to output sounds using the third argument.

(13) Since the argument attribute information of the third argument indicates bell sound information, the sound output control unit 601e retrieves a sound pattern corresponding to the argument value “01” and outputs the sound pattern to the speaker 106i. As a result, the sound “beep beep” is outputted from the speaker 106i.

(14) The program ends.

The appearance of the radio pager when receiving the message information 1100c is shown in FIG. 35C.

With the present embodiment, the transmitter can specify how the radio pager of the receiver operates after receiving a message by including the program information into the message, and further specify how the program operates by including information for specifying the program operation into the message contents information in the message. Accordingly, the transmitter can specify sounds and vibrations to be outputted and change the operation in the radio pager easily by changing the information for specifying the program operation. Thus, the transmitter can make messages in greater flexibility.

Note that while the program information included in the message header information is a four-digit identifier of a fixed length in the present embodiment, the program information may be an identifier of a variable length. Also, the identifier may be expressed as a string or a code. The program information may instead be a list of a plurality of identifiers. Alternatively, the program information may include a program itself, so that the program execution unit can execute the program analyzed by the received data analysis unit.

While “*8” is used as the separator in the message information in the present embodiment, any other separators may be used or, if possible, the separator may be omitted.

While the argument attribute information in the message contents information has a two-digit value of a fixed length in the present embodiment, the value may be of a variable length. Also, the argument attribute information may be expressed as a string or a code. When the argument attribute information indicates information such as display animation information, display moving image information, melody sound information, or audio information, any data forms may be used for an argument value corresponding to each type of the argument attribute information.

While the message header information is placed at the head of the message information in the present embodiment, the message header information may instead be placed at the end of the message information.

While the programs stored in the program information storage unit are written in the programming language C in the present embodiment, the programs may be written in any other programming languages such as the assembler, Tcl, C++, PostScript, and Java. Alternatively, model templates of output messages may be used as the programs.

While the radio pager is described as an independent device in the present embodiment, the radio pager may be installed in a radio device, such as a PHS (Personal Handyphone System), a portable phone, or a PDA (Personal Digital Assistant).

While the sound output control unit and the vibration control unit each store combinations of identifiers and patterns and retrieve a pattern corresponding to an identifier included in an argument sent from the program execution unit in the present embodiment, the sound output control unit and the vibration control unit may instead receive the pattern itself from the program execution unit as argument information and output the pattern.

While the message header information is composed of the program information in the present embodiment, the message header information may also include transmitter information and transmission device type information.

### Fifth Embodiment

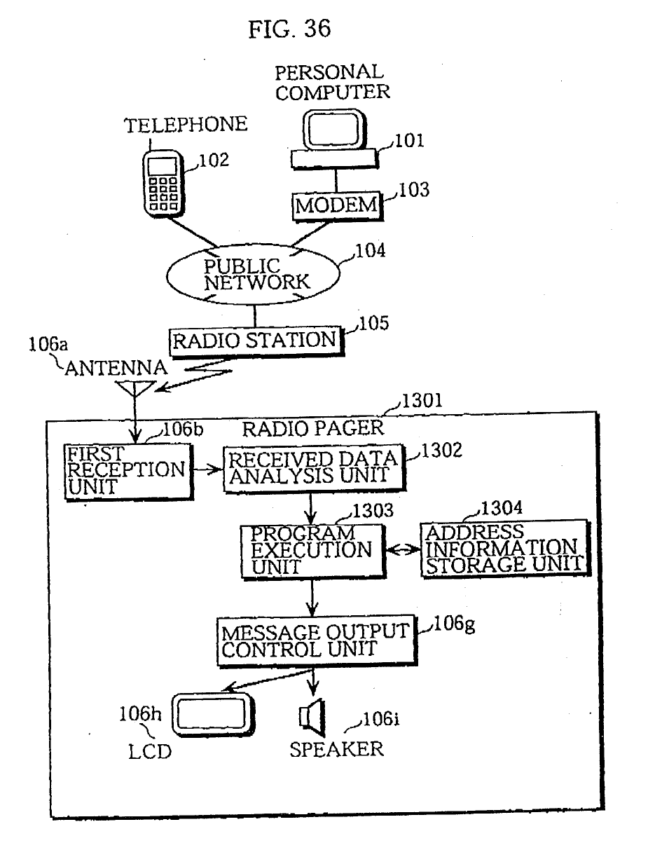

FIG. 36 is a block diagram showing an example of the general construction of the system that uses the radio pager of the fifth embodiment of the present invention.

In the figure, a message inputted using the personal computer 101 is transmitted to a radio pager 1301 as a radio message via the modem 103, the public network 104, and the radio station 105. A message inputted using the telephone 102 is transmitted to the radio pager 1301 as a radio message via the public network 104 and the radio station 105. The personal computer 101, the telephone 102, the modem 103, the public network 104, and the radio station 105 are as described above and thus are not explained here.

The radio pager 1301 includes the antenna 106a, the first reception unit 106b, a received data analysis unit 1302, a program extraction unit 1303, an address information storage unit 1304, the message output control unit 106g, the LCD 106h, and the speaker 106i. The antenna 106a, the first reception unit 106b, the message output control unit 106g, the LCD 106h, and the speaker 106i are as described above and thus are not explained here.

The received data analysis unit 1302 analyzes a radio message sent from the first reception unit 106b and extracts message header information and message contents information (described later) from the analyzed message information. The received data analysis unit 1302 then extracts program information (described later) and an argument group respectively from the message header information and the message contents information.

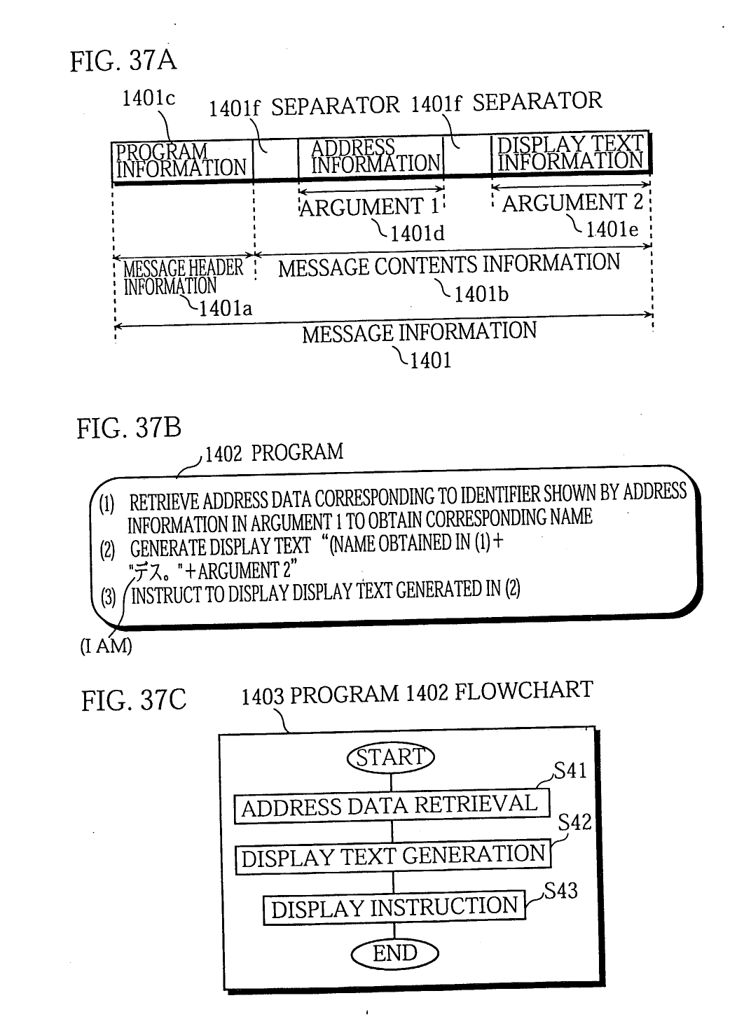

The construction of the message information is explained below with reference to FIG. 37.

In the figure, message information 1401 is composed of message header information 1401a and message contents information 1401b. The message header information 1401a is composed of program information 1401c. The message contents information 1401b is composed of argument 1 (1401d), argument 2 (1401e), and separators 1401f. Argument 1 (1401d) stores address information, while argument 2 (1401e) stores display text information. The program information 1401c stores a program, such as program 1402. The operation of program 1402 is explained here with reference to flowchart 1403. The operation proceeds in numerical order.

(1) Retrieve address data stored in the radio pager that corresponds to an identifier shown by the address information in argument 1 in order to obtain a name.

(2) Generate a display text “(name obtained in (1))+‘ [symbol] [symbol] ’+(display text of argument 2)” using the name obtained in (1).

(3) Instruct to display the display text generated in (2).

(4) Program ends.

An example program written in the programming language Tcl is shown below as a specific example of program 1402. Each comment is given the code #.

# Retrieve address data and store it in a variable name.

# Note that argument 1 is stored in a variable arg1info.

set name[getaddrname$arg1info]

# Generate a display text.

# Note that the generated display text is stored in a variable disptxt.

# Note that argument 2 is stored in a variable arg2info.

# Note that a display text of message contents 2 information is stored.

set disptxt[join[list $name“ [symbol] “$arg2info]””]

# Instruct to display.

execdisp $disptxt (End)

The program execution unit 1303 executes the program included in the program information 1401c using the program information 1401c and the information in the message contents information 1401 which were analyzed in the received data analysis unit 1302.

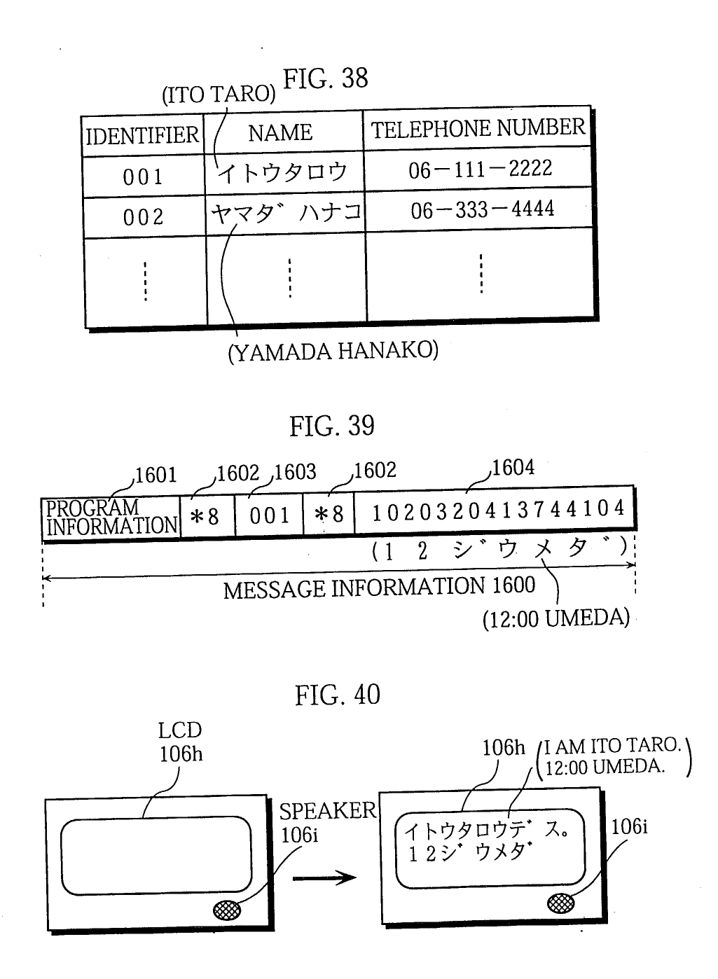

The address information storage unit 1304 stores each set of an identifier, a name, and a telephone number in a conceptual form as shown in FIG. 38.

The following is an explanation of the specific operation of the radio pager of the fifth embodiment with the above construction. Here, the case is explained when the radio pager receives a radio message from the radio station 105, the radio message including message information shown in FIG. 39 which is sent from the personal computer 101.

First, FIG. 39 is briefly explained.

In the figure, field 1601 shows program information which stores program 1402. Field 1602 shows a separator with the value “*8”. Field 1603 shows address information which stores an identifier “001”. Field 1604 shows display text information with the value “1020320413744104” in the free word form. In the free words, “10” indicates “1”, “20” indicates “2”, “32” indicates “ [symbol] ”, “04” indicates “ [symbol] ”, “13” indicates “ [symbol] ”, “74” indicates “ [symbol] ”, and “41” indicates “ [symbol] ”, so that “1020320413744104” indicates “12 [symbol] ”.

The following is an explanation of the operation when receiving the radio message which includes the message information 1600 shown in FIG. 39. The operation proceeds in numerical order. The information shown in FIG. 38 is stored in the address information storage unit 1304 in advance.

(1) The radio pager maintains a reception waiting state.

(2) The first reception unit 106b receives the radio message via the antenna 106a.

(3) The first reception unit 106b judges whether the radio message received in (2) is for the radio pager 1301. If the message is not for the radio pager 1301, the operation returns to (1). Otherwise, the operation proceeds to (4).

(4) The received data analysis unit 1302 analyzes the radio message and extracts the message information 1600. The received data analysis unit 1302 then extracts message header information and message contents information from the message information 1600. The received data analysis unit 1302 further extracts program information and an argument group respectively from the message header information and the message contents information. As a result, program 1402 as the program information, argument 1 with the value “001”, and argument 2 with the value “1020320413744104” are extracted.

(5) The program execution unit 1303 obtains arguments 1 and 2 extracted in (4) and starts the execution of program 1402 extracted in (4).

(6) The program execution unit 1303 searches the address information storage unit 1304 with reference to the value “001” of argument 1 and retrieves a corresponding name “ [symbol] ” (ITO TARO).

(7) The program execution unit 1303 generates a display text “ [symbol] 12 [symbol] ” (ITO TARO. 12:00, UMEDA) using “ [symbol] [symbol] ” retrieved in (6) and the value of argument 2 “1020320413744104 (12 [symbol] )”, and instructs the message output control unit 106g to display the display text.

(8) The message output control unit 106g has the LCD 106h display “ [symbol] 12 [symbol] ”.

The appearance of the radio pager when receiving the message information 1600 is shown in FIG. 40.

With the present embodiment, the transmitter can specify program information that instructs the receiver to retrieve address data stored in the radio pager and display a message using the retrieved address data. In other words, the transmitter can send the program information that relates to the data stored in the radio pager by including the program information in the message information. Accordingly, the display message is generated by combining a message transmitted by the transmitter and the data stored in the radio pager, so that the transmitter does not need to make the whole display message. Thus, the transmitter can make and transmit messages more easily.

While the program stored in the program information in the message header information is written in the programming language Tcl in the present embodiment, the program may be written in any other programming languages such as the assembler, C, C++, PostScript, and Java. Alternatively, a model template of output messages may be used as the program.

While “*8” is used as the separator in the message information in the present embodiment, any other separators may be used or, if possible, the separator may be omitted.

While the address information of the argument in the message contents information has a three-digit identifier of a fixed length in the present embodiment, the identifier may be of a variable length. Also, the identifier may be expressed as a string or a code. While the free word form is used to express the display text information in the present embodiment, any other data forms for expressing text information may be used.

While the message header information is placed at the head of the message information in the present embodiment, the message header information may instead be placed at the end of the message information.

While the message header information is composed of the program information in the present embodiment, the message header information may also include transmitter information and transmission device type information.

Address data which the radio pager possesses in advance may be used as the address data in the address information storage unit.

While the radio pager is described as an independent device in the present embodiment, the radio pager may be installed in a radio device, such as a PHS (Personal Handyphone System), a portable phone, or a PDA (Personal Digital Assistant).

### Sixth Embodiment

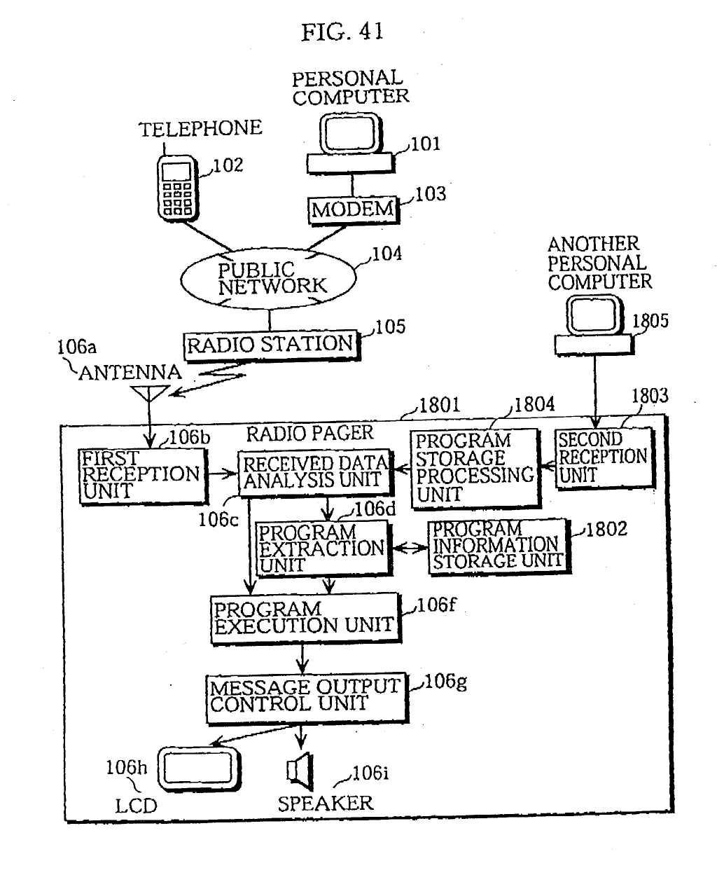

FIG. 41 is a block diagram showing an example of the general construction of the system that uses the radio pager of the sixth embodiment of the present invention.

In the figure, a message inputted using the personal computer 101 is transmitted to a radio pager 1801 as a radio message via the modem 103, the public network 104, and the radio station 105. A message inputted using the telephone 102 is transmitted to the radio pager 1801 as a radio message via the public network 104 and the radio station 105. The personal computer 101, the telephone 102, the modem 103, the public network 104, and the radio station 105 are as described above and thus are not explained here.

The radio pager 1801 includes the antenna 106a, the first reception unit 106b, the received data analysis unit 106c, the program extraction unit 106d, a program information storage unit 1802, a second reception unit 1803, a program storage processing unit 1804, the program execution unit 106f, the message output control unit 106g, the LCD 106h, and the speaker 106i. The radio pager 1801 is connected to another personal computer 1805 by wire. The antenna 106a, the first reception unit 106b, the program extraction unit 106d, the program execution unit 106f, the message output control unit 106g, the LCD 106h, and the speaker 106i are as described above and thus are not explained here.

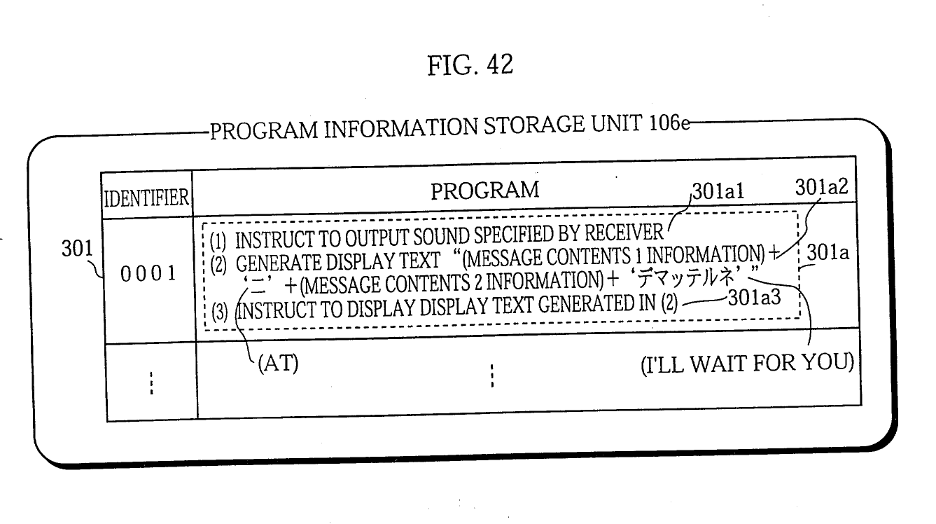

The program information storage unit 1802 stores each combination of an identifier and a program in a conceptual form shown in FIG. 42.

In the figure, a combination 301 shows that program 301a has an identifier 0001. Program 301a is composed of sub programs 301a1, 301a2, and 301a3. Program 301a and sub programs 301a1-301a3 are as described above.

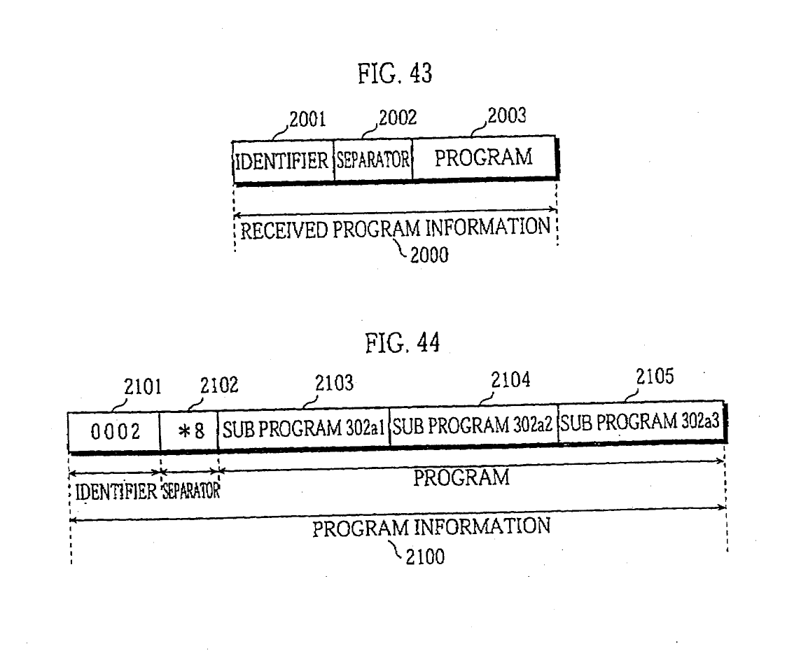

The second reception unit 1803 receives program information shown in FIG. 43 from the personal computer 1805.

In FIG. 43, program information 2000 is composed of an, identifier 2001, a separator 2002, and a program 2003.

The program storage processing unit 1804 analyzes the program information received by the second reception unit 1803 and stores the analyzed program information into the program information storage unit 1802.

The following is an explanation of the specific operation of the radio pager of the sixth embodiment of the present invention with the above construction. Here, the operation of receiving program information 2100 shown in FIG. 44 which precedes the operation of receiving a radio message is explained.

First, FIG. 44 is briefly explained below. An identifier 2101 has the value “0002”. A separator 2102 has the value “*8”. A sub program 2103 shows sub program 302a1. A sub program 2104 shows sub program 302a2. A sub program 2105 shows sub program 302a3. The sub programs 2103-2105 compose a program. Sub programs 302a1-302a3 are as described above.

The following is an explanation of the operation of receiving the program information shown in FIG. 44. The operation proceeds in numerical order. The information shown in FIG. 42 explained above is stored in the program information storage unit 1802 in advance.

(1) The radio pager 106 maintains a reception waiting state.

(2) The second reception unit 1803 receives the program information 2100 from the personal computer 1805 by wire.

(3) The program storage processing unit 1804 analyzes the program information 2100 received by the second reception unit 1803 and extracts the identifier “0002” and the program that is composed of “sub program 302a1, sub program 302a2, and sub program 302a3”.

(4) The program storage processing unit 1804 stores the extraction result into the program information storage unit 1802.

(5) The operation returns to (1).

FIG. 26 shows the result of storing the program information 2100 in the program information storage unit 1802. FIG. 26 is as described above and thus is not explained here.

With the present embodiment, the receiver receives and downloads program information, so that the transmitter can make messages in greater flexibility. In download processing, a new program can be added by using a new program identifier, while an existing program can be changed to the new program by using an existing program identifier. Also, the existing program can be deleted by storing an invalid program using the existing program identifier.

While each program has a four-digit identifier of a fixed length in the present embodiment, the identifier may be of a variable length. Also, the identifier may be expressed as a string or a code.

While “*8” is used as a separator in the message information in the present embodiment, any other separators may be used or, if possible, the separator may be omitted.

While the identifier is placed at the head of the program information in the present embodiment, the identifier may instead be placed at the end of the program information.

While the program is written in the conceptual form in the present embodiment, the program may be written in any programming languages such as the assembler, C, C++, Tcl, PostScript, and Java. Alternatively, a model template of output messages may be used as the program.

While the second reception unit and another personal computer are connected by wire in the present embodiment, they may be connected by radio.

### Seventh Embodiment

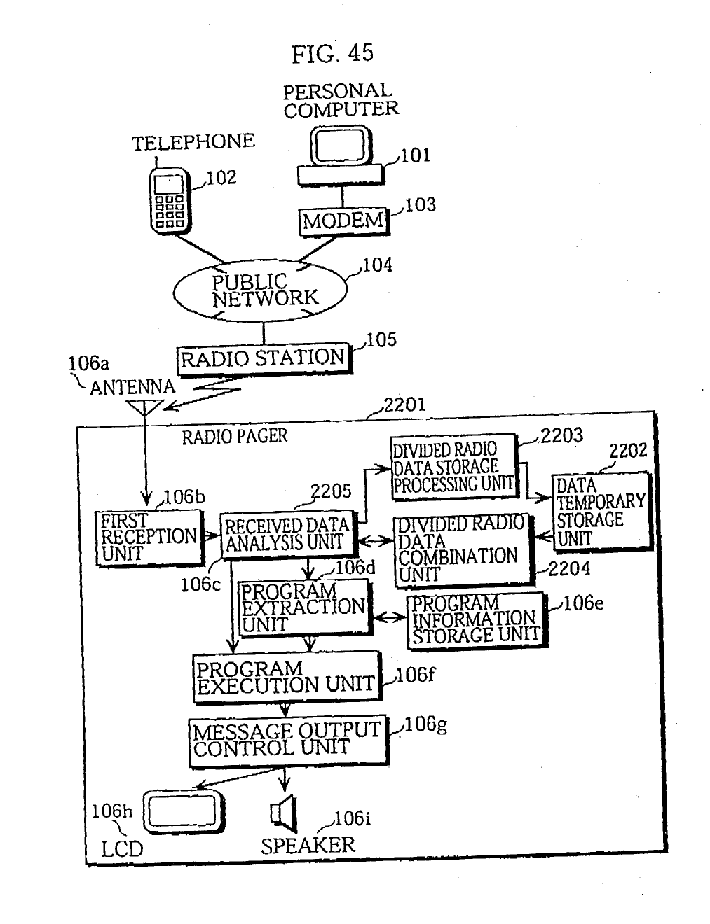

FIG. 45 is a block diagram showing an example of the general construction of the system that uses the radio pager of the seventh embodiment of the present invention.

In the figure, a message inputted using the personal computer 101 is transmitted to a radio pager 2201 as a radio message via the modem 103, the public network 104, and the radio station 105. A message inputted using the telephone 102 is transmitted to the radio pager 2201 as a radio message via the public network 104 and the radio station 105. The personal computer 101, the telephone 102, the modem 103, the public network 104, and the radio station 105 are as described above and thus are not explained here.

The radio pager 2201 includes the antenna 106a, the first reception unit 106b, a data temporary storage unit 2202, a divided radio data storage processing unit 2203, a divided radio data combination unit 2204, a received data analysis unit 2205, the program execution unit 106f, the program information storage unit 106e, the program execution unit 106f, the message output control unit 106g, the LCD 106h, and the speaker 106i. The antenna 106a, the first reception unit 106b, the program extraction unit 106d, the program information storage unit 106e, the program execution unit 106f, the message output control unit 106g, the LCD 106h, and the speaker 106i are as described above and thus are not explained here.

The data temporary storage unit 2202 temporarily stores message information of a received radio message.

The divided radio data storage processing unit 2203 performs processing of temporarily storing the message information into the data temporary storage unit 2202.

The divided radio data combination unit 2204 obtains the message information stored in the data temporary storage unit 2202 and combines the divided message information into a set of message information.

The received data analysis unit 2205 extracts message information from a received radio message and refers to division information in the message information to judge whether the message information is divided message information and, if so, whether it is the last divided message information. If the message information is divided message information but not the last divided message information, the received data analysis unit 2205 instructs the divided radio data storage processing unit 2203 to store the message information. If, on the other hand, the message information is the last divided message information, the received data analysis unit 2205 sends the message information to the divided radio data combination unit 2204 and instructs the divided radio data combination unit 2204 to combine divided message information.

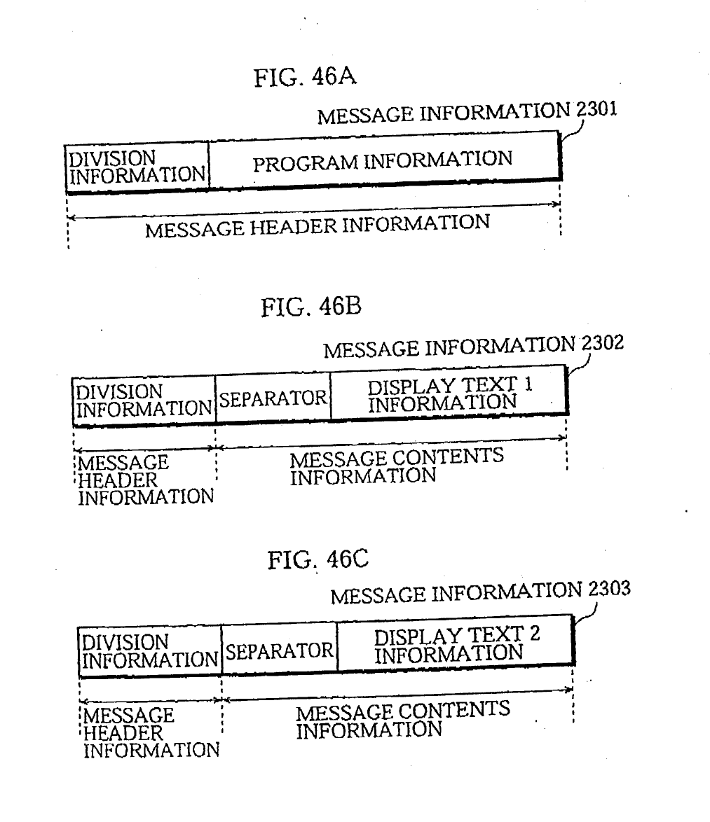

FIG. 46 shows a specific example of divided message information when dividing the message information shown in FIG. 25. The message information 201 shown in FIG. 25 is divided into message information 2301, message information 2302, and message information 2303 in FIG. 46. Division information is included at each head of the message information 2301-2303 as message header information.

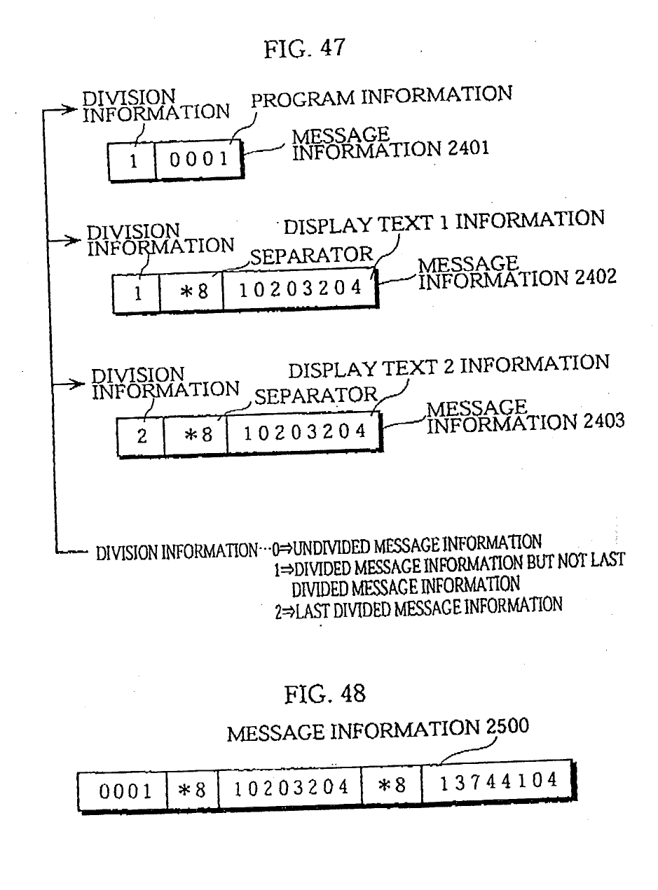

The following is an explanation of the specific operation of the radio pager of the seventh embodiment of the present invention with the above construction. Here, the operation of the received data analysis unit 2205 is explained when successively receiving three radio messages which respectively store message information 2401, message information 2402, and message information 2403 shown in FIG. 47.

First, FIG. 47 is briefly explained. The message information 2401 stores division information “1” and program information “0001”. The message information 2402 stores division information “1”, a separator “*8”, and display text 1 information “10203204 (12 [symbol] )” in the free word form. The message information 2403 stores division information “2”, a separator “*8”, and display text 2 information “13744104 ( [symbol] )” in the free word form. Division information “0” shows that the message information is not divided message information. Division information “1” shows that the message information is divided message information but not the last divided message information. Division information “2” shows that the message information is the last divided message information.

The following is an explanation of the operation of the received data analysis unit 2205 when receiving the message information 2401, the message information 2402, and the message information 2403 shown in FIG. 47. The operation proceeds in numerical order. The information shown in FIG. 26 is stored in the program information storage unit 106e in advance. FIG. 26 is as described above.

(1) The radio pager 2201 maintains a reception waiting state.

(2) The first reception unit 106b receives a radio message via the antenna 106a.

(3) The first reception unit 106b judges whether the radio message received in (2) is for the radio pager 2201. If the message is not for the radio pager 2201, the operation returns to (1). Otherwise, the operation proceeds to (4).

(4) The received data analysis unit 2205 analyzes the radio message, extracts the message information 2401 from the radio message, and extracts division information from the message information 2401. Since the division information is “1”, the received data analysis unit 2205 sends the message information 2401 to the divided radio data storage processing unit 2203.

(5) The divided radio data storage processing unit 2203 stores the message information 2401 received in (4) into the data temporary storage unit 2202.

(6) The radio pager 2201 maintains a reception waiting state.

(7) The first reception unit 106b receives a radio message via the antenna 106a.

(8) The first reception unit 106b judges whether the radio message received in (7) is for the radio pager 2201. If the message is not for the radio pager 2201, the operation returns to (6). Otherwise, the operation proceeds to (9).

(9) The received data analysis unit 2205 analyzes the radio message, extracts the message information 2402 from the radio message, and extracts division information from the message information 2402. Since the division information is “1”, the received data analysis unit 2205 sends the message information 2402 to the divided radio data storage processing unit 2203.

(10) The divided radio data storage processing unit 2203 stores the message information 2402 received in (9) into the data temporary storage unit 2202.

(11) The radio pager 2201 maintains a reception waiting state.

(12) The first reception unit 106b receives a radio message via the antenna 106a.

(13) The first reception unit 106b judges whether the radio message received in (12) is for the radio pager 2201. If the message is not for the radio pager 2201, the operation returns to (11). Otherwise, the operation proceeds to (14).

(14) The received data analysis unit 2205 analyzes the radio message, extracts the message information 2403 from the radio message, and extracts division information from the message information 2403. Since the division information is “2”, the received data analysis unit 2205 sends the message information 2403 to the divided radio data combination unit 2204 and instructs the divided radio data combination unit 2204 to combine the divided message information.

(15) The divided radio data combination unit 2204 extracts the message information 2401 and the message information 2402 stored in the data temporary storage unit 2202 and combines the message information 2401, the message information 2402, and the message information 2403. As a result, message information 2500 shown in FIG. 48 is generated and sent to the received data analysis unit 2205.

(16) The received data analysis unit 2205 extracts message header information and message contents information from the message information 2500 received in (15). The received data analysis unit 2505 then extracts program information from the message header information and extracts message contents 1 information and message contents 2 information from the message contents information. As a result, the program information “0001”, the message contents 1 information “10203204 (12 [symbol] )”, and the message contents 2 information “13744104 ( [symbol] )” are extracted.

(17) The program extraction unit 106d extracts a program stored in the program information storage unit 106e in accordance with the program information “0001” extracted in (16). As a result, sub program 301a is extracted.

(18) The program execution unit 106f obtains the message contents 1 information and the message contents 2 information extracted in (16) and starts the execution of the program extracted in (17).

(19) The program execution unit 106f executes sub program 301a and instructs the message output control unit 106g to output the sound specified by the receiver.

(20) The message output control unit 106g has the speaker 106i output the sound specified by the receiver.

(21) The program execution unit 106f executes sub program 301a and generates a display text “12 [symbol] [symbol] ” using the message contents 1 information “10203204 (12 [symbol] )” and the message contents 2 information “13744104 ( [symbol] )”. The program execution unit 106f then instructs the message output control unit 106g to display the display text.

(22) The message output control unit 106g has the LCD 106h display the display text generated in (21).

(23) The operation returns to (1).

With the present embodiment, it is possible to send a message of a large size by dividing the contents of the message and sending each divided part, so that messages of various sizes can be sent. Thus, the transmitter can make a wide variety of messages in greater flexibility.

While the program has a four-digit identifier of a fixed length in the present embodiment, the identifier may be of a variable length. Also, the identifier may be expressed as a string or a code.

While “*8” is used as a separator in the message information in the present embodiment, any other separators may be used or, if possible, the separator may be omitted.

While the division information is placed at the head of the message information in the present embodiment, the division information may instead be placed at the end of the program information. While the division information is expressed as a one-digit value of a fixed length in the present embodiment, the division information may be of a variable length or may be expressed as a string or a code.

While the division information shows whether the message information is the last divided message information in the present embodiment, the division information may instead specify the number “n”, wherein the message information is the “n”th divided message information.

While the program is written in the conceptual form in the present embodiment, the program may be written in any programming languages such as the assembler, C, C++, Tcl, PostScript, and Java. Alternatively, a model template of output messages may be used as the program.

While the free word form is used to express the display text 1 information and the display text 2 information included in the message contents information in the present embodiment, any other data forms for expressing text information may be used.

While the message header information is composed of the division information in the present embodiment, the message header information may also include transmitter information and transmission device type information.

While the radio pager is described as an independent device in the present embodiment, the radio pager may be installed in a mobile device, such as a PHS (Personal Handyphone System), a portable phone, or a PDA (Personal Digital Assistant). If the radio pager is installed in the PHS, for instance, radio messages can be transmitted and received in a one-to-one basis between each radio pager using a transceiver mode of the PHS.

The eighth embodiment is explained next where the control information stored in the storage means relates to event information.

### Eighth Embodiment

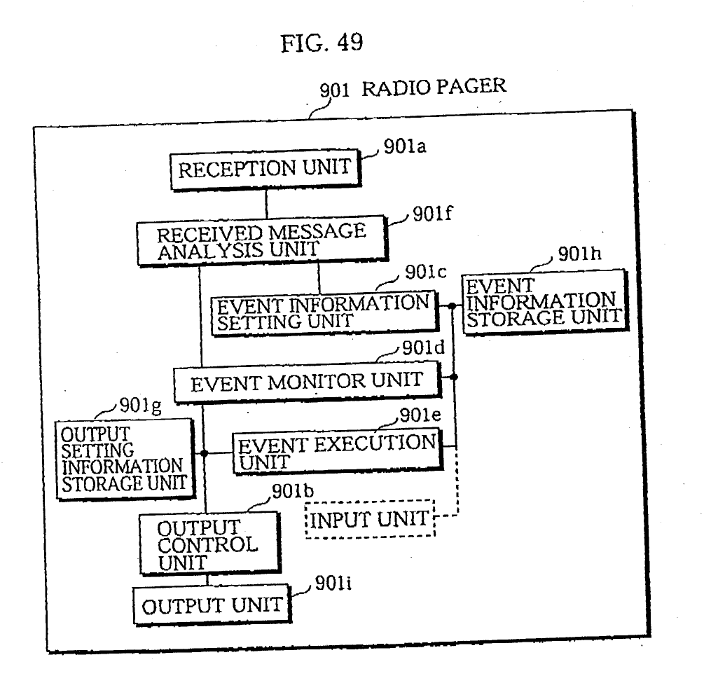

FIG. 49 is a block diagram showing the radio pager of the eighth embodiment of the present invention.

A reception unit 901a receives a message via an antenna (not illustrated).

An event information storage unit 901b stores event instruction information that is composed of event condition information showing an event that leads to execute control and event execution contents information showing the contents of the control to be executed when the event shown by the event condition information occurs.

An event information setting unit 901c executes registration and deletion of the event instruction information in the event information storage unit 901b.

An event monitor unit 901d monitors received messages and a timer to detect the occurrence of the event shown by the event condition information stored in the event information storage unit 901b. Note that the event monitor unit 901e does not need to constantly monitor but monitors whether the event occurs only when a message is received or when a timer is set.

When the event occurs, an event execution unit 901e executes the control shown by the event execution contents information that corresponds to the event.

A received message analysis unit 901f shifts the operation to the event information setting unit 901c if a received message is not an output message but a message for executing internal processing. Otherwise, the received message analysis unit 901f shifts the operation to the event monitor unit 901d.

An output setting information storage unit 901g stores output setting information for output control to be executed when receiving a message and renews the output setting information according to instructions from the event execution unit 901e. Also, the output setting information storage unit 901g has a buffer (not illustrated) for temporarily storing radio messages which are in an event occurrence waiting state.

The output control unit 901h performs the output control including sound output control, vibration control, LED (light-emitting diode) control, and display control. This output control is performed according to the output setting information stored in the output setting information storage unit 901g when a message is received and when the event execution unit 901e instructs the output control unit 901h to perform the output control.

The output unit 901i is composed of a speaker, a vibrator, an LED, and a display that are controlled by the output control unit 901h.

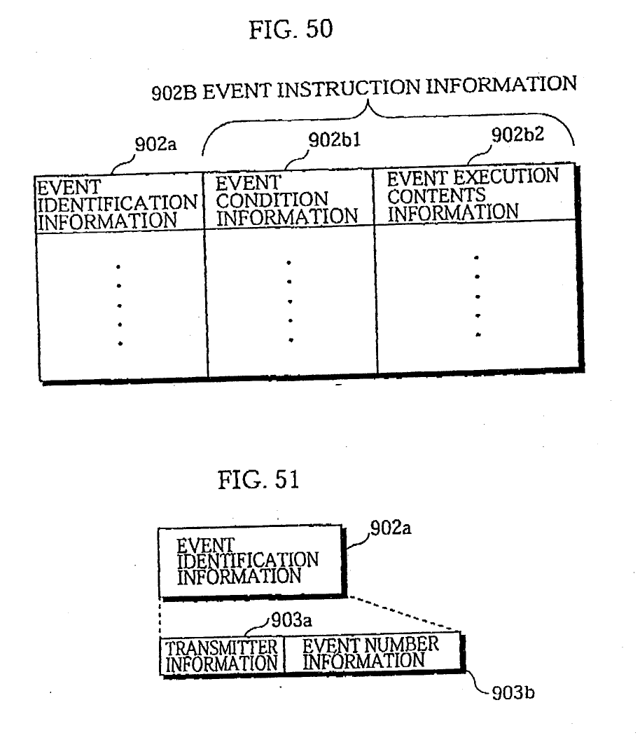

FIG. 50 shows the construction of the event information stored in the event information storage unit 901b shown in FIG. 49. The event information is composed of a combination of event instruction information 902b and event identification information 902a which identifies the event instruction information 902b, the event instruction information 902b being composed of event condition information 902b1 for showing an event which leads to execute the control and event execution contents information 902b2 for showing the contents of the control to be executed when the event shown by the event condition information 902b1 occurs.

FIG. 51 shows the construction of the event identification information 902a shown in FIG. 50.

The event identification information 902a includes transmitter information 903a for showing a registrant of the event instruction information 902b and event number information 903b which is set individually via a transmitter's terminal.

Note that when the radio pager 901 itself registers the event instruction information 902b via a connected terminal, the transmitter information 903a shows the radio pager 901 as the registrant. Which is to say, the transmitter information 903a of the radio pager 901 itself is given in the event identification information 903a. Here, the transmitter information 903a is an ID for identifying the transmitter.

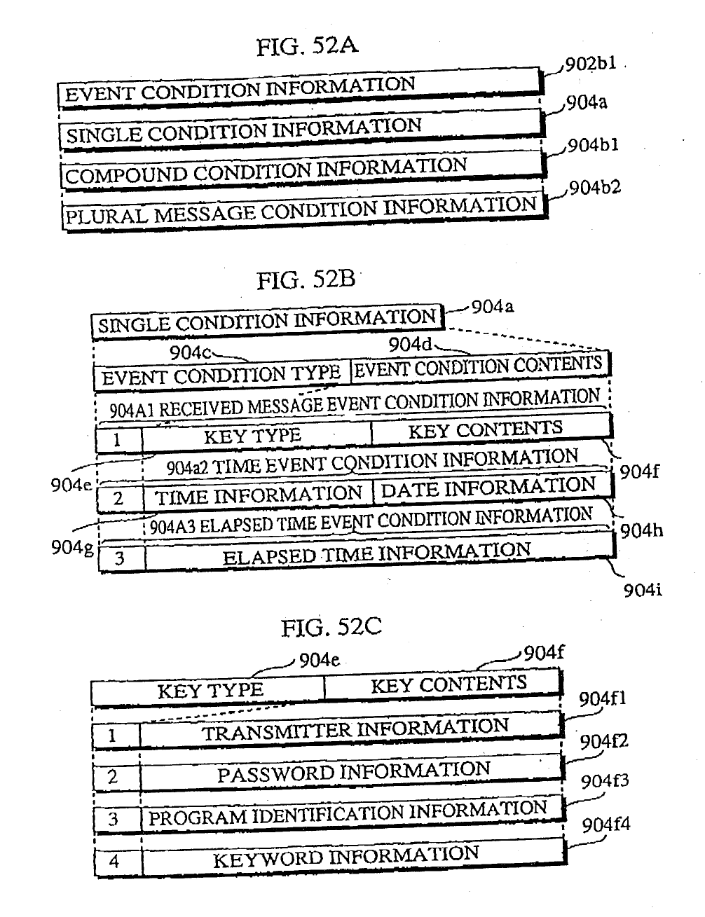

FIG. 52 shows the construction of the event condition information 902b1 shown in FIG. 50.

The event condition information 902b1 shows an event which leads to execution of the control. There are three types of event condition information that are single condition information 904a, compound condition information 904b1, and plural message condition information 904b2.

The single condition information 904a includes an event condition type 904c and event condition contents 904d. Conditions of the event occurrence specified by the single condition information 904a are generally classified into a message reception, a coming of a time, and a lapse of time.

When the event condition type 904c is “1”, it indicates received message event condition information 904a1 showing that an event occurs according to key information in a received message. The event condition contents 904d corresponding to the event condition type 904c “1” includes a key type 904e and key contents 904f. When the key type 904e is “1”, the key contents 904f show transmitter information 904f1. When the key type 904e is “2”, the key contents 904f show password information 904f2. When the key type 904e is “3”, the key contents 904f show program identification information 904f3. When the key type 904e is “4”, the key contents 904f show keyword information 904f4. The program identification information 904f3 is a program ID for identifying a program stored in the event information storage unit 901b. The keyword information 904f4 specifies a given code string. When the keyword information 904f4 specifies “ [symbol] ” (OSAKA), for example, an event condition is satisfied if the received message includes codes showing “ [symbol] ”.

When the event condition type 904c is “2”, it indicates time event condition information 904a2 showing that an event occurs at a certain time. The event condition contents 904d corresponding to the event condition type 904c “2” includes time information 904g and date information 904h. For example, when the time information 904g is “1230” and the date information 904h is “0710”, the time shown by the event condition contents 904d is 12:30 on July 10th.

When the event condition type 904c is “3”, it indicates elapsed time event condition information 904a3 showing that an event occurs after a specified period of time elapses since receiving a message. The event condition contents 904d corresponding to the event condition type 904c “3” include elapsed time information 904i that specifies a period of time from the message reception to the event occurrence. For example, when the elapsed time information 904i is “0130”, the specified period of time is 1.5 hours after the message reception.

The compound condition information 904b1 is expressed as a formula in which the single condition information 904a is used as a term along with operators such as AND “*”, OR “+”, NOT “!”, and delimiters “(” and “)”. For instance, when the compound condition information is a logical OR of two sets of event condition information “event condition 1” and “event condition 2”, the compound condition information is expressed as “(event condition 1)+(event condition 2)”.

The plural message condition information 904b2 is expressed using the single condition information 904a or the compound condition information 904b1 as a term along with an operator “&”. Each term shows a condition in one received message. The plural message condition information 904b2 expressed with the operator “&” shows that an event condition is satisfied when conditions shown by all terms are successively met in respective received messages.

In addition to the above logical signals, a binary operator “-” with the left and right terms showing the time event condition information 904a2 is used to show period information. For instance, when the left term shows 2:00 and the right term shows 4:00 in the time event condition information 904a2, the period information indicates a period from 2:00 to 4:00.

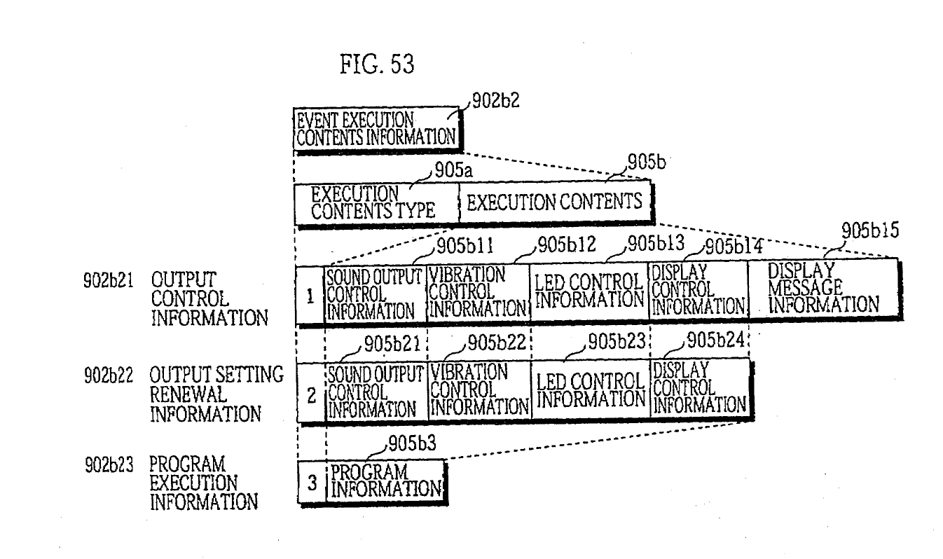

FIG. 53 shows the construction of the event execution contents information 902b2 shown in FIG. 50. The event execution contents information 902b2 includes an execution contents type 905a and execution contents 905b.

When the execution contents type 905a is “1”, it indicates output control information 902b21 for executing the control of notification and displays.

The execution contents 905b corresponding to the execution contents type 905a “1” includes sound output control information 905b11, vibration control information 905b12, LED control information 905b13, display control information 905b14, and display message information 905b15 which is displayed when executing the display control. The execution contents 905b show how to notify of the occurrence of the event and display the message, such as by producing vibrations without outputting melodies.

When the execution contents type 905a is “2”, it indicates output setting renewal information 902b22 for executing the renewal of the output setting information stored in the output setting information storage unit 901g. The execution contents 905b corresponding to the execution contents type 905a “2” include sound output control information 905b21, vibration control information 905b22, LED control information 905b23, and display control information 905b24. When the execution contents type 905a is “3”, it indicates program execution information 902b23 for executing a program. The execution contents 905b corresponding to the execution contents type 905a “3” include program information 905b3.

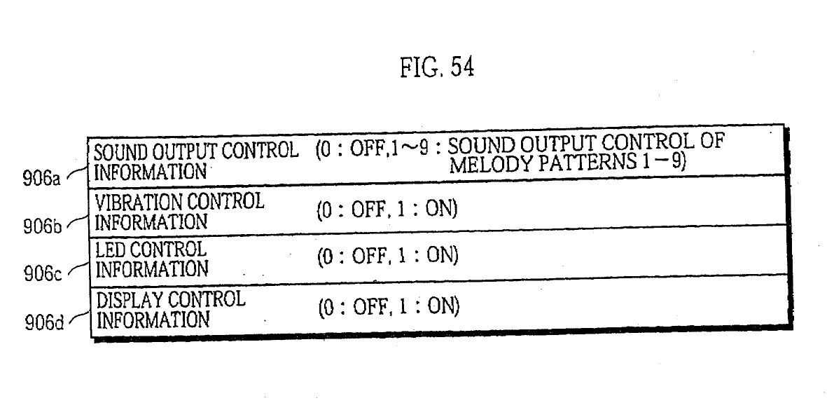

FIG. 54 shows types of the output setting information stored in the output setting information storage unit 901g and meanings of the codes included in each type of the output setting information. Note that the meanings of the codes in the output setting information storage unit 901g shown in FIG. 54 also apply to the sound output control information 905b11 and other information included in the output control information 902b21 and to the sound output control information 905b21 and other information included in the output setting renewal information 902b22 shown in FIG. 53.

Sound output control information 906a has the codes “0” to “9”. When the sound output control information 906a is “0”, the output is OFF, that is, no melody is outputted. When the sound output control information 906a is “1”-“9”, melody patterns 1-9 are respectively outputted. Vibration control information 906b has the codes “0” and “1”. When the vibration control information 906b is “0”, the vibration control is not executed. When the vibration control information 906b is “1”, the vibration control is executed. LED control information 906c has the codes “0” and “1”. When “0”, the LED control is not executed, that is, the LED does not flash. When “1”, the LED control is executed. Display control information 906d has the codes “0” and “1”. When “0”, the display control is not executed, that is, no display is made. When “1”, the display control is executed.

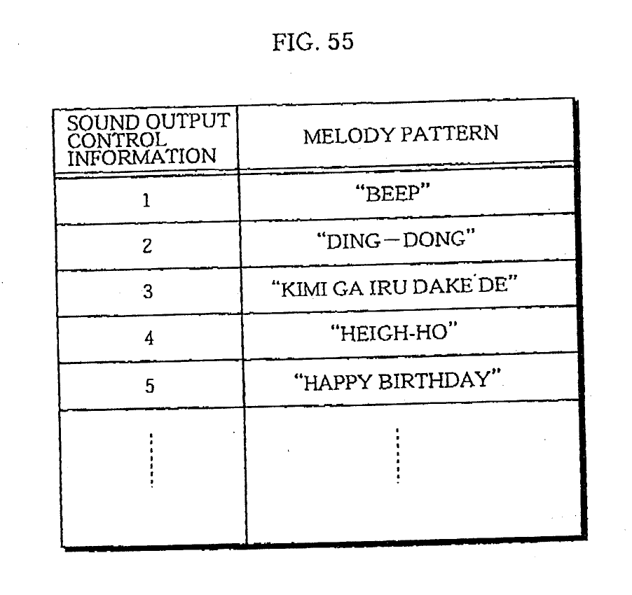

FIG. 55 shows a specific example of the melody patterns corresponding to the codes “1”-“9” of the sound output control information 906a shown in FIG. 54.

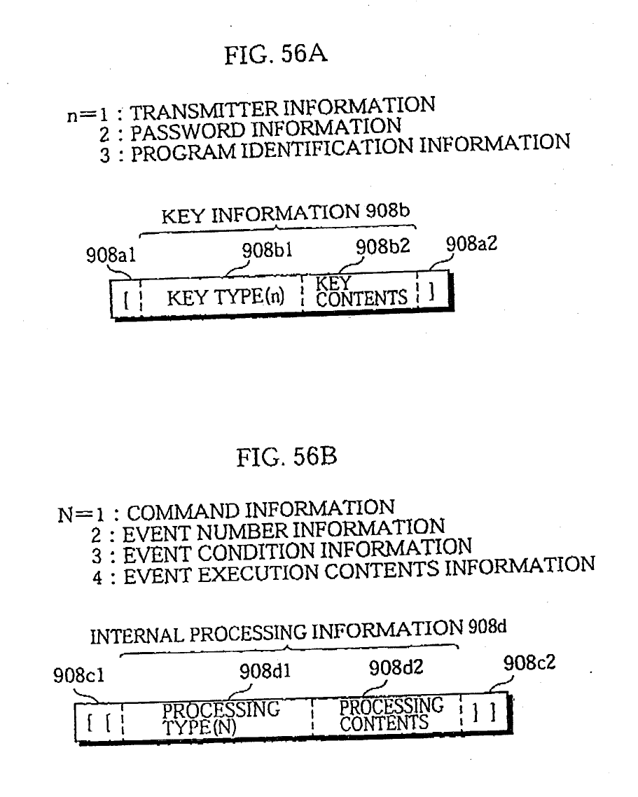

FIG. 56 shows key information and internal processing information that are included in a received message.

Data sandwiched between a separator 908a1 “[” and a separator 908a2 “]” in the received message is key information 908b. The key information 908b is composed of a key type 908b1 and key contents 908b2. When the key type 908b1 is “1”, the key contents 908b2 show transmitter information 904f1. When the key type 908b1 is “2”, the key contents 908b2 show password information 904f2. When the key type 908b1 is “3”, the key contents 908b2 show program identification information. The key contents 908b2 are as described in FIG. 52.

Data sandwiched between a separator 908c1 “[[” and a separator 908c2 “]]” in the received message is internal processing information 908d, which is composed of a processing type 908d1 and processing contents 908d2.

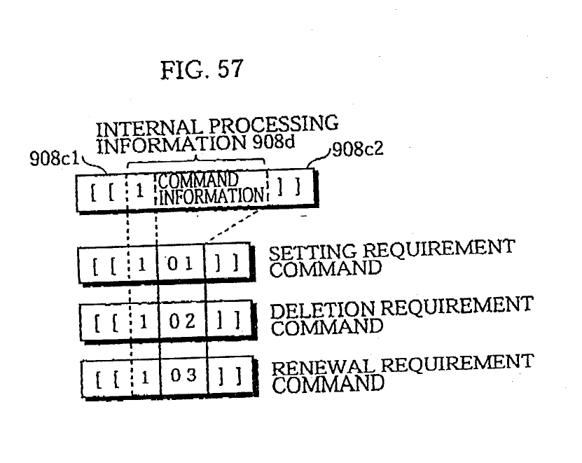

When the processing type 908d1 is “1”, the processing contents 908d2 show command information. When the processing type 908d1 is “2”, the processing contents 908d2 show the event number information 903b. When the processing type 908d1 is “3”, the processing contents 908d2 show the event condition information 902b1. When the processing type 908d1 is “4”, the processing contents 908d2 show the event execution contents information 902b2. The event number information 903b, the event condition information 902b1, and the event execution contents information 902b2 are as described in FIGS. 51-53, respectively. The command information is explained below with reference to FIG. 57.

FIG. 57 shows a case when the processing type in the internal processing information included in the received message is “1” that shows the command information.

The command information “01” shows a setting requirement command that requires to register the event instruction information 902b into the event information storage unit 901b. The command information “02” shows a deletion requirement command that requires to delete the event instruction information 902b in the event information storage unit 901b. The command information “03” shows a renewal requirement command that requires to partially change the event instruction information 902b in the event information storage unit 901b.

The following is an explanation of the specific operation of the radio pager of the eighth embodiment of the present invention with the above construction, using the operation examples that are: (1) when the event condition is a transmitter; (2) when the event condition is a time; (3) when the event condition is a password; (4) when the event condition is an elapsed time; (5) when registering event information and using program information; and (6) when using the program information.

### First Example

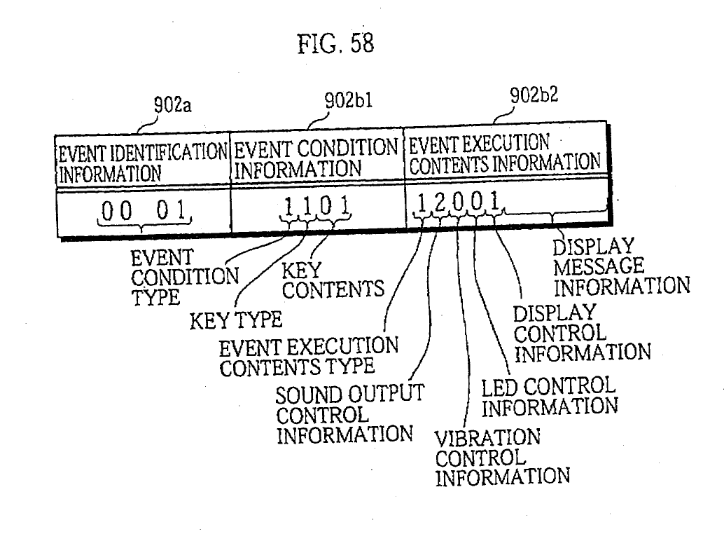

FIG. 58 shows an example of the event instruction information 902b stored in the event information storage unit 901b. Here, the event condition information 902b1 “1101” is made up of the event condition type “1”, the key type “1”, and the key contents “01” as shown in FIG. 52. The event condition type “1” shows that an event occurs by a message reception. The key type “1” shows that the key contents are the transmitter information. The key contents “01” show a transmitter whose transmitter ID is “01”. Thus, the event condition information “1101” shows that an event condition is met when receiving a message from the transmitter whose transmitter ID is “01”. The transmitter whose transmitter ID is “01” is hereinafter referred to as the transmitter “01”.

The event execution contents information 902b2 includes an execution contents type “1” and execution contents “2011” as shown in FIG. 53. The execution contents type “1” shows that the execution contents “2011” relate to the output control. In the execution contents “2011”, sound output control information “2” shows that notification is to be made by the sound output control of the melody pattern “2”, vibration control information “0” and LED control information “0” show that neither the vibration nor the LED flashing is to be used, and display control information “1” shows that the received message is to be displayed. Display message information shows information which is to be displayed with the received message. In the present example, the display message information is not registered.

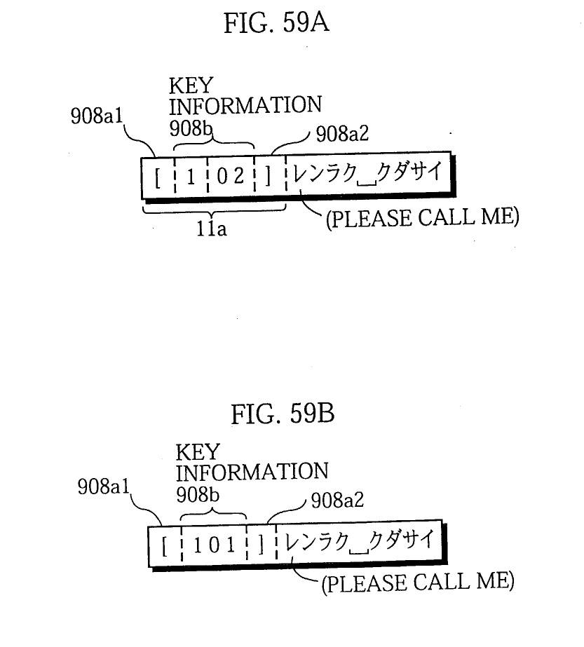

FIG. 59 shows examples of received messages. As shown in FIG. 56, information sandwiched between the separator 908a1 “[” and the separator 908a2 “]” is the key information 908b. The key information 908b “102” is composed of a key type “1” and key contents “02” in FIG. 59A. The key type “1” shows that the key contents are transmitter information, wherein the key contents “02” show a transmitter “02”. Accordingly, the received message in FIG. 59A is a message “ [symbol] ” (PLEASE CALL ME) sent from the transmitter “02”. Similarly, the received message shown in FIG. 59B is a message “ [symbol] ” from the transmitter “01”.

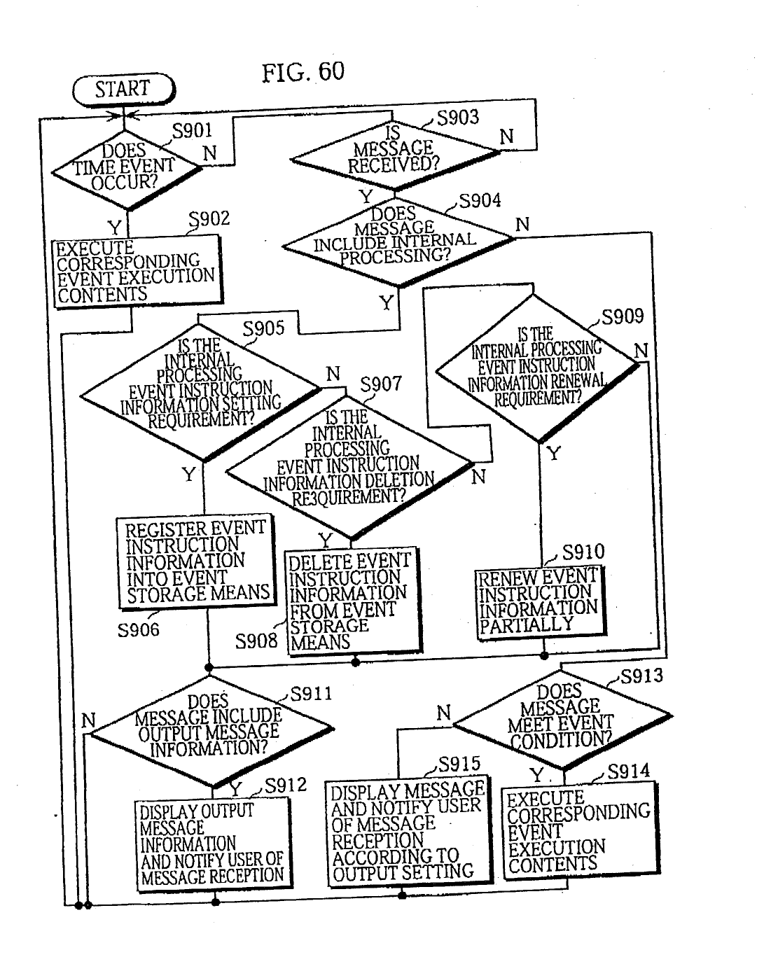

FIG. 60 is a flowchart showing the operation of the radio pager 901. Each step in the operation is described below.

Step S901: Proceed to Step S902 if an event occurs as a result of the coming of a time or the lapse of time shown by the event condition information 902b1 stored in the event information storage unit 901b. Otherwise, proceed to Step S903.

Step S902: Execute the event execution contents information 902b2 corresponding to the event occurred in Step S901, and return to Step S901.

Step S903: Proceed to Step S904 if a message is received. Otherwise, return to Step S901.

Step S904: Proceed to Step S905 if the received message includes information relating to internal processing. Otherwise, proceed to Step S913.

Step S905: Proceed to Step S906 if the internal processing relates to the setting of the event instruction information 902b in the event information storage unit 901b. Otherwise, proceed to Step S907.

Step S906: Register the event instruction information 902b into the event information storage unit 901b and proceed to Step S911.

Step S907: Proceed to Step S908 if the internal processing relates to the deletion of the event instruction information 902b from the event information storage unit 901b. Otherwise, proceed to Step S909.

Step S908: Delete the event instruction information 902b from the event information storage unit 901b and proceed to Step S911.

Step S909: Proceed to Step S910 if the internal processing relates to the partial change of the event instruction information 902b in the event information storage unit 901b. Otherwise, proceed to Step S911.

Step S910: Partially renew the event instruction information 902b in the event information storage unit 901b and proceed to Step S911.

Step S911: Proceed to Step S912 if the received message includes output message information in addition to the internal processing information. Otherwise, return to Step S901.

Step S912: Execute the display and notification of the output message information.

Step S913: Proceed to Step S914 if the received message meets an event condition of the event condition information 902b1. Otherwise, proceed to Step S915.

Step S914: Execute the event execution contents information 902b2 corresponding to the event condition information 902b1 and return to Step S901.

Step S915: Execute the display of the received message according to output setting information stored in the output setting information storage unit 901g and return to Step S901.

The following is an explanation of the difference of the operation when the radio pager which stores the event instruction information shown in FIG. 58 receives two different messages shown in FIG. 59, with reference to FIG. 60.

First, the operation when receiving the message from the transmitter “02” shown in FIG. 59A is explained.

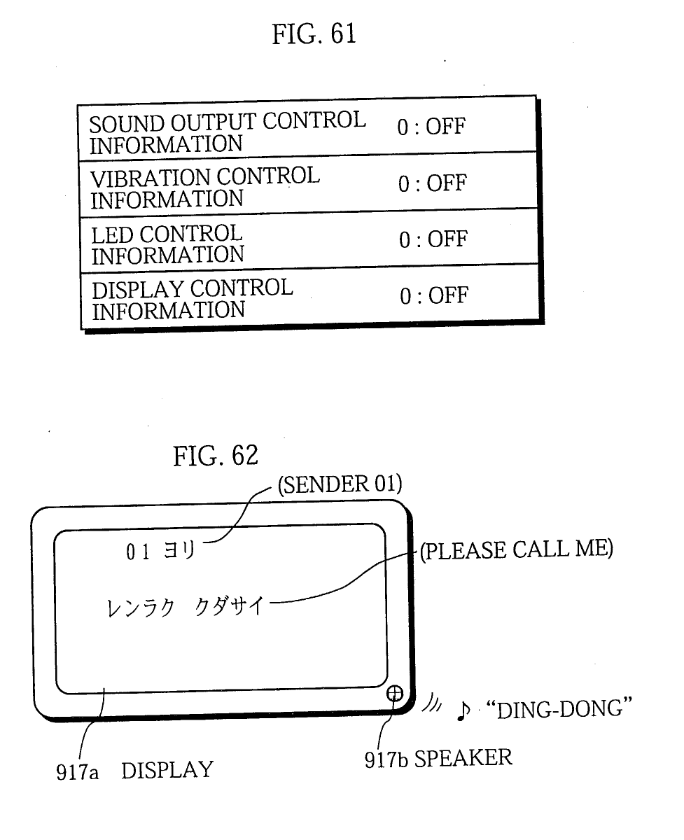

Since event condition information relating to a time or an elapsed time is not stored in the event information storage unit 901b, an event does not occur by the coming of the time or the elapsed time (Step S901). Accordingly, the operation proceeds to Step S903. The reception unit 901a receives the message and the operation proceeds to Step S904. In Step S904, the received message analysis unit 901f judges that the received message does not relate to internal processing, since the received message does not include the separator 908c1 “[[”, and the operation proceeds to Step S913. In Step S913, the event monitor unit 901d checks the event condition information in the event information storage unit 901b. Since the received message does not meet an event condition that the transmitter is the transmitter “01” specified by the event condition information, the event monitor unit 901d shifts the operation to the output control unit 901h. In Step S915, the output control unit 901h performs the output control according to the output setting information stored in the output setting information storage unit 901g. Here, the output setting information in the output setting information storage unit 901g shows that all types of the output setting information are “0”, that is, no output control is to be executed, as shown in FIG. 61. Accordingly, the user is not notified of the message reception.

Next, the operation when receiving the message from the transmitter “01” is explained. The operation proceeds to Step S913 in the same way as receiving the message from the transmitter “02”. In Step S913, the event monitor unit 901d checks the event condition information in the event information storage unit 901b and judges that the received message meets the event condition that the transmitter is the transmitter “01” specified by the event condition information. Accordingly, the event monitor unit 901d notifies the event execution unit 901e of the occurrence of the event and shifts the operation to the event execution unit 901e. In Step S914, the event execution unit 901e performs the control according to the event execution contents information stored in the event information storage unit 901b. The event execution contents information corresponding to the above event condition information is that the sound output control of the melody pattern “2” and the display control of the received message are to be performed. Accordingly, the event execution unit 901e instructs the output control unit 901h to perform the control specified by the event execution contents information. FIG. 62 shows an output example. The output control unit 901h has the display 917a in the output unit 901i display the message information “ [symbol] ” and the transmitter ID “01”. The output control unit 901h also has the speaker 917b in the output unit 901i output the melody “ding-dong” of the melody pattern “2” to notify the user of the message reception.

As described above, with the present embodiment it is possible to perform the different operations for messages from different transmitters.

Note that any types of information, such as a transmitter name, a common name, and a transmission number, may be used as the transmitter information 903a, as long as they can identify the transmitter. Transmission terminal information, such as a transmission terminal ID, may instead be used as the transmitter information 903a.

While the transmitter information is used as the event condition information 902b1 stored in the event information storage unit 901b in the present example, the event condition information 902b1 may instead be keyword information. In such a case, when a received message includes a keyword specified by the keyword information, the output operation can be performed in a different way, such as by outputting a special melody, from messages which do not include the keyword.

Note that a plurality of event conditions can be combined to execute different output operations by setting the compound condition information 904b1 as the event condition information 902b1. For instance, it can be set such that the output operation changes when receiving a message that is sent from a specified transmitter and that also includes a specified keyword, such as “ [symbol] ” (URGENT).

Also, by setting the plural message condition information 904b2 as the event condition information 902b1, the user is notified of the message reception only after receiving all specified messages. As a result, the user does not need to be notified of the received messages one by one but can be notified of them all at once.

While the display 917a displays a text in the present example, the display 917a may also display animation, static images, and moving images in combination with the melody outputted from the speaker 917b. In such a case, images can be easily displayed by flashing each dot of the display 917a on and off or by combining sideways scrolling and up-and-down scrolling in units of dots.

### Second Example

The following is an explanation of the specific operation of the radio pager 901 when receiving a message with which the transmitter has specified an operation to be performed at a desired time, with reference to FIGS. 60 and 63-65.

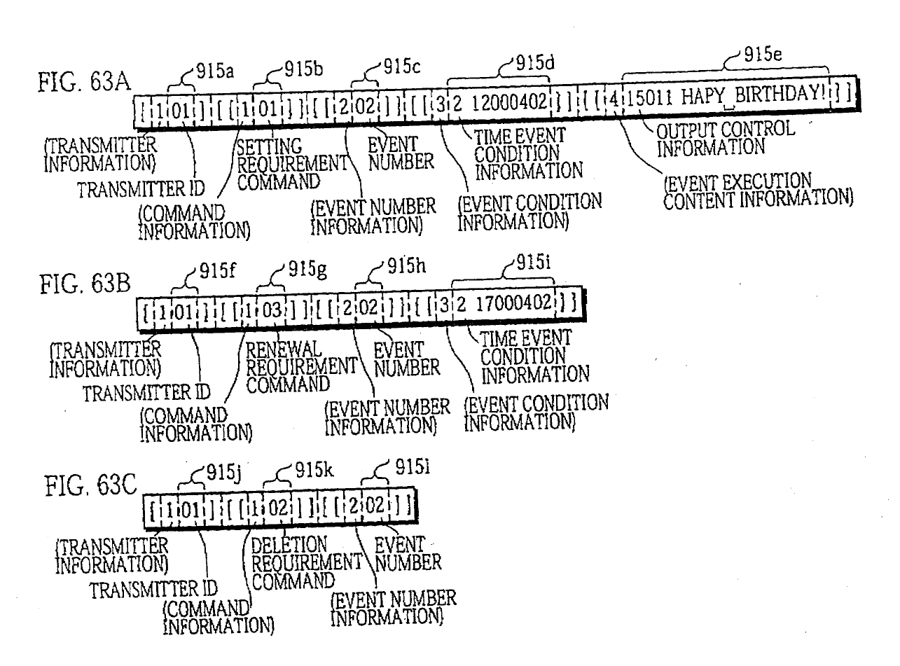

FIG. 63A shows a message for setting event information in the event information storage unit 901b. The message includes transmitter information 915a, command information 915b, event number information 915c, event condition information 915d, and event execution contents information 915e.

The transmitter information 915a shows that the message is sent from the transmitter “01”. The command information 915b shows a setting requirement command. The event number information 915c has the value “02”, which is combined with the transmitter information 915a “01” to form the event identification information 902a “0102”. The event identification information 902a is used to identify the event instruction information 902b stored in the radio pager 901. The event condition information 915d shows that an event occurs at 12:00 on April 2nd, as explained in FIG. 52. The event execution contents information 915e shows that the output of the melody pattern “5”, the LED flashing, and the display of display message information “HAPPY BIRTHDAY!” are to be performed, as explained in FIG. 53.

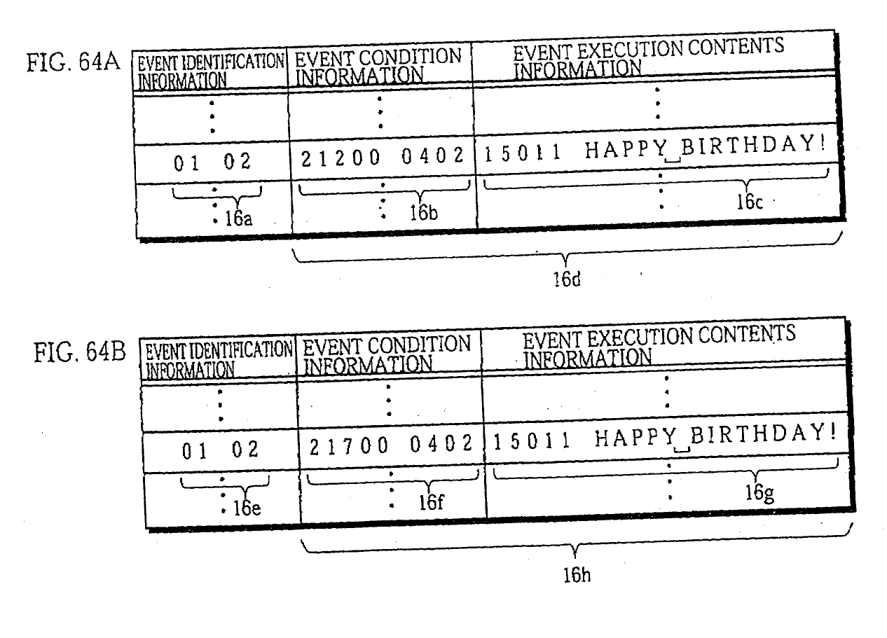

FIG. 64A shows event information registered in the event information storage unit 901b as a result of receiving the message shown in FIG. 63A.

The operation when receiving the message shown in FIG. 63A is explained below with reference to FIG. 60.

In Step S901, since the event information storage unit 901b does not store event condition information 902b1 which specifies a time or an elapsed time as an event condition, a time event does not occur. Accordingly, the operation proceeds to Step S903.

In Step S903, the reception unit 901a receives the message. In Step S904, the received message analysis unit 901f judges that the received message includes information relating to internal processing, since the received message includes data sandwiched between the separator 908c1 “[[” and the separator 908c2 “]]”. In Step S905, the event information setting unit 901c refers to the command information 915b “01” in the received message to judge that the received message is a setting requirement message.

In Step S906, the event information setting unit 901c registers the event instruction information 902b and the event identification information 902a “0102” for identifying the event instruction information 902b into the event information storage unit 901b, the event instruction information 902b being composed of the event condition information 915d and the event execution contents information 915e. On completing the registration in the event information storage unit 901b, the event information setting unit 901c notifies the event monitor unit 901d of the registration. The event monitor unit 901d starts monitoring an occurrence of an event specified by the newly registered time event condition information 904a2 “21200”.

In Step S911, when the received message does not include information other than the information relating to the internal processing and the key information 908b sandwiched between the separator 908a1 “[” and the separator 908a2 “]”, the received message is judged as not including output message information. Since the received message does not include the output message information in the present example, the operation returns to Step S901.

FIG. 64A shows the event information registered in the event information storage unit 901b in Step S906. The event identification information, the event condition information, and the event execution contents information included in the received message are registered as shown in the figure.

The operation of executing the registered event execution contents information is explained next. When the time event condition information 904a2 is registered, the event monitor unit 901d starts monitoring a timer and notifies the event execution unit 901e of the occurrence of the event at the registered time “12:00 on April 2nd”. Then the operation proceeds from Step S901 to Step S902.

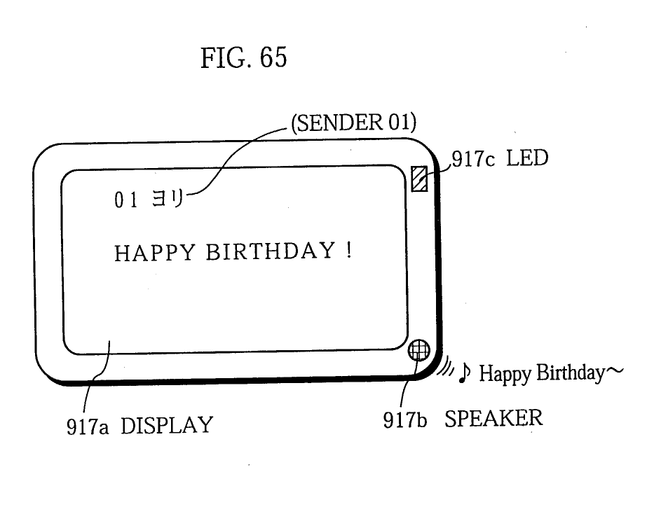

In Step S902, the event execution unit 901e instructs the output control unit 901h to perform the output control according to the registered event execution contents information. As shown in an output example in FIG. 65, the output control unit 901h has the display 917a display the transmitter ID “01” and “HAPPY BIRTHDAY!”. The output control unit 901h also has the speaker 917b output the sound “Happy Birthday” of the melody pattern “5” and has the LED 917c flash to notify the user of the message reception. Since the registered event condition information 902b1 is the time event condition information 904a2, the event execution unit 901e deletes the event information shown in FIG. 64A which has already been executed from the event information storage unit 901b. Then the operation returns to Step S901.

The operation of renewing the event instruction information registered in the above operation is explained next.

Suppose the event instruction information is still registered, since the time specified by the event condition has not come yet.

The following is an explanation of the operation of changing the time from “12:00” to “17:00” using a message shown in FIG. 63B.

FIG. 63B shows a renewal requirement message for the event instruction information 902b. The message includes transmitter information 915f, command information 915g, event number information 915h, and event condition information 915i.

The event instruction information that is subjected to the change is identified by the event identification information “0102” which is composed of the transmitter information 915f “01” and the event number information 915h “02”. The command information 915g “03” shows a renewal requirement command for requiring the partial change of the event instruction information. The event condition information 915i “217000402” is the time event condition information 904a2 showing that the event occurs at “17:00 on April 2nd”, as explained in FIG. 52.

The operation when receiving this renewal requirement message is explained below with reference to FIG. 60.

The operation proceeds to Step S905 in the same way as the operation when receiving the message shown in FIG. 63A.

The operation proceeds from Step S905 to Steps 907, S909, and then S910, since the received message is the renewal requirement message as indicated by the command information 915g “03”.

In Step 910, the event information setting unit 901c renews the event instruction information stored in the event information storage unit 901b according to the received message. FIG. 64B shows the renewed event instruction information. The event occurrence time is renewed as shown in the event condition information “217000402”, while the event execution contents information which is not included in the received message is not changed. The event information setting unit 901c notifies the event monitor unit 901d of the renewal of the event information in the event information storage unit 901b. On receiving the notification, the event monitor unit 901d changes the event occurrence time from “12:00” to “17:00”. The operation of cancelling the registered event instruction information is explained next.

The following is an explanation of the operation of deleting the registered event instruction information in accordance with a message shown in FIG. 63C, with reference to FIG. 60. FIG. 63C shows a deletion requirement message that includes transmitter information 915j, command information 915k, and event number information 915l. The operation when receiving this deletion requirement message proceeds to Step S905 in the same way as the operation when receiving the above setting requirement message.

The operation proceeds from Step S905 to Steps S907 and then S908, since the received message is the deletion requirement message as indicated by the command information 915k “02”.

In Step S908, the event information setting unit 901c deletes the event identification information “0102”, which is composed of the transmitter information 915j “01” and the event number information 915l “02”, and the event instruction information specified by the event identification information “0102” from the event information storage unit 901b. The event information setting unit 901c then notifies the event monitor unit 901d of the deletion. The event monitor unit 901d accordingly completes the monitoring of the occurrence of the event specified by the deleted time event condition information 904a2.

As described above, with the present embodiment the transmitter can specify how and when the operation is performed in the radio pager of the receiver.

The transmitter can also modify or cancel the operation which has been specified, by sending an appropriate message.

The message which includes the event identification information (composed of the transmitter information 915a and the event number information 915c), the command information 915b, the event condition information 915d, and the event execution contents information 915e is used to register the event information into the event information storage unit 901b in the present example. However, a message which includes the event condition information 915d and the event execution contents information 915e is sufficient if just registering the event information in the event information storage unit 901b.

Note that the registration in the event information storage unit 901b may be performed using a local-mode input device such as a personal computer.

Note that any data which can specify a time and a date may be used instead of the date information 904h and the time information 904g.

Also, the date information 904h does not have to be used.

While the event information for the time event condition is deleted from the event information storage unit 901b once the event occurs and the event execution contents information is executed in the present example, the event information does not need to be deleted but may continue to be stored, so that the same event will repeatedly occur.

### Third Example

The following is an explanation of an example of changing a notification method according to password information included in a received message.

Here, output setting information of no notification control is stored in the output setting information storage unit 901g as shown in FIG. 61.

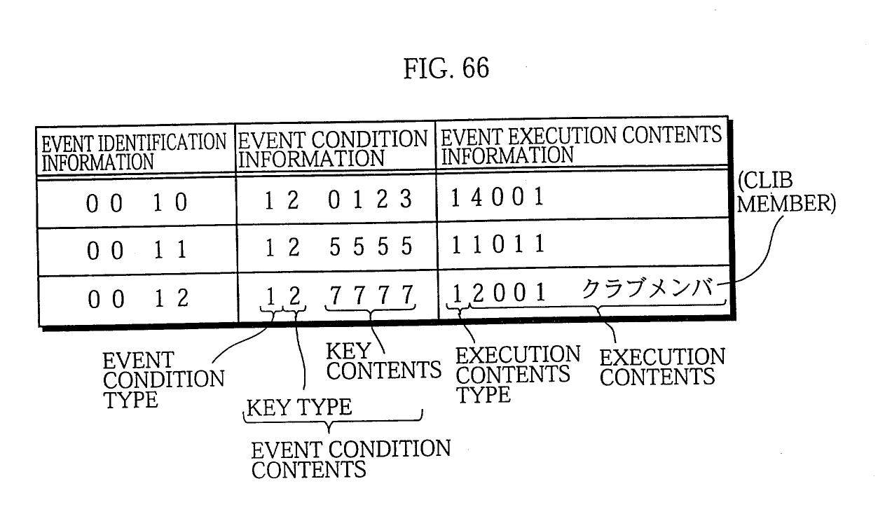

FIG. 66 shows the event instruction information 902b stored in the event information storage unit 901b. The event condition information 902b1 is composed of the event condition type 904c and the event condition contents 904d. The event condition type “1” shows that an event occurs by a message reception and that the event condition contents are made up of a key type and key contents. The key type “2” shows that the key contents are password information, wherein the key contents specify the password information “7777”. Thus, the event condition information shows that the event occurs when receiving a message whose password information is “7777”. The event information storage unit 901b also stores two other sets of event instruction information which show that an event occurs when receiving a message with password information “0123” and “5555”, respectively.

The event execution contents information 902b2 is composed of the execution contents type 905a and the execution contents 905b. The execution contents type “1” shows that the execution contents are the output control information 902b21. The execution contents “2001 [symbol] ” (CLUB MEMBER) show that a received message and “ [symbol] ” are to be displayed, along with the execution of the sound output control of the melody pattern “2”, as explained in FIG. 53.

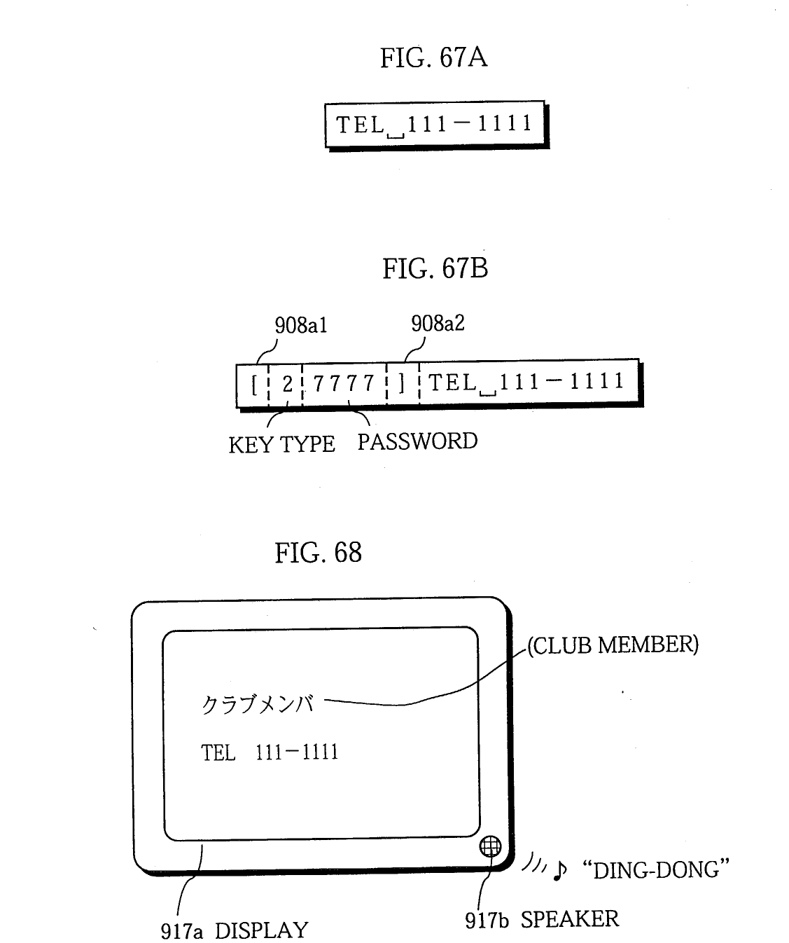

In FIG. 67, information sandwiched between the separator 908a1 “[” and the separator 908a2 “]” is the key information 908b shown in FIG. 56. The key information 908b is composed of the key type 908b1 and the key contents 908b2. The key type “2” shows that the key contents are the password information which is “7777”.

The following is an explanation of the different operations when receiving the message with no password information shown in FIG. 67A and when receiving the message with the password information shown in FIG. 67B, with reference to FIG. 60.

First, the operation when receiving the message shown in FIG. 67A is explained. The operation proceeds from Step S901 to Step S903, since event information which sets a time or an elapsed time as an event condition is not stored in the event information storage unit 901b as shown in FIG. 66. On receiving the message shown in FIG. 67A, the operation proceeds to Step S904 where the received message analysis unit 901f judges that the received message does not include information relating to internal processing. In Step S913, the event monitor unit 901d checks event instruction information in the event information storage unit 901b and judges that the received message does not meet any conditions specified by the three sets of event condition information shown in FIG. 66, the conditions being the inclusion of the password information “0123”, “5555”, and “7777”, respectively. In Step S915, the output control unit 901h refers to the output setting information of no notification and display control of the message in the output setting information storage unit 901g as shown in FIG. 61. Accordingly, neither display nor notification of the received message is performed. The operation then returns to Step S901.

Next, the operation when receiving the message with the password information shown in FIG. 67B is explained. The operation proceeds from Step S901 to Step S903, since event information which sets a time or an elapsed time as an event condition is not stored in the event information storage unit 901b as shown in FIG. 66. On receiving the message shown in FIG. 67A, the operation proceeds to Step S904 where the received message analysis unit 901f judges that the received message does not include information relating to internal processing. In Step S913, the event monitor unit 901d checks the event instruction information in the event information storage unit 901b and judges that the password information “7777” in the received message meets the condition specified by the event condition information, that is, the inclusion of the password information “7777”. Accordingly, the event monitor unit 901d notifies the event execution unit 901e of the occurrence of the event, and the operation proceeds to Step S914.

The event execution unit 901e instructs the output control unit 901h to perform the output control in accordance with the event execution contents information stored in the event information storage unit 901b. FIG. 68 shows an output example. The output control unit 901h has the display 917a in the output unit 901i display the received message “TEL 111-1111” and the display message information “ [symbol] ”. The output control unit 901h also has the speaker 917b in the output unit 901i output the melody “ding-dong” of the melody pattern “2” to notify the user of the message reception.

As described above, with the present embodiment it is possible to execute different operations when receiving a message which meets a registered condition on password information and when receiving a message which does not meet the condition. Also, it is possible to register a plurality of sets of password information and associate each set of password information with a different operation to be performed after message reception.

### Fourth Example

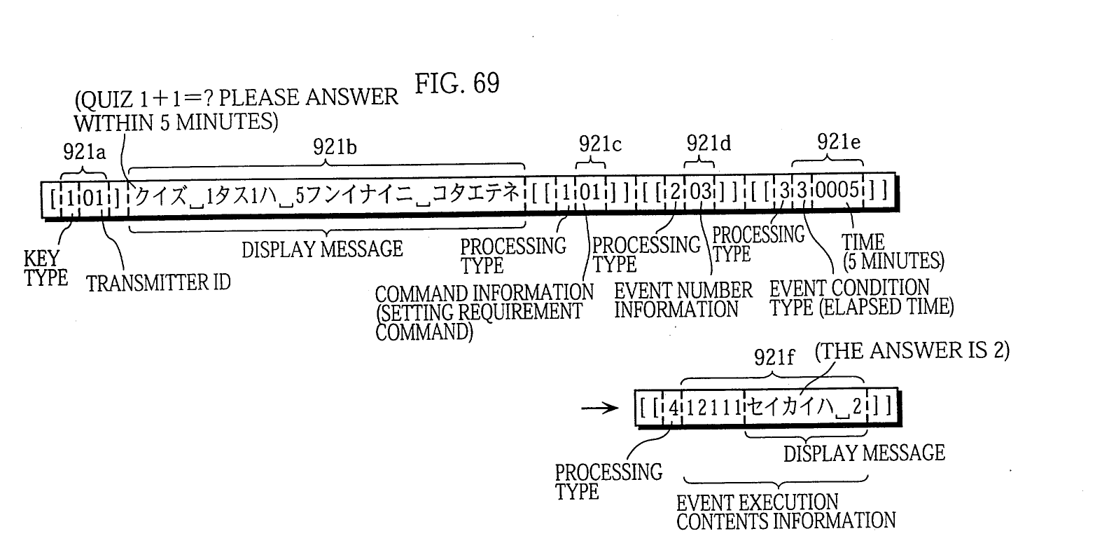

The following is an explanation of the operation when receiving a message that relates to an elapsed time event condition, with reference to FIGS. 60 and 69-72. FIG. 69 shows a specific example of a received message. Key information 921a sandwiched between the separator 908a1 “[” and the separator 908a2 “]” shows that the message is sent from the transmitter “01”. Command information 921c shows the setting requirement command of the event instruction information 902b. Event number information 921d is combined with the transmitter information 921a to form the event identification information 902a “0103”. Event condition information 921e includes the event condition type “3” indicating that the event condition contents 904d are the elapsed time information 904i. The elapsed time information 904i “0005” shows that an event occurs “00” hours and “05” minutes (5 minutes) after the message reception. Event execution contents information 921f shows that display message information 921f1 is to be displayed along with the execution of the sound output control of the melody pattern “2”, the vibration control, and the LED flashing control, as explained in FIG. 53.

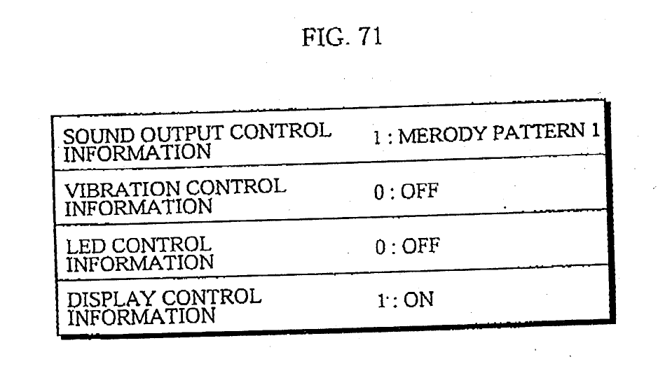

Here, the output setting information storage unit 901g stores output setting information specifying the sound output control of the melody pattern “1” and the display control of the received message to be performed, as shown in FIG. 71.

The operation when receiving the message shown in FIG. 69 is explained below with reference to FIG. 60.

The operation proceeds from Step S901 to Step S903, since event information which sets a time or an elapsed time as an event condition is not stored in the event information storage unit 901b. On receiving the message shown in FIG. 69, the operation proceeds to Step S904.

In Step S904, the received message analysis unit 901f judges that the received message include internal processing information, since data sandwiched between the separator 908c1 “[[” and the separator 908c2 “]]” is included in the message. Accordingly, the received message analysis unit 901f shifts the operation to the event information setting unit 901c. In Step S905, the event information setting unit 901c checks the command information 921c “01” that specifies the setting requirement command of the event instruction information 902b, and the operation proceeds to Step S906.

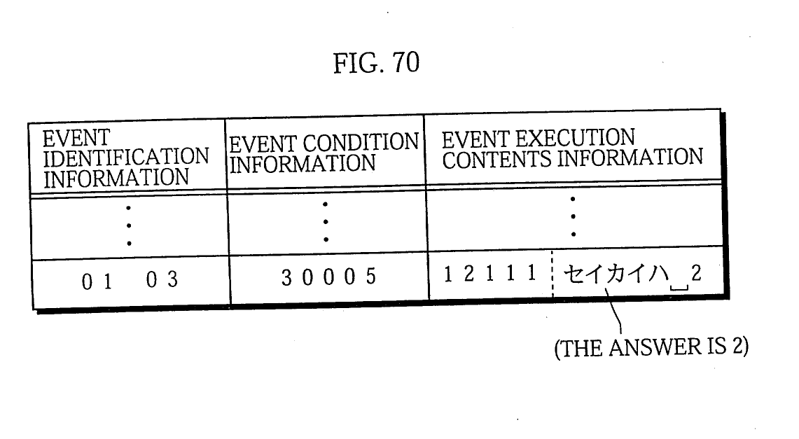

The event information setting unit 901c registers the event condition information 921e, the event execution contents information 921f, and the event identification information 902a which is composed of the transmitter information 921a and the event number information 921d into the event information storage unit 901b. FIG. 70 shows the registered event identification information, event condition information, and event execution contents information. The transmitter information 921a “01” and the event number information 921d, “03” in the received message are registered as the event identification information “0103”. The event condition information 921e “30005” in the received message is registered as the event condition information “30005” showing that an event occurs “00” hours and “05” minutes (5 minutes) after the registration. The event execution contents information 921f in the received message is registered as the event execution contents information. On completing the registration in the event information storage unit 901b, the event information setting unit 901c notifies the event monitor unit 901d of the registration. The event monitor unit 901d starts counting the timer, since the newly registered event condition information is the elapsed time event condition information 904a3 showing that the event occurs 5 minutes later.

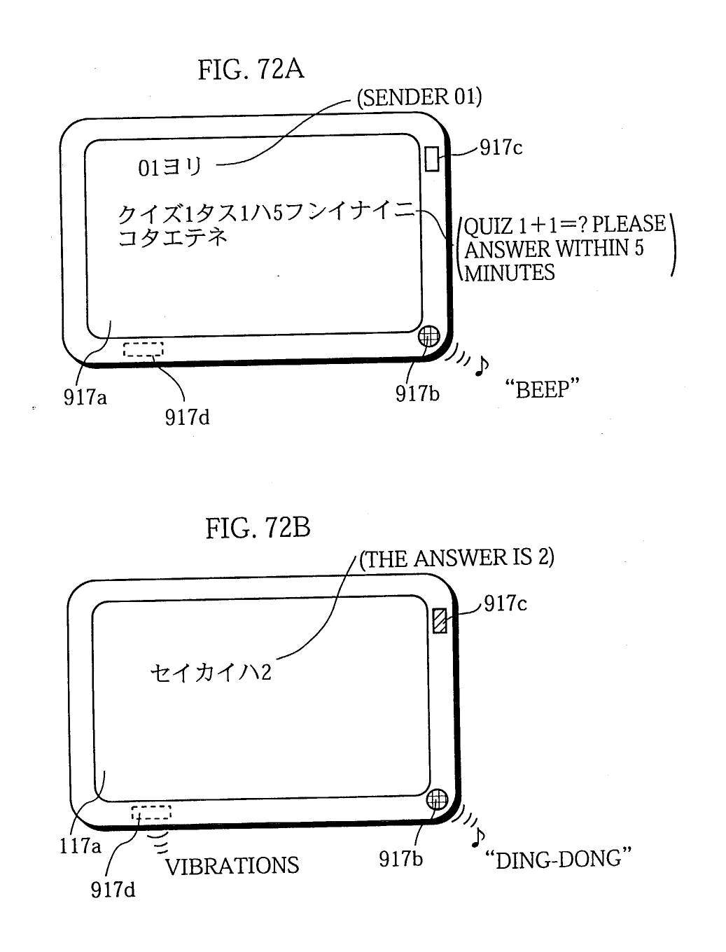

In Step S911, since the received message includes output message information 921b, the event information setting unit 901c instructs the event execution unit 901e to display the output message information 921b and the transmitter information 921a “01”. In Step S912, the event execution unit 901e instructs the output control unit 901h to display the output message information 921b and the transmitter information 921a. The output control unit 901h accordingly performs the output control according to the output setting information in the output setting information storage unit 901g. FIG. 71 shows the output setting information in the output setting information storage unit 901g which specifies the sound output control of the melody pattern “1” to notify the user of the message reception. FIG. 72A shows an output example. The transmitter ID “01” and the output message information 921b “z,173 5 [symbol] ” (QUIZ 1+1=? PLEASE ANSWER WITHIN 5 MINUTES) are displayed with the sound output control of the melody pattern “1” for notifying the user of the message reception. Then the operation returns to Step S901.

In Step S901, when 5 minutes which are the elapsed time specified by the event condition information have passed since the event condition information was registered, the event monitor unit 901d notifies the event execution unit 901e of the event occurrence. In Step S902, the event execution unit 901e instructs the output control unit 901h to perform the output control shown by the event execution contents information corresponding to the event. The output control unit 901h accordingly performs the output control. Once the event execution contents information is executed, the event execution unit 901e deletes the event information relating to the elapsed time shown in FIG. 70 from the event information storage unit 901b.

FIG. 72B shows an output example. According to the instruction from the event execution unit 901e, the output control unit 901h has the display 917a in the output unit 901i display the display message information “ [symbol] 2” (THE ANSWER IS 2), has the speaker 917b output the melody “ding-dong” of the melody pattern “2”, has the vibrator 917d vibrate, and has the LED 917c flash.

With the present embodiment, the transmitter can specify that the desired operation be performed in the radio pager of the receiver after a lapse of specified time.

Also, a single message can be used to specify both the operation to be performed when receiving the message and the operation to be performed after the lapse of the specified time.

While the elapsed time is used in the present example, it is also possible to specify both operations with a single message when the event condition is a coming of a time.

The event condition information 902b1 to be registered may instead be the received message event condition information 904a1.

Also, the execution contents when an event occurs are not limited to the simple operation of the sound output, the vibration, the flashing, and the display but may be performed in a multimedia data form. For example, the display 917a may display animation, static images, and moving images in combination with the melody outputted from the speaker 917b.

### Fifth Example

The following is an explanation of the operation of registering the program information 905b3 into the event information storage unit 901b and the operation of receiving messages using the registered program information, with reference to FIGS. 60 and 73-79.

First, the operation of registering the program information 905b3 into the event information storage unit 901b is explained with reference to FIGS. 60, 73, and 74.

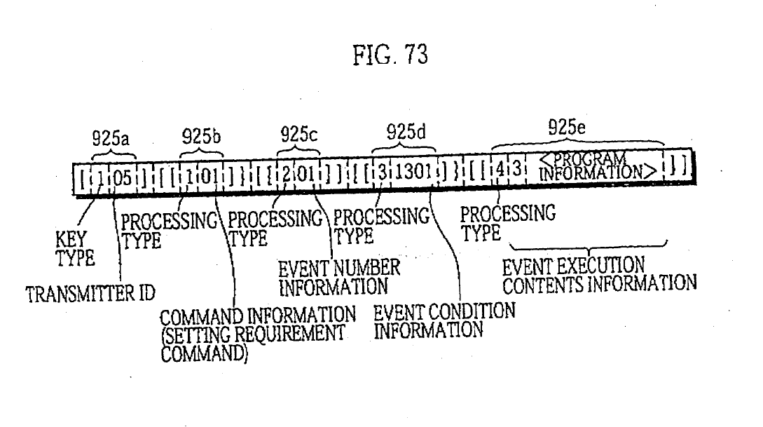

FIG. 73 shows a message used for registering the program information. The message includes transmitter information 925a, command information 925b, event number information 925c, event condition information 925d, and event execution contents information 925e. The transmitter information 925a shows that the message is sent from a transmitter “05”. The command information 925b “01” shows a setting requirement command as explained in FIG. 57. The event number information 925c “01” is combined with the transmitter information 925a to form the event identification information 902a “0501”. The event condition information 925d shows that an event occurs when receiving a message whose program identification information 904f3 is “01”. The event execution contents information 925e includes an execution contents type “3” and execution contents “<program information>”. The execution contents type “3” shows that the execution contents are program information that includes a program to be analyzed and executed by the event execution unit 901e.

The operation when receiving the message shown in FIG. 73 is explained below with reference to FIG. 60.

The operation proceeds from Step S901 to Step S903, since the event information storage unit 901b does not store the event instruction information 902b and thus a time event by a coming of a time or an elapsed time does not occur.

The reception unit 901a receives the message in Step S903.

In Step S904, the received message analysis unit 901f judges that the received message include internal processing information, since data sandwiched between the separator 908c1 “[[” and the separator 908c2 “]]” is included in the received message. The received message analysis unit 901f accordingly shifts the operation to the event information setting unit 901c.

In Step S905, the event information setting unit 901c checks the command information 925b “01” in the received message that specifies the setting requirement of the event instruction information 902b.

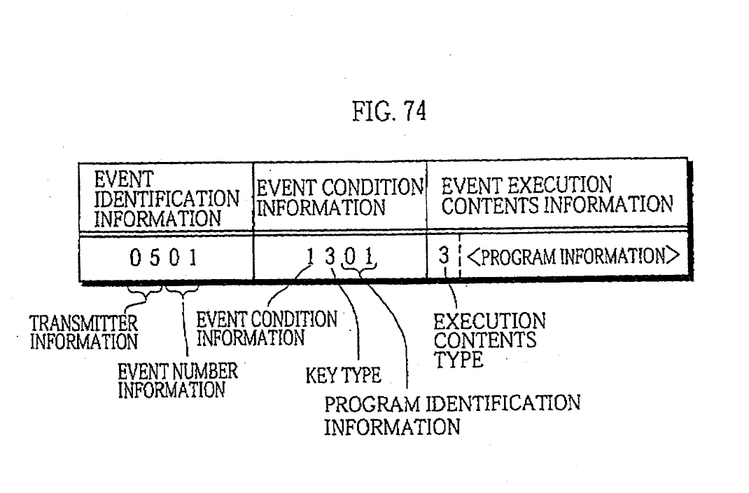

In Step S906, the event information setting unit 901c registers the event information into the event information storage unit 901b. FIG. 74 shows the registered event information. The transmitter information 925a “05” and the event number information 925c “01” in the received message are registered as the event identification information “0501”. The event condition information 925d “1301” in the received message is registered as the event condition information. The event execution contents information 925e “3<program information>” in the received message is registered as the event execution contents information. The operation proceeds to Step S911.

Since the received message only includes the information sandwiched between the separator 908a1 “[” and the separator 908a2 “]” and the information sandwiched between the separator 908c1 “[[” and the separator 908c2 “]]” and does not include output message information, the operation returns to Step S901.

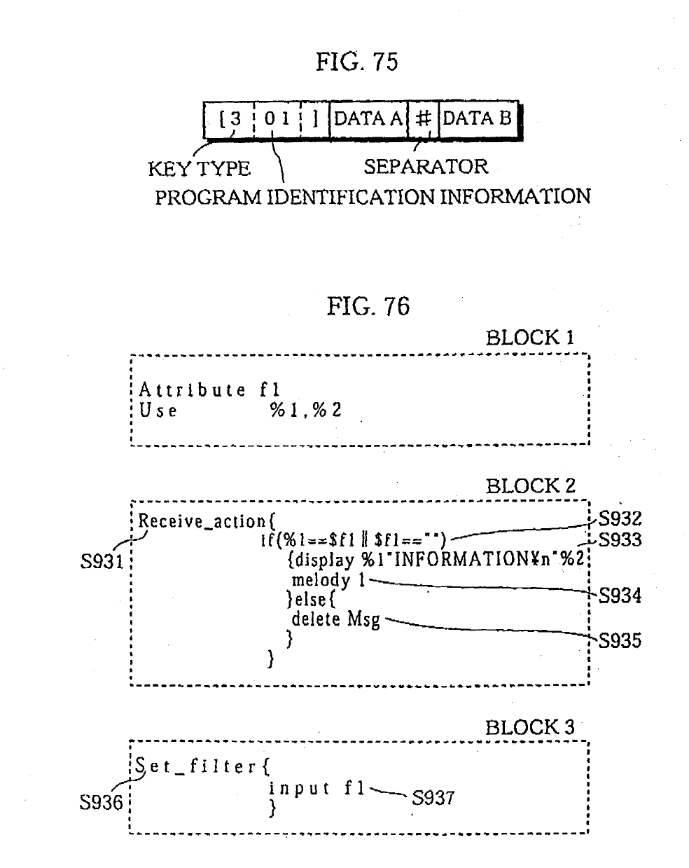

Next, the operation of processing a received message using the program information is explained below with reference to FIGS. 75-79.

FIG. 75 shows the predetermined construction of a received message to be processed using the program information. The received message includes program identification information, along with data A and data B with a separator “#” between them. Data A is used to judge a filter condition for displaying only predetermined messages in the present example, while data B is used as display data.

The operation when receiving the message with the above construction is explained below with reference to FIG. 60.

The operation proceeds from Step S901 to Step S903, since the event information storage unit 901b does not store the event instruction information 902b1 which specifies a time or an elapsed time as an event condition and thus a time event does not occur.

On receiving the message shown in FIG. 75, the operation proceeds to Step S904.

Since the received message does not include internal processing information, the operation proceeds to Step S913.

The event monitor unit 901d checks the event instruction information in the event information storage unit 901b. The program identification information “01” in the received message meets the event condition that the program identification information 904f3 be “01”, the event condition being specified by the event condition information in the event information storage unit 901b. Accordingly, the event monitor unit 901d notifies the event execution unit 901e of the event occurrence.

In Step S914, the event execution unit 901e processes the received message according to the event execution contents information that shows the execution of the program information. That is to say, the event execution unit 901e processes the received message according to the program information. The operation then returns to Step S901.

The following is an explanation of the registered program information.

FIG. 76 shows a specific example of the program information. This program information realizes a filter function for displaying only radio messages that include predetermined data. The program information is composed of three main blocks 1-3.

Block 1 includes a variable f1 that can be set by the key input and other means and column variables %1 and %2 for storing data in the message to be processed. The message to be processed has the predetermined construction as shown in FIG. 75, and data A and data B are assigned respectively to the column variables %1 and %2.

Block 2 describes a method of processing the message.

In this method, first the variable f1 is checked. If the variable f1 matches the column variable %1, the column variable %1 being data A, or if the variable f1 has an initial value, the message is formatted and displayed (Step S933) and the melody pattern “1” is outputted (Step S934). Otherwise, the message is deleted (Step S935).

Block 3 describes the setting of the variable f1 by the input operation (Step S937).

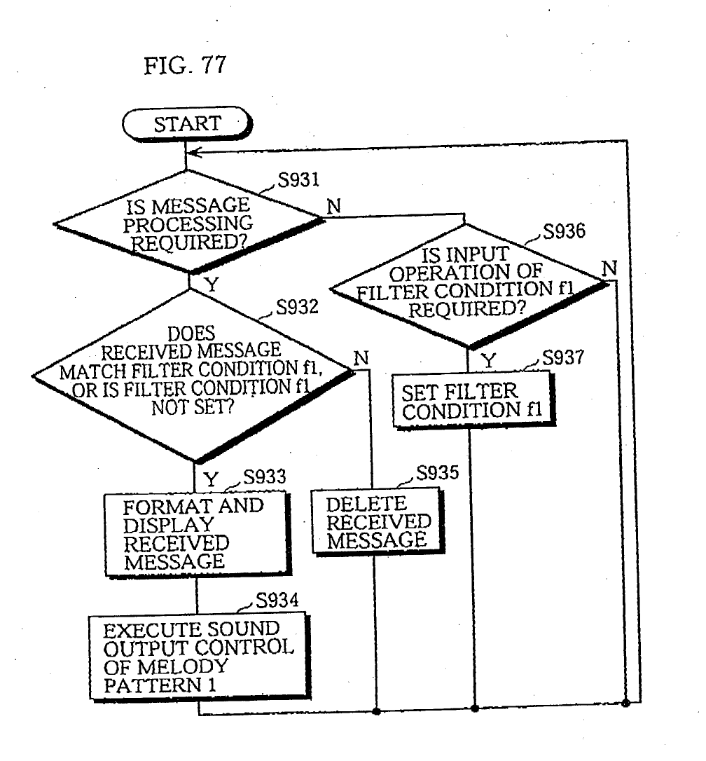

FIG. 77 is a flowchart showing the processing of the program information shown in FIG. 76.

Each step of the processing is described below.

Step S931: Proceed to Step S932 if the message processing is required. Otherwise, proceed to Step S936.

Step S932: Refer to the variable f1. Proceed to Step S933 if the variable f1 matches the column variable %1, that is, data A, or if the variable f1 has the initial value. Otherwise, proceed to Step S935.

Step S933: Format and display the message according to the program information.

Step S934: Output the melody pattern “1”.

Step S935: Delete the message.

Step S936: Proceed to Step S937 if the input operation in the variable f1 is required. Otherwise, return to Step S931.

Step S937: Set the variable f1 that is used as the filter condition and return to Step S931.

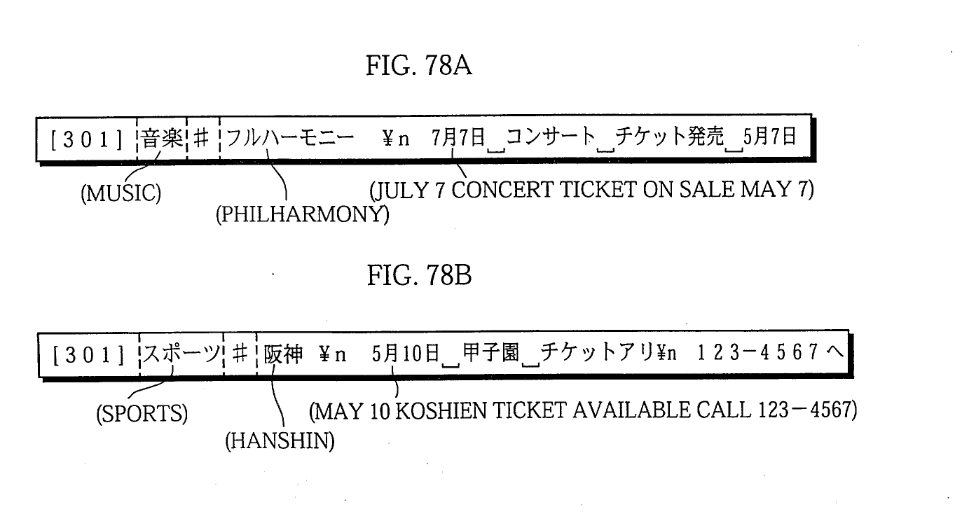

The following is an explanation of the operation of receiving a message shown in FIG. 78A and executing the program information shown in FIG. 76 when the variable f1 is not set but remains at the initial value, with reference to FIG. 77.

The operation proceeds from Step S931 to Step S932, since the received message is to be processed using the program.

Since the variable f1 is not set but remains at the initial value, the operation proceeds to Step S933.

The event execution unit 901e formats the received message and instructs the output control unit 901h to display the formatted message. The output control unit 901h accordingly has the display 917a in the output unit 901i display the formatted message.

In Step S934, the event execution unit 901e instructs the output control unit 901h to output the melody pattern “1”. The output control unit 901h accordingly has the speaker 917b in the output unit 901i output the melody pattern “1” to notify the user of the message reception.

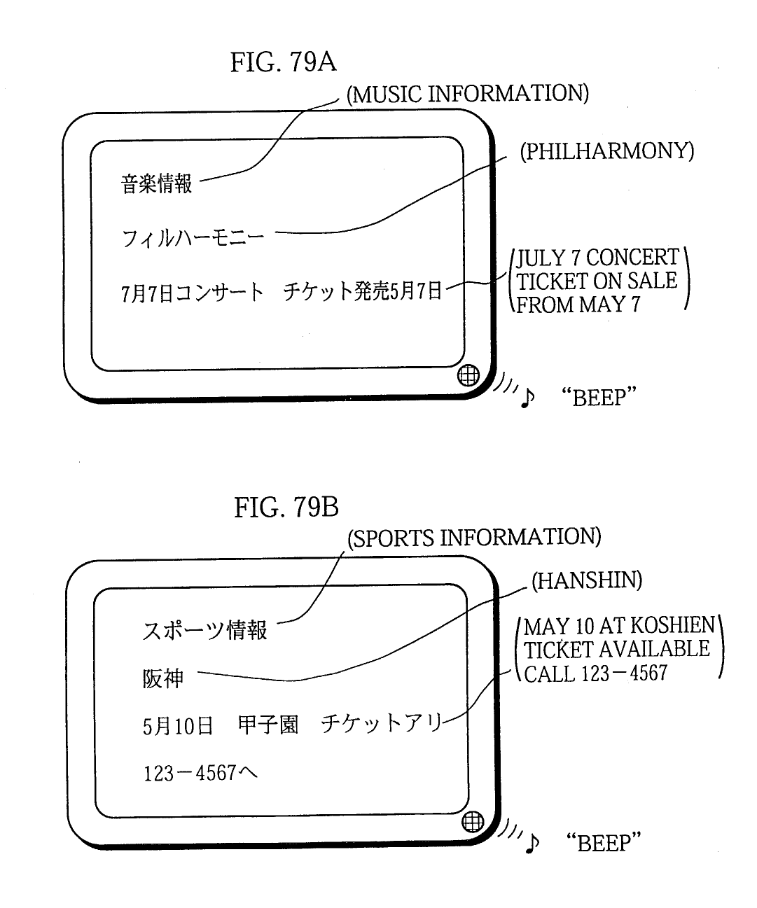

FIG. 79A shows an output example.

The same notification is performed when receiving a message shown in FIG. 78B as the message shown in FIG. 78A. FIG. 79B shows an output example. The message formatted in the same way as FIG. 79A is displayed with the output of the melody pattern “1” to notify the user of the message reception.

The operation of setting “z,176 ” (MUSIC) in the variable f1 by the input operation is explained next.

The operation proceeds from Step S931 to Step S936, since the message processing is not required.

The operation proceeds to Step S937, since the variable f1 setting is required.

“ [symbol] ” is set in the variable f1 by the input operation.

The following is an explanation of the operation of receiving the message shown in FIG. 78A and executing the program information shown in FIG. 76 when “ [symbol] ” is set in the variable f1.

The operation proceeds from Step S931 to Step S932, since the received message is to be processed using the program.

The operation proceeds to Step S933, since the variable f1 and data A in the received message both store “ [symbol] ”.

The event execution unit 901e formats the received message and instructs the output control unit 901h to display the formatted message. The output control unit 901h accordingly has the display 917a in the output unit 901i display the formatted message.

In Step S934, the event execution unit 901e instructs the output control unit 901h to output the melody pattern “1”. The output control unit 901h accordingly has the speaker 917b in the output unit 901i output the melody pattern “1” to notify the user of the message reception.

As a result, the message is displayed as shown in FIG. 79A and the user is notified of the message reception.

Next, the operation of receiving the message shown in FIG. 78B and executing the program information shown in FIG. 76 is explained.

The operation proceeds from Step S931 to Step S932, since the received message is to be processed using the program.

The operation proceeds to Step S935, since “ [symbol] ” set in the variable f1 does not match “ [symbol] ” (SPORTS) set in data A in the received message.

The event execution unit 901e deletes the message. As a result, the user is not notified of the message reception.

With the present embodiment, it is possible to notify the user of only selected messages among all received messages.

Also, the program information for formatting and processing messages can be registered by sending a message which includes the program information to the radio pager.

While the variable in the example program is used to determine whether notifying the user of a received message in the present embodiment, the program may be written so as to change a notification method according to the variable, so that it is possible to notify the user of received messages differently in accordance with the difference of data included in each message.

It is also possible to set more variables, in addition to the variable f1.

While the program information is registered by the message reception in the present example, it may also be inputted via a local input unit.

The program identification information 904f3 may not necessarily be expressed as a program ID but can be expressed as a program name, as long as it can be distinguished from other programs.

### Sixth Example

The following is an explanation of the operation when receiving a message using the program information 905b3 stored in the event information storage unit 901b, with reference to FIGS. 60 and 80-85.

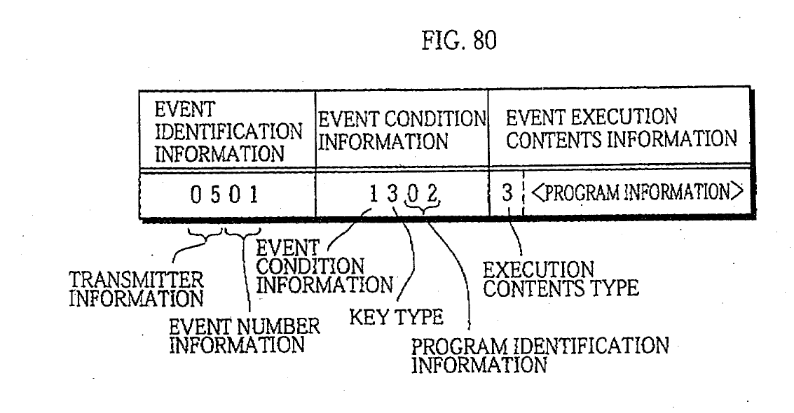

FIG. 80 shows an example of event information stored in the event information storage unit 901b. In the figure, event identification information is made up of transmitter information “05” and event number information “01”. An event condition type “1” in event condition information shows that an event occurs by a message reception, while a key type “3” shows that key contents are program information with program identification information “02”. Event execution contents information is made up of an execution contents type “3” showing that execution contents are program information and the program information.

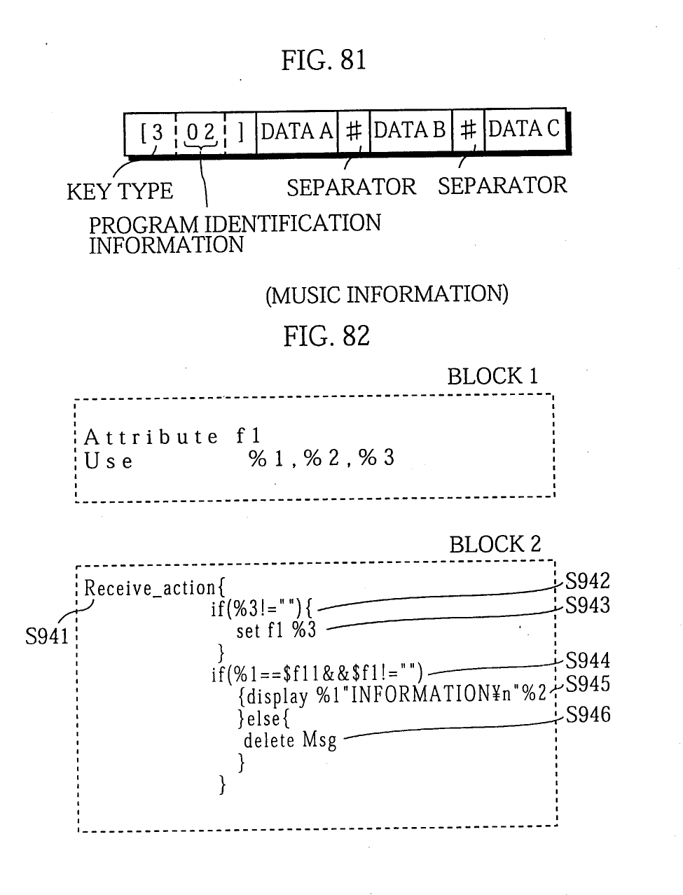

FIG. 81 shows the predetermined construction of a received message to be processed using the above program information. The received message includes program identification information, along with data A, data B, and data C with the separator “#” placed between each two sets of data.

The operation when receiving this message is explained below with reference to FIG. 60.

The operation proceeds from Step S901 to Step S903, since the event information storage unit 901b does not store the event condition information 902b1 which specifies a time or an elapsed time as an event condition and thus a time event does not occur.

On receiving the message shown in FIG. 81, the operation proceeds to Step S904.

The operation proceeds to Step S913, since the received message does not include internal processing information.

The event monitor unit 901d checks the event instruction information in the event information storage unit 901b. The program identification information “02” in the received message meets the condition that the program identification 904f3 be “02” specified by the event condition information 902b1 in the event information storage unit 901b. Accordingly, the event monitor unit 901d notifies the event execution unit 901e of the event occurrence.

In Step S914, the event execution unit 901e processes the received message according to the event execution contents information 902b2 that specifies the execution of the program information. That is to say, the event execution unit 901e processes the received message according to the program information. The operation then returns to Step S901.

The program information with the program identification information “02” is explained below.

FIG. 82 shows a written example of the program information.

The program information is composed of two main blocks.

Block 1 includes a variable f1 into which filter information is set, along with column variables %1, %2, and %3 for storing data included in a message to be processed. The message to be processed has the predetermined construction as shown in FIG. 81, and data A, data B, and data C are assigned respectively to the column variables %1, %2, and %3.

Block 2 describes a method of processing the message.

In this method, if the received message has data C (column variable %3), data C (column variable %3) is set in the filter condition variable f1.

Next, the variable f1 is checked. If a condition is set in the variable f1 and the condition matches the column variable %1, that is, data A, the message is formatted and displayed (Step S945). Otherwise, the message is deleted (Step S946).

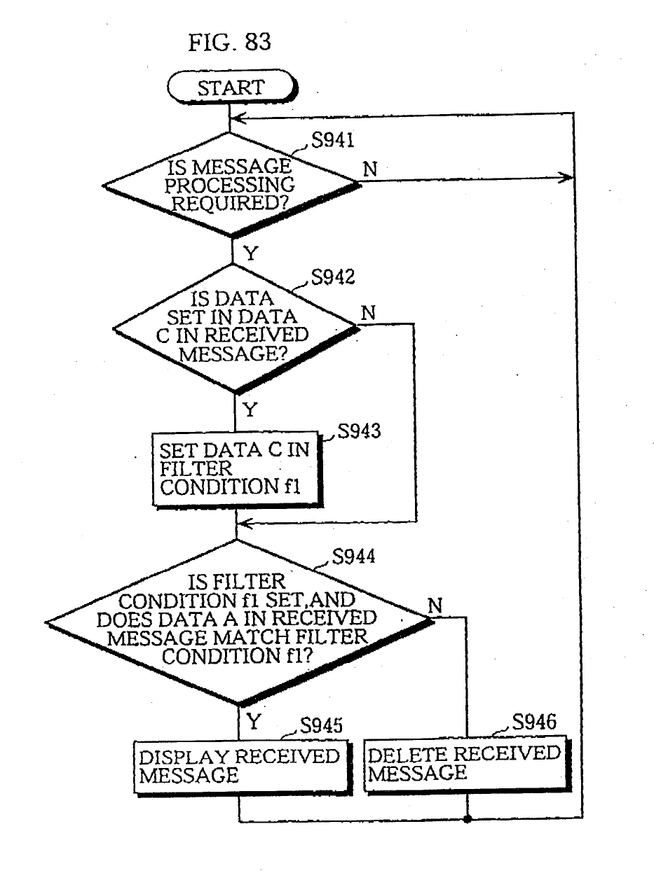

FIG. 83 is a flowchart showing the processing of the program information shown in FIG. 82.

Each step in the processing is described below.

Step S941: Proceed to Step S942 if the message processing is required.

Step S942: Proceed to Step S943 if the received message has data C (filter setting condition). Otherwise, proceed to Step S944.

Step S943: Set data C (filter setting condition) into the filter condition variable f1.

Step S944: Refer to the filter condition variable f1.Proceed to Step S945 if the variable f1 is set and if the variable f1 matches data A (column variable %1). Otherwise, proceed to Step S946.

Step S945: Format and display the message according to the program information.

Step S946: Delete the message.

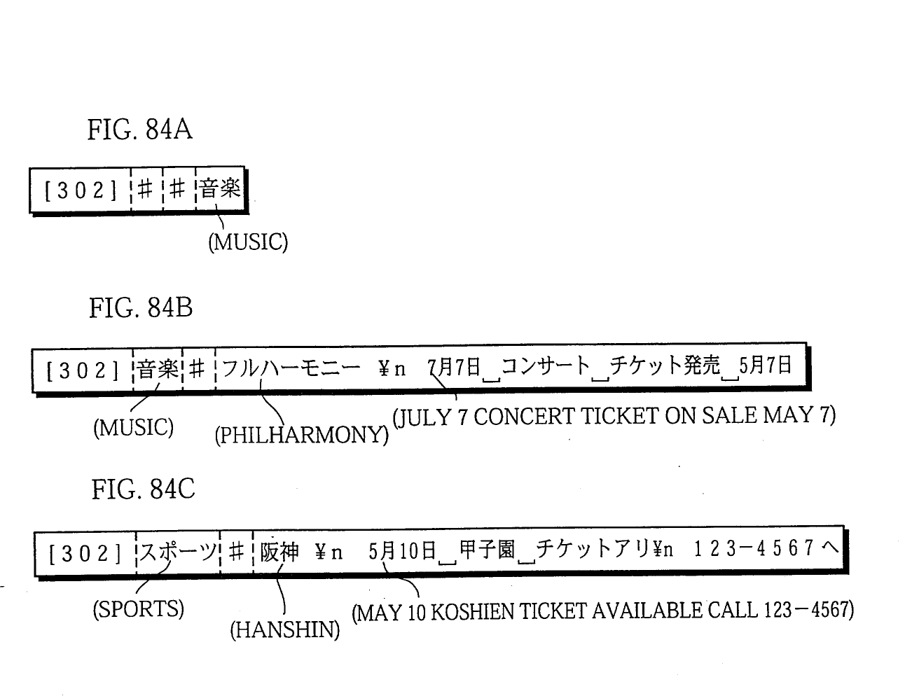

The following is an explanation of the operation of receiving a message shown in FIG. 84B and executing the program information shown in FIG. 82 when the variable f1 is not set but remains at an initial value, with reference to FIG. 83.

The operation proceeds from Step S941 to Step S942, since the received message is to be processed using the program.

The operation proceeds to Step S944, since the received message does not have data C (column variable %3).

The operation proceeds to Step S946, since the filter condition variable f1 is not set.

The received message is deleted.

Next, the operation when receiving a message shown in FIG. 84(a) and executing the program information shown in FIG. 82 is explained with reference to FIG. 83.

The operation proceeds from Step S941 to Step S942, since the received message is to be processed using the program.

The operation proceeds to Step S943, since the received message has data C (column variable %3).

Data C in the received message is set into the filter condition variable f1.

In Step S944, the filter condition variable f1 does not match data A, since no data is set in data A while “ [symbol] ” is set in the filter condition variable f1.

In Step S946, the received message is deleted. However, data C (“ [symbol] ”) set in the filter condition variable f1 is valid.

The following is an explanation of the operation of receiving the message shown in FIG. 84B when “ [symbol] ” is set in the filter condition variable f1.

The operation proceeds from Step S941 to Step S942, since the received message is to be processed using the program.

The operation proceeds to Step S944, since the received message does not have data C (column variable %3).

The set filter condition variable f1 matches data “ [symbol] ” in the received message.

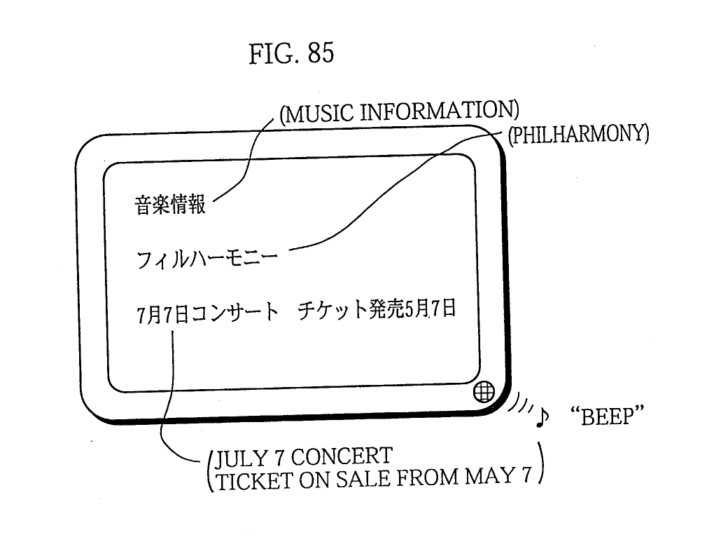

In Step S945, the received message is formatted and displayed according to the program information. An example of the display is shown in FIG. 85(a).

With the present embodiment, it is possible to determine how to process a received message not only by local input but also by message reception.

Accordingly, the transmitter can determine how the received message is to be processed in the receiver terminal.

As described above, in the radio pager of the present invention, it is possible to perform the control according to a condition, such as a scheduled time, an elapsed time, or key information (such as transmitter information or a keyword) included in the received message, or according to a combination of the above conditions.

Also, the output control is not limited to the fixed operation of outputting a bell sound. It is possible to specify the output control for displays and sounds. For example, it is possible to notify the user only of messages from specified transmitters, to use different notification methods for messages from different transmitters, or to notify the user only of necessary messages. These messages can be displayed at a specified time with the output of a specified sound.

Also, an event condition and event execution contents which have been registered can be changed by receiving appropriate messages. Thus, it is possible to delete or modify the event condition and event execution contents registered when the radio pager received a wrong message.

Thus, the radio pager of the present invention provides various services that includes: notification of messages only from specified transmitters; output of the bell sound only after receiving all specified messages from transmitters A, B, and C; and no sound output during a specified time period.

Note that the output setting information storage unit 901g may give the user a warning when the buffer for temporarily storing radio messages waiting for the occurrence of events becomes full.

The user may also be notified of the existence of the radio messages waiting for the event occurrence by certain means, such as by displaying a mark on the display 917a. By doing so, the user can have the waiting radio messages displayed before the event occurrence.

While there are three types of command information shown in FIG. 57 that are the setting requirement command, the deletion requirement command, and the renewal requirement command in the present embodiment, other commands may also be included, such as a command for temporarily nullifying event information which has been registered and a command for recovering the temporarily nullified event information.

Note that it is possible to combine two or more of the above embodiments. In such a case, it is not necessary to include all elements of each embodiment in the combination. If these embodiments include elements that have the same function, these elements may be replaced with one common element.

### INDUSTRIAL APPLICABILITY

As described above, the radio pager of the present invention can be used to receive radio messages from transmitters and notify the user of the contents of the received messages, and is particularly effective for performing the output control in great variety and flexibility.

What is claimed is:

1. A radio pager, comprising:
output means for performing an output operation using at least one of a display, a sound output, a vibration, and a light emission;
storage means for storing control information for controlling an output mode that includes at least one of the display, the sound output, the vibration, and the light emission;
reception means for receiving a radio message that includes at least one parameter relating to the control information;
generation means for generating output control data according to the received parameter and the control information; and
control means for controlling the output means according to the output control data generated by the generation means.

2. The radio pager of claim 2,
wherein the storage means stores any of: at least one program for processing data in the radio message and determining the output mode; at least one set of event information that are each a combination of an event condition relating to the radio message and operation data which is dependent on an occurrence of an event; and at least one template showing a form for a display message where contents of at least one column in the radio message are included.

3. The radio pager of claim 2,
wherein the reception means receives the radio message that includes a program identifier as the parameter, and
wherein the generation means processes the data in the radio message and determines the output mode according to a program specified by the program identifier in order to generate the output control data which instructs to execute the output mode.

4. The radio pager of claim 2,
wherein the storage means stores the combination of the event condition for the occurrence of the event and the operation data to be used when the event occurs,
wherein the reception means receives the radio message that includes an element relating to the event condition as the parameter, and
wherein the generation means generates the output control data according to the operation data stored in the storage means when the event caused by the parameter occurs.

5. The radio pager of claim 4,
wherein the storage means stores, as the event condition, any of: a reception of a radio message which includes specified data; a coming of a time, and a lapse of a time period since a reception of a radio message.

6. The radio pager of claim 2,
wherein the storage means stores the template which includes a plurality of columns,
wherein the reception means receives the radio message that includes the contents of at least one column as the parameter, and
wherein the generation means generates the output control data according to the contents of the columns and the template.

7. The radio pager of claim 2,
wherein the radio message includes one of a new program, a new set of event information, and a new template, and
wherein the radio pager further comprises
setting means for setting one of the new program, the new set of event information, and the new template included in the radio message into the storage means.

8. A radio pager, comprising:
output means for performing an output operation using at least one of a display, a sound output, a vibration, and a light emission;
storage means for storing at least one program that each determine an output mode, the program being stored as control information for controlling the output mode which includes at least one of the display, the sound output, the vibration, and the light emission;
reception means for receiving a radio message that includes a program identifier as a parameter relating to the control information;
generation means for generating output control data according to the received parameter and the control information; and
control means for controlling the output means according to the output control data generated by the generation means,
wherein the generation means includes:
analysis means for analyzing the radio message received by the reception means and detecting the program identifier;
read means for reading a program specified by the detected program identifier from the storage means; and
creation means for creating the output control data by executing the read program.

9. The radio pager of claim 8,
wherein the radio message includes the program identifier and contents information showing message contents,
wherein the analysis means detects the contents information, and
wherein the creation means creates display data using the contents information, as well as creating the output control data for specifying the output operation in which the display of the created display data is combined with the sound output.

10. The radio pager of claim 9,
wherein the contents information includes at least one character string, and
wherein the creation means complements the character strings included in the contents information to create the display data.

11. The radio pager of claim 9,
wherein the contents information includes address information showing an address stored in the storage means and at least one set of data,
wherein the storage means further stores a group of predetermined data which can be specified by the address information, and
wherein the creation means complements the set of data included in the contents information and data specified by the address information to create the display data.

12. The radio pager of claim 8,
wherein the output means includes a display unit, a sound output unit, and a vibration unit, and
wherein the creation means creates the output control data that specifies a combination and an order of the display of created display data, the sound output, and the vibration.

13. The radio pager of claim 8,
wherein the radio message includes the program identifier and at least one combination that are each composed of argument attribute information and an argument value,
wherein the analysis means further detects each combination of the argument attribute information and the argument value, and
wherein the creation means creates the output control data according to the program specified by the program identifier, the output control data including an instruction for instructing the output means to output information specified by the argument value in the output mode specified by the argument attribute information.

14. The radio pager of claim 13,
wherein the argument attribute information is one of: a first attribute showing the display of data of the argument value; a second attribute showing the sound output of a bell sound specified by the argument value; a third attribute showing the sound output of a melody sound specified by the argument value; a fourth attribute showing the sound output of audio data specified by the argument value; and a fifth attribute showing the vibration in a vibration pattern specified by the argument value.

15. The radio pager of claim 14,
wherein the argument attribute information further includes an order attribute showing whether the combinations are included in the radio message in a fixed order or a random order,
wherein the storage means further stores fixed information that shows an order and a number of the combinations,
wherein the analysis means detects whether the order attribute in the radio message shows the fixed order or the random order, and
wherein the creation means creates output mode data according to all of the combinations included in the radio message when the detected order attribute shows the random order, while the creation means creates the output mode data according to combinations, among the combinations included in the radio message, which correspond to the fixed information when the detected order attribute shows the fixed order.

16. The radio pager of claim 8, further comprising:
acquisition means for acquiring at least one program identifier and at least one corresponding program; and
save means for storing the program identifier and the corresponding program acquired by the acquisition means into the storage means.

17. The radio pager of claim 8,
wherein the radio message is composed of a plurality of divided messages which each possess division information showing whether the divided message is a last divided message, and
wherein when a divided message received by the reception means is other than the last divided message, the creation means temporarily stores the divided message into the storage means, while when a divided message received by the reception means is the last divided message, the creation means combines the last divided message with divided messages temporarily stored in the storage means.

18. The radio pager of claim 8,
wherein the radio message further includes a transmitter identifier,
wherein the storage means further stores at least one transmitter identifier, and
wherein the control means includes prohibition means for judging whether the transmitter identifier in the radio message is stored in the storage means and prohibiting the output means to output the radio massage according to a judgement result.

19. The radio pager of claim 8,
wherein the radio message further includes a transmitter identifier,
wherein the storage means further stores at least one transmitter identifier corresponding to the program, and
wherein when both the transmitter identifier and the program identifier in the radio message correspond to the program in the storage means, the read means reads the program.

20. A radio pager, comprising:
output means for performing an output operation using at least one of a display, a sound output, a vibration, and a light emission;
storage means for storing at least one combination of an event condition for an occurrence of an event and operation data to be used when the event occurs, the combination being stored as control information for controlling an output mode which includes at least one of the display, the sound output, the vibration, and the light emission;
reception means for receiving a radio message which includes an element relating to the event condition, the element being a parameter relating to the control information;
generation means for generating output control data according to the received parameter and the control information; and
control means for controlling the output means according to the output control data generated by the generation means,
wherein the generation means includes:
analysis means for analyzing the radio message received by the reception means and detecting the element relating to the event condition;
monitor means for monitoring whether the detected element meets the event condition; and
creation means for creating the output control data according to the operation data when the event condition is met.

21. The radio pager of claim 20,
wherein the analysis means analyzes whether the radio message is one of a first type which includes a predetermined instruction and a second type which is other than the first type,
wherein the monitor means judges whether the element in the radio message meets the event condition when the radio message is analyzed to be the second type, and
wherein the radio pager further comprises setting means for setting, in accordance with the predetermined instruction included in the radio message, a predetermined event condition and operation contents to be executed when the predetermined event condition is met into a storage unit, when the radio message is analyzed to be the first type.

22. The radio pager of claim 21,
wherein the radio message of the first type includes a command for instructing to one of add, delete, and renew contents of the storage means,
wherein the analysis means analyzes a type of the command included in the radio message of the first type, and
wherein the setting means one of adds, deletes, and renews the contents of the storage means according to the analyzed type of the command.

23. The radio pager of claim 20,
wherein the event condition stored in the storage means is at least one of: a presence of specified data in the radio message; a lapse of a specified time period since a message reception; and a coming of a specified time of a specified date.

24. The radio pager of claim 23,
wherein the specified data is one of transmitter identification information, a password, specified program identification information, and a keyword.

25. The radio pager of claim 20, further comprising
output setting storage means for storing at least one out of sound patterns, vibration patterns, light emission patterns, and display patterns, in accordance with a capacity of the output means,
wherein the creation means creates the output control data which is specified by the operation data corresponding to the met event condition and which includes at least one of a sound pattern, a vibration pattern, and display data, and
wherein the control means controls the output means according to the operation data with reference to the output setting storage means specified by the operation data.

26. The radio pager of claim 25,
wherein the reception means receives the radio message that includes an setting instruction for any of the sound patterns, the vibration patterns, the light emission patterns, and the display patterns,
wherein the analysis means detects the setting instruction, and
wherein the radio pager further comprises renewal means for renewing the output setting storage means according to the detected setting instruction.

27. A radio pager, comprising:
output means for performing an output operation using at least one of a display, a sound output, a vibration, and a light emission;
storage means for storing a plurality of sets of event information that are each composed of an event condition for an occurrence of an event, an identifier, and operation data to be used when the event occurs, each set of event information being stored as control information for controlling an output mode which includes at least one of the display, the sound output, the vibration, and the light emission;
reception means for receiving a radio message that includes an element relating to the event condition, the element being a parameter relating to the control information;
generation means for generating output control data according to the received parameter and the control information; and
control means for controlling the output means according to the output control data generated by the generation means,
wherein the generation means includes:
analysis means for analyzing the radio message received by the reception means and detecting the element relating to the event condition;
monitor means for monitoring whether the detected element meets the event condition; and
creation means for creating the output control data according to the operation data when the event condition is met.

28. The radio pager of claim 27,
wherein the radio message is one of a first type which includes a setting instruction to one of add, delete, and renew a set of event information in the storage means and a second type which is other than the first type,
wherein the analysis means further analyzes whether the radio message is the first type which includes the setting instruction for the set of event information or the second type,
wherein the monitor means judges whether the element in the radio message meets the event condition when the radio message is analyzed to be the second type, and
wherein the radio pager further comprises setting means for one of adding, deleting, and renewing the set of event information in the storage means according to the setting instruction when the radio message is analyzed to be the first type.

29. The radio pager of claim 28,
wherein the event condition is expressed as one of: a single condition including one of a presence of specified data in the radio message, a lapse of a specified time period since a message reception, and a coming of a specified time of a specified date; a compound condition which is a combination of a plurality of single conditions; and a plural message condition which is to receive a plurality of radio messages, and
wherein the operation data is expressed as one of a first mode that shows at least one out of: a sound pattern; whether to vibrate; whether to display; and display data if displaying, and a second mode that shows an execution of a predetermined program.

30. The radio pager of claim 29,
wherein the storage means further stores the predetermined program corresponding to the second mode,
wherein the creation means executes the predetermined program when the met event condition is associated with the operation data of the second mode, and
wherein the control means controls the output means according to a result of executing the predetermined program by the creation means.

31. The radio pager of claim 29,
wherein the creation means executes the predetermined program when the met event condition is associated with the operation data of the second mode, and
wherein the control means changes processing contents of the predetermined program according to a result of executing the predetermined program.

32. The radio pager of claim 27, further comprising
output setting storage means for storing at least one out of sound patterns, vibration patterns, light emission patterns, and display patterns, in accordance with a capacity of the output means,
wherein the creation means creates the output control data which is specified by the operation data corresponding to the met event condition and which includes at least one of a sound pattern, a vibration pattern, and display data, and
wherein the control means controls the output means according to the operation data with reference to the output setting storage means specified by the operation data.

33. The radio pager of claim 32,
wherein the reception means receives the radio message that includes an setting instruction for any of the sound patterns, the vibration patterns, the light emission patterns, and the display patterns,
wherein the analysis means detects the setting instruction, and
wherein the radio pager further comprises renewal means for renewing the output setting storage means according to the detected setting instruction.

34. A radio pager, comprising:
output means for performing an output operation using at least one of a display, a sound output, a vibration, and a light emission;
storage means for storing at least one template that each define a column arrangement, the template being stored as control information for controlling an output mode which includes at least one of the display, the sound output, the vibration, and the light emission;
reception means for receiving a radio message that includes a template identifier and contents of each column as parameters relating to the control information;
generation means for generating output control data according to the received parameters and the control information; and
control means for controlling the output means according to the output control data generated by the generation means,
wherein the generation means includes:
analysis means for analyzing the radio message received by the reception means and detecting the template identifier and the contents of each column;
read means for reading a template specified by the detected template identifier from the storage means; and
creation means for creating the output control data according to the read template and the contents of each column.

35. The radio pager of claim 34, further comprising
preceding message storage means for storing contents of each column included in preceding messages which were one of transmitted and received,
wherein the reception means receives a change message which includes relation information showing a relation with a preceding message stored in the preceding message storage means, a template identifier, changed part information showing a changed part in the preceding message, and changed contents,
wherein the analysis means detects the changed contents in units of columns according to the changed part information, and
wherein the creation means creates a display message as the output control data using the detected changed contents and the preceding message.

36. The radio pager of claim, further comprising
renewal means for renewing contents of the preceding message storage means according to the change message when the display message created by the creation means is displayed.

37. The radio pager of claim 34, further comprising:
change specification means for specifying a changed part in a preceding message stored in preceding message storage means according to a user operation;
changed contents input means for inputting changed contents in the changed part specified by the change specification means according to the user operation;
change message creation means for creating a change message which includes relation information showing a relation with the preceding message, changed part information showing the changed part specified by the change specification means, and the changed contents inputted by the changed contents input means; and
transmission means for transmitting the change message created by the change message creation means.

38. The radio pager of claim 37, further comprising
guidance display means for displaying a guidance of each column for the user operation when specifying the changed part and the changed contents.

39. The radio pager of claim 37, further comprising
transmission information addition means for adding transmission information to the preceding message stored in the preceding message storage means, the transmission information showing whether the preceding message is present in an another radio pager in communication.

40. The radio pager of claim 34,
wherein the template defines the column arrangement in which a column showing the template identifier, a secret word column, a person column, a time column, a place column, an event column, and a reply column are arbitrarily combined, and
wherein the radio message is composed of the template identifier, the contents of each column, and separator codes.

41. A control method of a radio pager that includes an output unit for performing an output operation using at least one of a display, a sound output, a vibration, and a light emission and a storage unit for storing control information, the control method comprising:
a storage step of storing at least one program that each determine an output mode into the storage unit, the program being stored as the control information for controlling the output mode which includes at least one of the display, the sound output, the vibration, and the light emission;
a reception step of receiving a radio message that includes a program identifier as a parameter relating to the control information;
a generation step of generating output control data according to the received parameter and the control information; and
an output step of controlling the output unit according to the output control data generated in the generation step,
wherein the generation step includes:
an analysis substep of analyzing the radio message and detecting the program identifier;
a read substep of reading a program specified by the detected program identifier from the storage unit; and
a creation substep of creating the output control data by executing the read program.

42. A control method of a radio pager that includes an output unit for performing an output operation using at least one of a display, a sound output, a vibration, and a light emission and a storage unit for storing control information, the control method comprising:
a storage step of storing at least one combination of an event condition for an occurrence of an event and operation data to be used when the event occurs into the storage unit, the combination being stored as the control information for controlling an output mode which includes at least one of the display, the sound output, the vibration, and the light emission;
a reception step of receiving a radio message that includes an element relating to the event condition, the element being a parameter relating to the control information;
a generation step of generating output control data according to the received parameter and the control information; and
an output step of controlling the output unit according to the output control data generated in the generation step,
wherein the generation step includes:
an analysis substep of analyzing the radio message and detecting the element relating to the event condition;
a monitor substep of monitoring whether the detected element meets the event condition; and
a creation substep of creating the output control data according to the operation data when the event condition is met.

43. A control method of a radio pager that includes an output unit for performing an output operation using at least one of a display, a sound output, a vibration, and a light emission and a storage unit for storing control information, the control method comprising:
a storage step of storing at least one template that each define a column arrangement into the storage unit, the template being stored as the control information for controlling an output mode which includes at least one of the display, the sound output, the vibration, and the light emission;
a reception step of receiving a radio message that includes a template identifier and contents of each column as parameters relating to the control information;
a generation step of generating output control data according to the received parameters and the control information; and
an output step of controlling the output unit according to the output control data generated in the generation step,
wherein the generation step includes:
an analysis substep of analyzing the radio message and detecting the template identifier;
a read substep of reading a template specified by the detected template identifier from the storage unit; and
a creation substep of creating the output control data using the read template and the contents of each column.
